(19) United States
(12) Patent Application Publication
(10) Pub. No.: US 2002/0163693 A1
(43) Pub. Date: Nov. 7, 2002

(54) Method and system for switching and routing, while logically managing and controlling, multichannel optical signals in an optical communication system

(76) Inventors: Assaf Rubissa, Misgav (IL); Dono Van Meirop, Haifa (IL); Rotem Levy, Misgav (IL); Ariel Elior, Modiin (IL); Allon Guez, Narberth, PA (US); Shmuel Liran, Haifa (IL); Moshe Carmeli, Haifa (IL); Matty Katz, Alon Hagalil (IL); Gustavo Rodberg, Carmiel (IL); Elon Littwitz, Misgav (IL); Meir Razvag, Jerusalem (IL); Aharon J. Agranat, Mevasseret Zion (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/056,782

(22) Filed: Jan. 28, 2002

Related U.S. Application Data
(63) Continuation-in-part of application No. 09/621,874, filed on Jul. 21, 2000.
(60) Provisional application No. 60/264,055, filed on Jan. 26, 2001.

(30) Foreign Application Priority Data
Jul. 26, 1999 (IL) 131118

(51) Int. Cl. H04J 14/00; H04J 14/02

(52) U.S. Cl. 359/128; 359/117

(57) ABSTRACT

Method and system for switching and routing, while logically managing and controlling, multichannel optical signals in an optical communication system, featuring (a) an optical package array of optically connected: optical switch elements, left side and bottom side input ports, right side and top side output ports, and, (b) an operatively connected management and control logic mechanism (MCLM). The system is used for forming a variety of general and specific extendable all optical cross connect (AOXC) chained optical package (COP) architectures. MCLM logically manages and controls switching and routing of light entering and exiting the optical switch elements via input and output ports. Includes optional optical signal switching and routing functions of grouping, multicasting, adding and/or dropping, converting, and, restoring, of single and groups of a plurality of wavelengths. The optical switch elements are preferably voltage controlled Electroholography based optical switches. Three dimensional spatial representations of system structure and function are provided.

This is a Continuation-in-Part of U.S. patent application Ser. No. 09/621,874, filed Jul. 21, 2000, entitled: “Electroholographic Wavelength Selective Photonic Switch For WDM Routing”, and, claims the benefit of priority of U.S. Provisional Patent Application No. 60/264,055, filed Jan. 26, 2001.

### FIELD AND BACKGROUND OF THE INVENTION

The present invention relates to switching and routing optical signals for use in optical communications and, more particularly, to a method and system for switching and routing, while logically managing and controlling, multichannel optical signals in an optical communication system.

An optical communication system includes terminal equipment, system devices and elements, and, interconnecting elements and/or media. In the simplest case, an optical signal transmitted from originating terminal equipment, is transferred through an interconnecting element or media, such as an optical fiber, to receiving terminal equipment, thus creating an optical connection or coupling between the originating and receiving terminal equipment. In a more general case, the optical connection or coupling between originating and receiving terminal equipment is by way of a plurality of interconnecting elements or media and system devices and elements, such as optical amplifiers, optical switches, optical couplers, and the like, whereby, a plurality of originating and receiving terminal equipment is part of the optical communication system.

In an optical communication system, an optical communication channel is in the form of a light beam, associated with a carrier wave characterized by controllable, detectable, and, measurable, parameters such as wavelength and frequency. The light beam propagates in a medium such as an optical fiber, with the carrier wave featuring modulation in time according to the data carried by the channel. Such an optical communication channel is also referred to as an optical fiber communication channel. In wavelength division multiplexing (WDM), each of a plurality or multiple of K channels associated with a different carrier wave characterized by a corresponding (carrier) wavelength and (carrier) frequency, is carried by the same optical fiber. In the current state of the art, such a multichannel WDM link can have a plurality of up to 160 channels, characterized by K discrete wavelengths separated by a wavelength difference, delta λ, which may correspond to a frequency separation as small as 25 GHz, and maybe even less in the future.

Holographic optical elements and volume holograms have been used recently for two dimensional steering of light beams in optical interconnect networks, especially for highly parallel computer interconnects. However, such systems have generally relied, at least in the case of volume holograms, either on the use of a number of fixed holograms, the desired one of which is reconstructed using a reference beam selected by means of its wavelength or direction of incidence, or on the rewriting of the desired hologram in real time immediately before each steering action to be performed. Therefore, such holograms are not directly electrically switchable, and thereby do not provide for simple system construction and high speed operation.

With the increase of the bit throughput rate in optical fiber communication systems by using WDM, cost effective light sources with very narrow spectral linewidths have been developed. The development of such lasers for optical communications has enabled the use of volume (thick) holograms as routing devices. Because such holograms are inherently extremely wavelength selective, their use had not previously been feasible commercially. The use of thick holograms now enables the routing of different WDM communication channels to different destinations in the same communication network, and thus allows three dimensional steering. However, to date, optical switches based on the use of prior art holograms, which are not directly electrically switchable, have not shown sufficient speed, nor do they possess sufficiently low cross-talk levels, to enable their use in optical communication systems currently in use or under development.

Electroholography is a generic beam switching technique based on controlling the diffraction from volume gratings by means of applying an electric field to the medium containing the grating. Electroholography can be implemented by the voltage controlled photorefractive (PR) effect realized in paraelectric photorefractive crystals wherein the electro-optic effect is quadratic. Here, the grating is initially stored in the medium in the form of a photorefractive space charge, that induces an induced polarization grating and is consequently transformed by the quadratic electro-optic effect into an index of refraction (birefringence) grating when an electric field is applied to the medium. Alternatively, Electroholography can be implemented by the dielectric photorefractive effect where the grating is initially stored in the form of a grating of the dielectric constant, and is transformed by the quadratic electro-optic effect into an index of refraction (birefringence) grating when an electric field is applied to the medium. In the latter case the dielectric grating can be produced by the generation of a spatial variation of the chemical composition in the crystal that induces a spatial variation of the phase transition temperature.

In PCT International Patent Application Publication No. WO 00/02098, of PCT Patent Application No. PCT/IL99/00368, and, in co-filed U.S. patent application Ser. No. 09/348,057, each taking priority from IL Patent Application No. 125,241, filed Jul. 6, 1998, by a same inventor of the present invention, there is disclosed an “Electro-Holographic Optical Switch”, the teachings of which are incorporated by reference as if fully set forth herein. The disclosed ‘electroholographic (EH)’, hereinafter, equivalently referred to as ‘Electroholography (EH) based’, optical switch is particularly useful in optical communications. Electroholography enables the activation process of ‘latent’ volume holograms to be controlled by means of an externally applied electric field. Electroholography is based on the use of the voltage controlled photorefractive effect in the paraelectric phase, where the electro-optic effect is quadratic. ‘Latent’ volume holograms stored as a spatial distribution of space charge in a paraelectric crystal can be activated by the application of an electric field to the crystal. This field activates prestored holograms which determine the routing of data carrying light beams.

Implementation of Electroholography (EH) based devices requires use of a paraelectric photorefractive crystal with suitable properties, such as potassium tantalate niobate (KTN), strontium barium niobate (SBN), or especially potassium lithium tantalate niobate (KLTN), as taught by Hofmeister et al. in U.S. Pat. Nos. 5,614,129 and 5,785,898, which are incorporated by reference for all purposes as if fully set forth herein. KLTN doped with copper and vanadium is particularly suitable for use as the medium for Electroholography based devices. Unlike conventional holographic memory components based on conventional photorefractive crystals, which can be written and read only in the visible, Electroholography based devices featuring KLTN and similar materials can be operated in the near infra-red regions of the spectrum, including at 1.3 μm and 1.55 μm, wavelengths which are now commonly used in standard communication systems.

FIGS. 1A and 1B, from PCT Pat. Appl. Publication No. WO 00/02098 and co-filed U.S. patent application Ser. No. 09/348,057, schematically illustrates the two states of an Electroholography based 1×2 (that is, one input of an entering optical signal and two outputs of exiting diverted and non-diverted optical signals) switch 100 featuring a single paraelectric photorefractive crystal 10 incorporating a prestored holographic grating. A pair of electrodes 12 and 14 is deposited on two opposite faces of crystal 10. Paraelectric photorefractive crystals 10 could be of a material such as KTN, SBN, or especially KLTN. When a voltage V, is applied across electrodes 12 and 14, a spatial modulation of the refractive index of crystal 10 is produced from the spatially modulated space charge field, set up according to information carried by the volume hologram previously written into crystal 10. Thus, a diffraction grating 17 is effectively established in crystal 10 by application of the voltage difference V to electrode pair 12 and 14.

FIG. 1A shows one state of switch 100 activated by applying a voltage V₀ (that is, V=V₀) to crystal 10. In this state, an optical signal input along a path 16 passes to an output port 18. In this case, residual power remaining in the input beam passes to an output port 20. FIG. 1B shows the second state of switch 100. Here, a zero voltage (that is, V=0) is applied to crystal 10. Here, the optical signal input along a path 16 passes to an output port 20. In both states, optical signals carried on channels whose carrier wavelengths λ are not affected by grating 17 (as determined by the Bragg condition) pass unswitched to port 20. A photodetector 21 may be placed in the optical path defined by port 20, in which case residual power remaining after input beam 16 traverses switch 100 is used for management and monitoring purposes, as described in detail in PCT Publication No. WO 00/02098.

FIGS. 1C and 1D, also from PCT Pat. Appl. Publication No. WO 00/02098 and co-filed U.S. patent application Ser. No. 09/348,057, schematically illustrates the two states of Electroholography based 1×2 switch 100 that is based on two paraelectric photorefractive crystals 10 and 11. Each crystal 10 or 11 incorporates a prestored holographic grating, with electrode pair 12 and 14 deposited on two opposite faces of crystal 10 and electrode pair 13 and 15 deposited on two opposite faces of crystal 11. Paraelectric photorefractive crystals 10 and 11 could be of a material such as KTN, SBN, or especially KLTN. When a voltage V₀, is applied to either of the two pairs of electrodes 12 and 14 and 13 and 15, a spatial modulation of the refractive index of the respective crystal is produced from the spatially modulated space charge field, set up according to the information carried by the volume hologram previously written into crystal 10 or 11. Thus, a diffraction grating (17 in crystal 10, or 19 in crystal 11) is effectively established in crystal 10 or 11 by the application of the voltage to the electrode of the respective crystal.

FIG. 1C shows one state of switch 100 activated by applying a voltage V₀ (that is, V₁=V₀) to crystal 10 and zero voltage (that is, V₂=0) to crystal 11. In this state, an optical signal input along a path 16 passes to an output port 18. FIG. 1D shows the second state of switch 100. Here, a zero voltage (that is, V₁=0) is applied to crystal 10 and voltage V₀ (that is, V₂=V₀) is applied to crystal 11. Here, the optical signal input along a path 16 passes to an output port 20. In both cases, residual power remaining in the input beam is blocked by a block 21. Block 21 may be replaced by a photodetector, in which case residual power remaining after input beam 16 traverses switch 100 is used for management and monitoring purposes, as described in detail therein. If V₁ and V₂ are both set equal to V₀, then part of the optical signal is diffracted to output port 18, and the residual, that is not diffracted to output port 18, is diffracted to output port 20. If diffraction gratings 17 and 19 are set up with different grating spacings, to diffract light of different wavelengths, then switch 100 of FIGS. 1C and 1D functions as two switches 100 of FIGS. 1A and 1B configured in series.

As taught in PCT Pat. Appl. Publication No. WO 00/02098 and in co-filed U.S. patent application Ser. No. 09/348,057, and references therein, the mechanism by which the Electroholography based optical switch operates is based on the use of the voltage controlled photorefractive (PR) effect, as further described by A. J. Agranat, V. Leyva and A. Yariv in “Voltage-controlled photorefractive effect in paraelectric KTa₁₋ₓNbₓO₃CuV”, Optics Letters, vol. 14 pp. 1017-1019 (1989). The photorefractive effect enables the recording of optical information in a crystal, by spatially modulating its index of refraction in response to light energy it absorbs. The absorbed light photoionizes charge carriers from their traps to the conduction band (electrons) or the valence band (holes). The photoionized charge carriers are transported and eventually retrapped, forming a space charge field spatially correlated with the exciting illumination, and inducing a modulation in the index of refraction through the electrooptic effect. This mechanism is the basis for information storage in the form of phase holograms that can be selectively retrieved by applying the reconstructing (reading) light beam at the appropriate wavelength and angle.

It has also been shown possible to introduce dipolar holographic gratings into photorefractive crystals by the introduction of a spatial modulation of the low frequency dielectric constant. This effect has been described by A. J. Agranat, M. Razvag and M. Balberg in “Dipolar holographic gratings induced by the photorefractive process in potassium lithium tantalate niobate at the paraelectric phase”, Journal of the Optical Society of America B, vol. 14 pp. 2043-2048 (1997). In the paraelectric phase, the efficiency of these effects can be controlled by applying an external electric field on the crystals during the reading (reconstructing) stage. Electroholography (EH) is based on this capability.

As indicated above, the physical basis of Electroholography is the voltage controlled photorefractive (PR) effect. In general, the PR effect enables the recording of optical information in a crystal, by spatially modulating the index of refraction of the crystal in response to light energy that the crystal absorbs. In its simplest form the photorefractive effect is initiated by illuminating a crystal with the interference pattern of two mutually coherent beams. The absorbed light photoionizes charge carriers from their traps to the conduction band (electrons) or the valence band (holes). The photoionized charge carriers are transported and eventually retrapped, forming a space charge field that is spatially correlated with the exciting illumination, and inducing a modulation in the index of refraction of the crystal through the electrooptic effect. In most photorefractive (PR) crystals the electrooptic effect is linear. However, in PR crystals at the paraelectric phase the electrooptic effect is quadratic, whereby an applied external field controls the diffraction efficiency of the holographic grating induced by the space charge. The use of the quadratic electrooptic effect enables analog control of the reconstruction of the previously written information.

KLTN is a photorefractive crystal designed to be operated in the paraelectric phase, where the photorefractive effect is voltage controlled. Composition and method of production of this crystal are described in previously cited U.S. Pat. Nos. 5,614,129 and 5,785,898. The preferred chemical composition of the KLTN crystal used in switch 100, of FIGS. 1A-1D, is K_{0.9945}Li_{0.0055}Ta_{0.65}Nb_{0.35}O₃. The phase transition temperature of the KLTN crystal used, as determined by measurement of the temperature dependence of the dielectric constant, is T_{C}=26° C. In order to improve performance of the crystal, prior to writing the holograms, the crystals are subjected to a poling process in which they are gradually cooled at 0.5° C./minute from about 40° C. to about 10° C. under an external field of 2.1 kV/cm, and then warmed up to the operational temperature at the same rate. During operation, the crystal is held at 32° C., which is 6° C. above its phase transition temperature, well within the paraelectric phase. The temperature is maintained by means of a stabilized thermoelectric element (not shown) in juxtaposition to crystals 10 and 11.

In PCT International Patent Application Publication No. WO 01/07946, of PCT Patent Application No. PCT/IL00/00426, and, in co-filed U.S. patent application Ser. No. 09/621,874, each taking priority from IL Patent Application No. 131,118, filed Jul. 26, 1999, by a same inventor of the present invention, there is disclosed an “Electroholographic Wavelength Selective Photonic Switch For WDM Routing”, the teachings of which are incorporated by reference as if fully set forth herein. Therein, in FIG. 2 (also included herein), is a schematic diagram illustrating operation of the basic embodiment of the switching and routing device 110, featuring a matrix configuration of four Electroholography based switches, each featuring a single paraelectric photorefractive crystal incorporating a prestored holographic grating. As described therein, in general, device 110 is for switching and routing light of any of a plurality of discrete wavelengths to any of a plurality of output conduits, and includes an Electroholography based switch, for each wavelength and for each output conduit, for switching a controllable portion of the light of each wavelength to each output conduit, where the Electroholography based switches of a common output conduit are optically coupled, and, where the Electroholography based switches of a common wavelength are optically coupled.

Referring to FIG. 2, device 110 receives a plurality of concurrent WDM data streams from an input optical fiber 102. The two data streams whose carrier wavelengths are λ₁ and λ₂ are partially or totally diverted to output optical fibers 104a and 104b. The remainder of the input data streams continues undiverted into common output optical fiber 106. Device 110 includes two wavelength specific filters 112a and 112b and four switches, each switch analogous to switch 100 previously described above with reference to FIGS. 1A-1B, switch 100aa, switch 100ab, switch 100ba and switch 100bb, arranged in a matrix as shown. Filter 112a diverts the data stream whose carrier wavelength is λ₁ to switches 100aa and 100ba. Filter 112b diverts the data stream whose carrier wavelength is λ₂ to switches 100ab and 100bb. Filters 112 are demultiplexing narrow band filters, for example, interference filters or Bragg grating filters. Such filters are well known in the art, and are used, for example, in the DWDM1F series of demultiplexers available from E-TEK Dynamics, Inc. San Jose, Calif., USA. Alternatively, filters 112 are photorefractive crystals, such as crystals 10 and 11, with diffraction gratings such as gratings 17 and 19 incorporated therein and activated by appropriate voltages to provide nearly full diversion of their respective data streams.

In FIG. 2, switches 100 are illustrated as being positioned in a square grid. In general, the grid is oblique, with the grid angles and the grating spacings of the holographic gratings of switches 100 chosen, in accordance with the Bragg condition, so that switches 100aa and 100ba act only on light in a narrow band of wavelengths (narrower than Δλ) around carrier wavelength λ₁ and pass light of all other wavelengths, and so that switches 100ab and 100bb act only on light in a narrow band of wavelengths around carrier wavelength λ₂ and pass light of all other wavelengths. In the preferred embodiment of device 110, the grid is in fact square (or, more generally, rectangular, whereby the grid angle is 90°), in order to obtain as compact a device 110 as possible and to simplify the manufacture of device 110 with regard to issues such as alignment and collimation. The grating spacings of the holographic gratings are chosen to obtain Bragg angles of 45° relative to the corresponding wavelengths.

By appropriately adjusting the voltages applied to switches 100aa and 100ba, the data stream of carrier wavelength λ₁ is diverted to any desired degree, from no diversion to almost total diversion, to either or both of output optical fibers 104. Similarly, by appropriately adjusting the voltages applied to switches 100ab and 100bb, the data stream of carrier wavelength λ₂ is diverted to any desired degree, from no diversion to almost total diversion, to either or both of optical fibers 104. The diversion of the data stream of carrier wavelength λ₁ is totally independent of the diversion of the data stream of carrier wavelength λ₂. Either output optical fiber 104 may receive only the data stream of carrier wavelength λ₁, only the data stream of carrier wavelength λ₂, both data streams or neither data stream. Switches 100ab and 100bb have no effect on the data stream of wavelength λ₁, so that the data stream of wavelength λ₁ passes unaffected through switches 100ab and 100bb. Thus, each row of switches 100 in device 110 functions as an optical coupler. In a preferred embodiment of device 110, all four switches 100 are fabricated in the same photorefractive crystal.

In the disclosure of PCT Pat. Appl. Publication No. WO 01/07946 and of co-filed U.S. patent application Ser. No. 09/621,874, there is described various alternative embodiments of device 110 for variably switching and routing the WDM data streams from input optical fiber 102, several of which are briefly summarized as follows.

In the first alternative embodiment of device 110, the columns of switches 100 end in detectors that receive light of wavelengths λ₁ and λ₂ not diverted by switches 100. These detectors convert the undiverted light to electrical voltages that are proportional to the intensities of the undiverted light. These detectors typically are integrated in electronic devices that perform system functions such as error detection, network monitoring and analysis, and data monitoring and analysis. In the second alternative embodiment of device 110, the columns of switches 100 end in additional Electroholography based switches for diverting the light of wavelengths λ₁ and λ₂ not diverted by switches 100 to a common uplink conduit. In third and fourth alternative embodiments of device 110 a mechanism is included for verifying that switches 100 actually switch the data streams as intended. In the third alternative embodiment, a diversion mechanism such as a beamsplitter or yet another Electroholography based switch intervenes between each row of switches 100 and the corresponding output optical fiber 104. The diversion mechanism diverts a preferably controllable portion of the light emerging from that row of switches 100 to a detector. In the fourth alternative embodiment of device 110, each column of switches 100 is provided with a light source that emits coherent light at a wavelength other than the wavelength switched by that column of switches 100. This light also is diverted, at least partially, by the holographic gratings of switches 100 of that column, but in a direction other than the row direction, to be detected by appropriate detectors.

In the same disclosure, there is also described compound devices based on operatively combining the above described alternative embodiments of the basic device 110 as modules, several of which are briefly summarized as follows.

In the first compound device, for increasing the number of output ports, based on two modules, the second module lacks filters 112, and the light not switched by the columns of switches 100 of the first module goes directly to the columns of switches 100 of the second module, to be switched, entirely or in part, to output optical fibers 104 of the second module. In the second compound device, also for increasing the number of output ports, also based on two modules, the first module is one of the alternative embodiments, described above, in which the columns of switches 100 end in additional Electroholography based switches that divert the light emerging from the columns to a common uplink conduit. The uplink conduit then serves as input conduit 102 of the second module. In the third compound device, for increasing the number of wavelengths operated upon, also based on two modules, both modules are the enhanced module, described above, in which the columns of switches 100 end in additional Electroholography based switches that divert the light emerging from the columns to a common uplink conduit, and the uplink conduit is shared by both modules. In addition, the rows of switches 100 of the two modules are coupled into common output optical fibers 104, either by optically coupling the rows of switches 100 of the first module to the rows of switches 100 of the second module, or by joining output optical fibers 104 of the first module to output optical fibers 104 of the second module at y-junctions. In the fourth compound device, based on several modules, each with its own input optical fiber 102, corresponding output optical fibers 104 of the various modules lead to common couplers. The inputs of each coupler then are combined into a common output fiber leading from that coupler. In the fifth compound device, based on two modules, the first module has an equal number of rows and columns of switches 100, and the output conduits of the first module are not optical fibers 104, but instead are transponders, each of which converts input light into similar light at a respective output wavelength. Each transponder is optically coupled to a respective column of switches 100 of the second module.

In the same disclosure, there is also described an add-drop multiplexer, including a drop module and an add module, for removing data streams at carrier wavelengths λ₁ and λ₂, from a collection of concurrent data streams that include data streams at these and other wavelengths, and substituting for them other data streams at carrier wavelengths λ₁ and λ₂,. Output optical fibers 104 of the drop module are diversion conduits that carry the data streams being dropped to their respective destinations. The add module receives the surviving data streams from the drop module, and also receives input from substitution conduits that carry substitution data streams at their respective carrier wavelengths, λ₁ or λ₂. The substitution data streams are merged with the input from the drop module using optical components such as y-junctions, or, alternatively using Electroholography based switches in a manner similar to that used in the second alternative embodiment of device 110 to merge undiverted light of wavelengths λ₁ and λ₂ to a common uplink conduit.

In the same disclosure, there is also described a holographic tap for power management, by diverting portions of selected channels from a common optical fiber, using Electroholography based switches 100 specific to the carrier wavelengths of the selected channels. The diverted light is converted to electronic signals by suitable detectors, and the signals are used for optical communication system management functions. For example, in a holographic tap downstream from an amplifier, voltages applied to switches 100 are adjusted to equalize the powers in the tapped channels.

The wavelength specific photonic switching and routing technology disclosed in PCT Pat. Appl. Publication No. WO 01/07946 and in co-filed U.S. patent application Ser. No. 09/621,874, provides a way to readily ‘access’ a variety of optical transmissions of an optical communication system without intervening the all optical data path of the system. This is performed by using the residual (‘left-over’) signal from the switching of the optical signals in the Electroholography based switches, where the residual signal is a well defined portion of an original, single, optical signal, so it can be used to restore characteristics of the original signal for network management analysis, and, for network control. However, the invention of that disclosure is notably limited with respect to several significant aspects of switching and routing, while logically managing and controlling, a plurality of optical signals in a multichannel optical communication system.

In a first notably limiting aspect, therein is described switching and routing a single optical signal associated with a plurality of channels at a single input conduit or port only, that is input conduit or port 102 of each matrix or module 110 (FIG. 2) without describing switching and routing of a plurality or multiple of optical signals associated with a corresponding plurality or multiple of channels at a plurality or multiple of input conduits or ports, as is typical of commercial optical communication systems.

In a second notably limiting aspect, therein are described various different embodiments of using Electroholography based optical switches only, that is, Electroholography based switches 110 (FIG. 2), based on Electroholography based switch 100 (FIGS. 1A and 1B), where, in fact, currently operational commercial optical communication systems feature various types of optical switches for switching and routing multichannel optical signals.

In a third notably limiting aspect, therein are described management of specific signals only, that is, management of residual or left-over signals, and/or, management of input and output signals specifically for power management. In particular, according to that disclosure, a residual signal can be diverted to an output conduit as an optical signal and/or converted to electrical signals by a detector for performing power, error, and, data, analysis. Such a residual signal can be analyzed by system management devices for determining the efficacy of signal transmission. In actual commercial optical communication systems, there is a need for variably ‘logically’ managing and controlling different types of optical signals at any number of various transmission and/or reception points within the system, and, not limited to only managing residual or left-over and/or input and output signals for power management.

In a fourth notably limiting aspect, therein is limited description relating to only specific component configurations and architectures of the management of optical signals of the system.

In additional notably limiting aspects, therein is described various different embodiments of using optical switching and routing matrix or module 110 (FIG. 2) for specific applications only, with respect to matrix or module architecture, wavelength density and resolution of cross-talk of optical signals, and, adding and dropping of optical signals.

Overcoming each of these notably limiting aspects with respect to switching and routing multichannel optical signals in an optical communication system, requires the introduction of sophisticated new and enabling methodology and system features, which are not obviously derived from prior art, in general, and, not obviously derived from the invention disclosed in PCT Pat. Appl. Publication No. WO 01/07946 and in co-filed U.S. patent application Ser. No. 09/621,874, in particular.

There is thus a need for, and it would be highly advantageous to have a method and system for switching and routing, while logically managing and controlling, multichannel optical signals in an optical communication system.

### SUMMARY OF THE INVENTION

The present invention relates to a method and system for switching and routing, while logically managing and controlling, multichannel optical signals in an optical communication system.

The present invention provides a sophisticated new and inventive way to readily ‘access’ a variety of multichannel optical transmissions in an optical communication system without intervening the all optical data path of the system, by way of ‘logically’ managing and controlling the switching and routing of the multichannel optical signals in the optical communication system.

The present invention provides a method and system for switching and routing, while logically managing and controlling, a plurality or multiple of optical signals associated with a corresponding plurality or multiple of channels at a plurality or multiple of input conduits or ports, as is typical of commercial optical communication systems.

The present invention is readily implemented by using Electroholography based optical switches, as well as by using other types of optical switches.

The present invention provides a method and system for variably and logically managing and controlling different types of optical signals at any number of various transmission and/or reception points within the system, and, is not limited to only managing residual or left-over and/or input and output signals for power management.

The present invention provides unique and inventive embodiments relating to optical package (OP) array architecture for switching and routing of the multichannel optical signals in an optical communication system, switching and routing functions such as grouping wavelengths, multicasting wavelengths, adding and/or dropping single wavelengths, adding and/or dropping groups of a plurality of wavelengths, converting wavelengths, restoring wavelengths, and, supporting increased wavelength density while maintaining cross-talk between neighboring channels within an acceptable range.

Additionally, the present invention provides unique and inventive configurations and architectures of the logical management and control of the switching and routing of the multichannel optical signals in an optical communication system.

Thus, according to the present invention, there is provided a method for switching and routing, while logically managing and controlling, multichannel optical signals in an optical communication system, comprising the steps of: (a) providing an optical package (OP) array as an array of H rows by W columns, denoted as an [H×W] dimensioned OP array, of (i) optically connected optical switch (OS) elements, wherein an optical switch (OS) element at a row h and a column w, for h=1 to H, and, w=1 to W, respectively, is denoted as OS(h,w), (ii) optically connected left input ports and bottom side input ports, and, (iii) optically connected right output ports and top side output ports, whereby each optical switch (OS) element is a device dynamically activated by an external control and features characteristics of: (1) selectivity to a particular wavelength, λ; (2) when the optical switch (OS) element is not activated, the optical switch (OS) element is transparent, by inducing very small loss, to light in a wavelength range of a multichannel optical signal; and (3) when the optical switch (OS) element is activated, then part of the light at a particular wavelength, λ, is diverted at a predetermined angle, whereby percentage of the light diverted compared to percentage of the light not diverted is a function of level of activation of the optical switch (OS) element, and, whereby the activated optical switch (OS) element is transparent to all other wavelengths; and (b) providing a management and control logic mechanism (MCLM) operatively connected to the optical package array, for logically managing and controlling the switching and routing of the light entering and exiting the optical switch (OS) elements via the optically connected left side input ports and bottom side input ports, and, via the optically connected right side output ports and top side output ports, and, for preventing a conflict of routing components with a same wavelength, λ, of the optical signals from different input ports to a same output port.

According to another aspect of the present invention, there is provided a system for switching and routing, while logically managing and controlling, multichannel optical signals in an optical communication system, comprising: (a) an optical package (OP) array as an array of H rows by W columns, denoted as an [H×W] dimensioned OP array, of (i) optically connected optical switch (OS) elements, wherein an optical switch (OS) element at a row h and a column w, for h=1 to H, and, w=1 to W, respectively, is denoted as OS(h,w), (ii) optically connected left side input ports and bottom side input ports, and, (iii) optically connected right side output ports and top side output ports, whereby each optical switch (OS) element is a device dynamically activated by an external control and features characteristics of: (1) selectivity to a particular wavelength, λ; (2) when the optical switch (OS) element is not activated, the optical switch (OS) element is transparent, by inducing very small loss, to light in a wavelength range of a multichannel optical signal; and (3) when the optical switch (OS) element is activated, then part of the light at a particular wavelength, λ, is diverted at a predetermined angle, whereby percentage of the light diverted compared to percentage of the light not diverted is a function of level of activation of the optical switch (OS) element, and, whereby the activated optical switch (OS) element is transparent to all other wavelengths; and (b) a management and control logic mechanism (MCLM) operatively connected to the optical package array, for logically managing and controlling the switching and routing of the light entering and exiting the optical switch (OS) elements via the optically connected left side input ports and bottom side input ports, and, via the optically connected right side output ports and top side output ports, and, for preventing a conflict of routing components with a same wavelength, λ, of the optical signals from different input ports to a same output port.

According to further features in preferred embodiments of the invention described below, the optical package (OP) array features characteristics of: (1) the light may travel by entering and/or exiting along the rows and/or along the columns of the optical package (OP) array, whereby (I) the light may enter a row h at left side of the optical package (OP) array via a corresponding left side input port, (II) the light may enter a column w at bottom side of the optical package (OP) array via a corresponding bottom side input port, (III) the light may exit from a row h at right side of the optical package (OP) array via a corresponding right side output port, and, (IV) the light may exit from a column w at top side of the optical package (OP) array via a corresponding top side output port; and (2) the light diverted by a particular optical switch (OS) element is grouped with other light entering same optical switch (OS) element and traveling in a same direction as the diverted light.

According to further features in preferred embodiments of the invention described below, the optical package (OP) array features additional characteristics of: (3) all the optical switch (OS) elements in a column w are selective to a specific wavelength, λ_{w}; (4) when the light traveling in a row h hits an active optical switch (OS) element in a column w, at least a portion of λ_{w} component of the light is diverted upwards, joining any other light traveling in the same column; and (5) when the light traveling in a column w hits an active optical switch (OS) element in a row h, at least a portion of the λ_{w} component of the light is diverted to the right side, joining any other light traveling in a same row.

According to further features in preferred embodiments of the invention described below, each optical switch (OS) element is a voltage controlled Electroholography based optical switch.

According to further features in preferred embodiments of the invention described below, a plurality of the optical package (OP) arrays are used as optical package (OP) building blocks, OPBBs, for forming a scaled-up optical package (OP) array featuring P*Y rows and Q*X columns of the OS elements, wherein each OP building block, OPBB(p,q), for p=1 to P, and q=1 to Q, is composed of Y rows and X columns of the OS elements, and, whereby the OPBBs are chained according to: for p=1 to P−1, and, q=1 to Q−1, all 1 to the Y rows at right side of the OPBB(p,q) are optically connected to corresponding rows at left side of OPBB(p,q+1), and, all 1 to the X columns at top side of the OPBB(p,q) are optically connected to corresponding columns at bottom side of OPBB(p+1,q).

According to further features in preferred embodiments of the invention described below, a plurality of the optical package (OP) arrays are used for forming an all optical cross connect (AOXC) chained optical package (COP) architecture featuring a three dimensional [N×M×K] array of the optical package (OP) arrays, where the N is number of input fibers, the M is number of output fibers, and, K is number of wavelengths λₖ, for k=1 to K, per fiber operated upon by the AOXC COP architecture.

According to further features in preferred embodiments of the invention described below, not all the K wavelengths operated upon by the AOXC COP architecture must be present in each fiber.

According to further features in preferred embodiments of the invention described below, each fiber may carry additional wavelengths other than the K wavelengths, the additional wavelengths may be different in the fibers.

According to further features in preferred embodiments of the invention described below, the AOXC COP architecture has two sets of optional components: (1) N input-residuals output fibers, where each input-residuals output fiber n, for n=1 to N, is optically connected to a corresponding input-residuals output port n of the AOXC COP architecture, for carrying portions of the optical signals from the input fibers that do not undergo switching, and, (2) M output-grouping input fibers, where each output-grouping input fiber m, for m=1 to M, is optically connected to a corresponding output-grouping input port m of the AOXC COP architecture, for carrying the optical signals into the output fibers from sources other than from the input fibers.

According to further features in preferred embodiments of the invention described below, the AOXC COP architecture further includes a set of output signals, denoted as U leftover signals, optionally used for the logical management and control purposes by the logical management and control mechanism.

According to further features in preferred embodiments of the invention described below, the AOXC COP architecture is independently extendable in three dimensions, to a [N′×M′×K′] AOXC COP architecture, where the N′ is equal to or greater than the N, the M′ is equal to or greater than the M, and, the K′ is equal to or greater than the K.

The present invention successfully overcomes all of the previously described notable limitations of presently known techniques for switching and routing multichannel optical signals in an optical communication system.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1D (prior art) is a schematic diagram illustrating operation of an Electroholography based optical switch featuring one or two paraelectric photorefractive crystals each incorporating a prestored holographic grating, as disclosed in PCT Pat. Appl. Publication No. WO 00/02098 and in co-filed U.S. patent application Ser. No. 09/348,057;

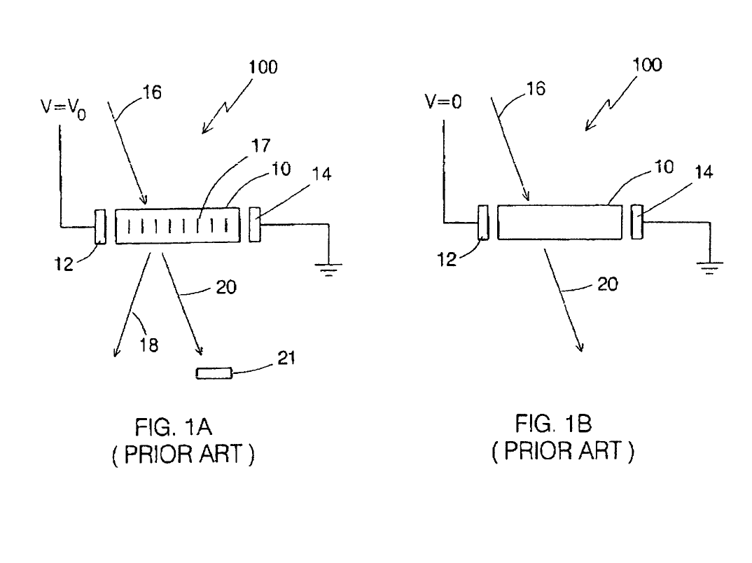

FIG. 2 (prior art) is a schematic diagram illustrating operation of the basic embodiment of the switching and routing device, featuring a matrix configuration of four Electroholography based switches of FIGS. 1A-1B, each featuring a single paraelectric photorefractive crystal incorporating a prestored holographic grating, as disclosed in PCT Pat. Appl. Publication No. WO 01/07946 and in co-filed U.S. patent application Ser. No. 09/621,874;

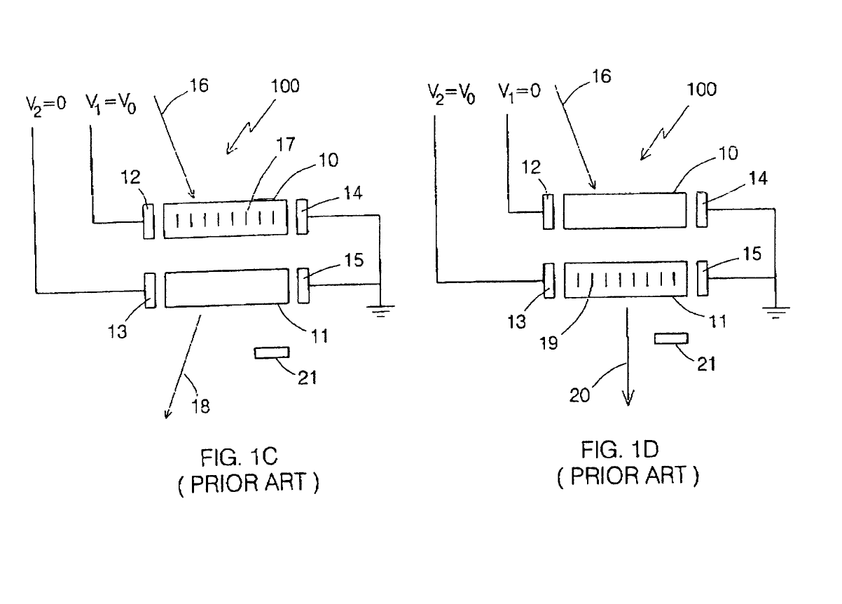

FIG. 3 is a schematic diagram illustrating an exemplary preferred embodiment of the basic system of the present invention featuring an optical package (OP) array of optical switch (OS) elements, input ports and output ports, and, a management and control logic mechanism (MCLM), used for forming the general embodiment of the extendable all optical cross connect (AOXC) chained optical package (COP) architecture, and, different specific embodiments of extendable all optical cross connect (AOXC) chained optical package (COP) architectures, in accordance with the present invention;

FIG. 4 is a schematic diagram illustrating an exemplary preferred embodiment of a scaled-up system of the present invention featuring a plurality of the basic optical package (OP) array of optical switch (OS) elements, input ports and output ports, and, a correspondingly scaled-up management and control logic mechanism (MCLM), in accordance with the present invention;

FIG. 5 is a schematic diagram illustrating the general embodiment of the extendable all optical cross connect (AOXC) chained optical package (COP) architecture, derived from the basic system illustrated in FIG. 3, in accordance with the present invention;

FIG. 6 is a schematic diagram illustrating a specific embodiment of the extendable all optical cross connect (AOXC) chained optical package (COP) architecture (FIG. 5), as a ‘Basic Chained Input’ (‘BCI’) AOXC COP architecture, in accordance with the present invention;

FIG. 7 is a schematic diagram illustrating a specific embodiment of the extendable all optical cross connect (AOXC) chained optical package (COP) architecture (FIG. 5), as a ‘Basic Integrated Chained Input’ (‘BICI’) AOXC COP architecture, in accordance with the present invention;

FIG. 8 is a schematic diagram illustrating a specific embodiment of the extendable all optical cross connect (AOXC) chained optical package (COP) architecture (FIG. 5), as a ‘Basic Chained Output’ (‘BCO’) AOXC COP architecture, in accordance with the present invention;

FIG. 9 is a schematic diagram illustrating a specific embodiment of the extendable all optical cross connect (AOXC) chained optical package (COP) architecture (FIG. 5), as a ‘Basic Integrated Chained Output’ (‘BICO’) AOXC COP architecture, in accordance with the present invention;

FIG. 10 is a schematic diagram illustrating a specific embodiment of the extendable all optical cross connect (AOXC) chained optical package (COP) architecture (FIG. 5), as a ‘Basic Wavelength-Chained Output’ (‘BWCO’) AOXC COP architecture, in accordance with the present invention;

FIG. 11 is a schematic diagram illustrating a specific embodiment of the extendable all optical cross connect (AOXC) chained optical package (COP) architecture (FIG. 5), as a ‘Coupled Chained Output’ (‘CCO’) AOXC COP architecture, in accordance with the present invention;

FIG. 12 is a schematic diagram illustrating a specific embodiment of the extendable all optical cross connect (AOXC) chained optical package (COP) architecture (FIG. 5), as a ‘Coupled Integrated Chained Output’ (‘CICO’) AOXC COP architecture, in accordance with the present invention;

FIG. 13 is a schematic diagram illustrating a specific embodiment of the extendable all optical cross connect (AOXC) chained optical package (COP) architecture (FIG. 5), as a ‘Mixed Chained Output’ (‘MCO’) AOXC COP architecture, in accordance with the present invention;

FIG. 14 is a schematic diagram illustrating a specific embodiment of the extendable all optical cross connect (AOXC) chained optical package (COP) architecture (FIG. 5), as a ‘Mixed Integrated Chained Output’ (‘MICO’) AOXC COP architecture, in accordance with the present invention;

FIG. 15 is a schematic diagram illustrating a specific embodiment of the extendable all optical cross connect (AOXC) chained optical package (COP) architecture (FIG. 5), as a ‘Mixed Wavelength-Chained Output’ (‘MWCO’) AOXC COP architecture, in accordance with the present invention;

FIG. 16 is a schematic diagram illustrating a specific embodiment of the extendable all optical cross connect (AOXC) chained optical package (COP) architecture (FIG. 5), as an ‘Interleaved Modular Configuration’ AOXC COP architecture, in accordance with the present invention;

FIG. 17 is a schematic diagram illustrating a specific embodiment of the general all optical cross connect (AOXC) chained optical package (COP) architecture of FIG. 5 (A14), featuring an ‘add’ mechanism and a ‘drop’ mechanism, for adding and/or dropping single wavelengths, in accordance with the present invention;

FIG. 18 is a schematic diagram illustrating a specific embodiment of the general all optical cross connect (AOXC) chained optical package (COP) architecture (FIG. 5), featuring a grouped ‘add’ mechanism and a grouped ‘drop’ mechanism, for adding and/or dropping groups of a plurality of wavelengths, in accordance with the present invention;

FIG. 19A is a schematic diagram illustrating an exemplary embodiment of the management and control logic mechanism (MCLM) of the extendable all optical cross connect (AOXC) chained optical package (COP) architecture system, featuring single optical signal tapping and routing to multiple detectors, in accordance with the present invention;

FIG. 19B is a schematic diagram illustrating an exemplary embodiment of the management and control logic mechanism (MCLM) of the extendable all optical cross connect (AOXC) chained optical package (COP) architecture system, featuring single optical signal tapping and routing to a single detector, in accordance with the present invention;

FIG. 20 is a schematic diagram illustrating an exemplary embodiment incorporating an extendable all optical cross connect (AOXC) chained optical package (COP) architecture as part of the management and control logic mechanism (MCLM), in accordance with the present invention;

FIG. 21 is a schematic diagram illustrating an exemplary preferred embodiment of a basic optical switching cell for housing each optical switch (OS) element, in accordance with the present invention;

FIG. 22 is a schematic diagram illustrating beam switching by an optical switch (OS) element within the exemplary preferred embodiment of the basic optical switching cell of FIG. 21, in accordance with the present invention;

FIG. 23 is a schematic diagram illustrating an exemplary preferred embodiment of a mechanical frame for housing a 3-D array of optical switch (OS) elements, in accordance with the present invention;

FIG. 24 is a schematic diagram illustrating the exemplary preferred embodiment of the mechanical frame of FIG. 23 populated with optical switch (OS) elements, in accordance with the present invention;

FIG. 25 is a schematic diagram illustrating an exemplary embodiment of the 3-D array of optical switch (OS) elements, without the mechanical frame, together with the axes of the 3-D array and connections to input and output ports of an exemplary embodiment of an AOXC COP architecture system of the present invention, including two management and control logic layers, and, an interface for optically connecting detectors of management and control logic mechanism (MCLM) to the optical switch (OS) elements of these layers, in accordance with the present invention;

FIG. 26 is a schematic diagram illustrating highlighting of the various planes of the 3-D array of optical switch (OS) elements of FIG. 25 (B5), in accordance with the present invention;

FIG. 27 is a schematic diagram illustrating the input connections and input residuals layer, indicating the optical switch (OS) elements in this layer, and the connections to the input ports and the input residuals, of the 3-D array of optical switch (OS) elements of FIG. 25, in accordance with the present invention;

FIG. 28 is a schematic diagram illustrating the output groupings and an output connections layer, indicating the optical switch (OS) elements in this layer, and the connections to the output and output grouping ports, of the 3-D array of optical switch (OS) elements of FIG. 25, in accordance with the present invention;

FIG. 29 is a schematic diagram illustrating the mechanism of triple switching, of the 3-D array of optical switch (OS) elements of FIG. 25, in accordance with the present invention;

FIG. 30 is a schematic diagram illustrating the grouping operation in the 3-D array of optical switch (OS) elements of FIG. 25, in accordance with the present invention;

FIG. 31 is a schematic diagram illustrating the multicasting operation in the 3-D array of optical switch (OS) elements of FIG. 25, in accordance with the present invention;

FIG. 32 is a schematic diagram illustrating highlighting of the second-switching management-and-control layer of the 3-D array of optical switch (OS) elements of FIG. 25, together with an interface for optically connecting second-switching management detectors to the optical switch (OS) elements of this layer, in accordance with the present invention;

FIG. 33 is a schematic diagram illustrating the switching and routing operations within the second-switching management-and-control layer, of the 3-D array of optical switch (OS) elements of FIG. 25, in accordance with the present invention;

FIG. 34 is a schematic diagram illustrating highlighting of the third-switching management-and-control layer of the 3-D array of optical switch (OS) elements of FIG. 25, together with an interface for optically connecting third-switching management detectors to the optical switch (OS) elements of this layer, in accordance with the present invention; and

FIG. 35 is a schematic diagram illustrating the switching and routing operations within the third-switching management-and-control layer, of the 3-D array of optical switch (OS) elements of FIG. 25, in accordance with the present invention.

### DESCRIPTION OF THE PREFERRED EMBODIMENTS

The present invention relates to a method and system for switching and routing, while logically managing and controlling, multichannel optical signals in an optical communication system.

A main aspect of novelty and inventiveness of the present invention is the basic system featuring an optical package (OP) array of optical switch (OS) elements, input ports and output ports, operating with a management and control logic mechanism (MCLM) logically managing and controlling the switching and routing of the multichannel optical signals in the optical communication system. The basic system of the optical package (OP) array is used for deriving or forming the general embodiment of an extendable all optical cross connect (AOXC) chained optical package (COP) architecture, and, for deriving or forming different specific embodiments of extendable all optical cross connect (AOXC) chained optical package (COP) architectures.

Another main aspect of novelty and inventiveness relates to the implementation of different specific optical signal switching and routing functions, such as grouping wavelengths, multicasting wavelengths, adding and/or dropping wavelengths, converting wavelengths, and, restoring wavelengths, while logically managing and controlling the switching and routing of the multichannel optical signals in the optical communication system.

The method and system for switching and routing, while logically managing and controlling, multichannel optical signals in an optical communication system, of the present invention, are neither anticipated or obviously derived from the “Electroholographic Wavelength Selective Photonic Switch For WDM Routing”, as disclosed in PCT Pat. Application. Publication No. WO 01/07946 and in co-filed U.S. patent application Ser. No. 09/621,874.

It is to be understood that the invention is not limited in its application to the details of the order or sequence of steps of operation or implementation of the method, or, to the details of construction, arrangement, and, composition of the components and elements of the system, set forth in the following description, drawings, or examples. The invention is capable of other embodiments or of being practiced or carried out in various ways.

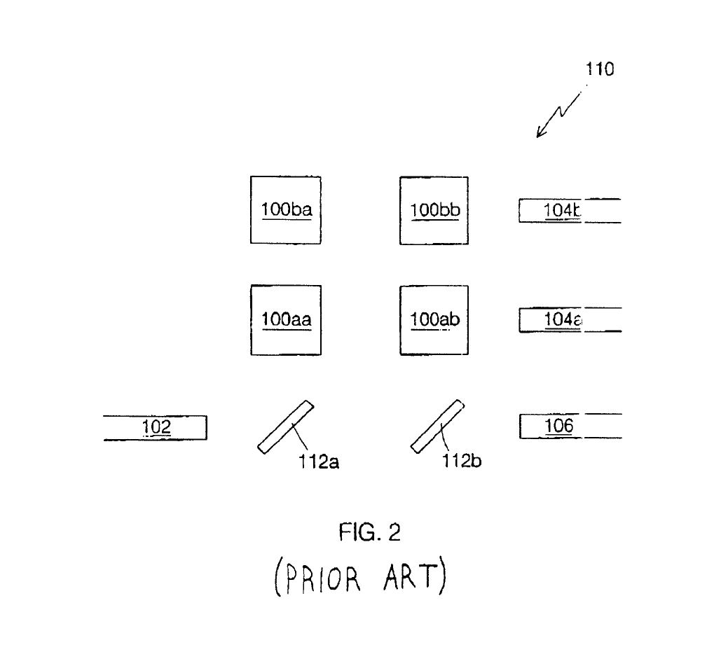

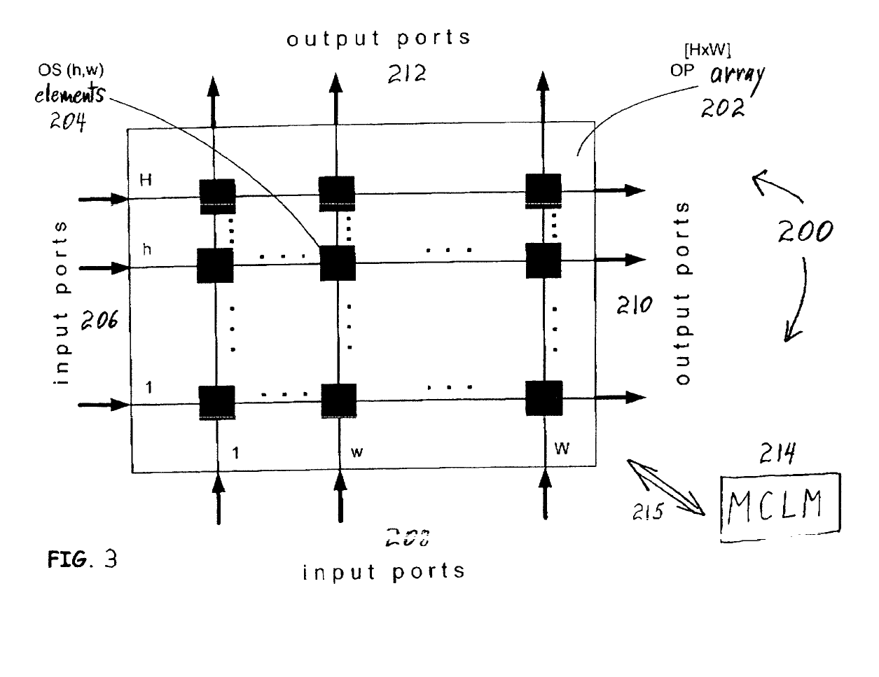

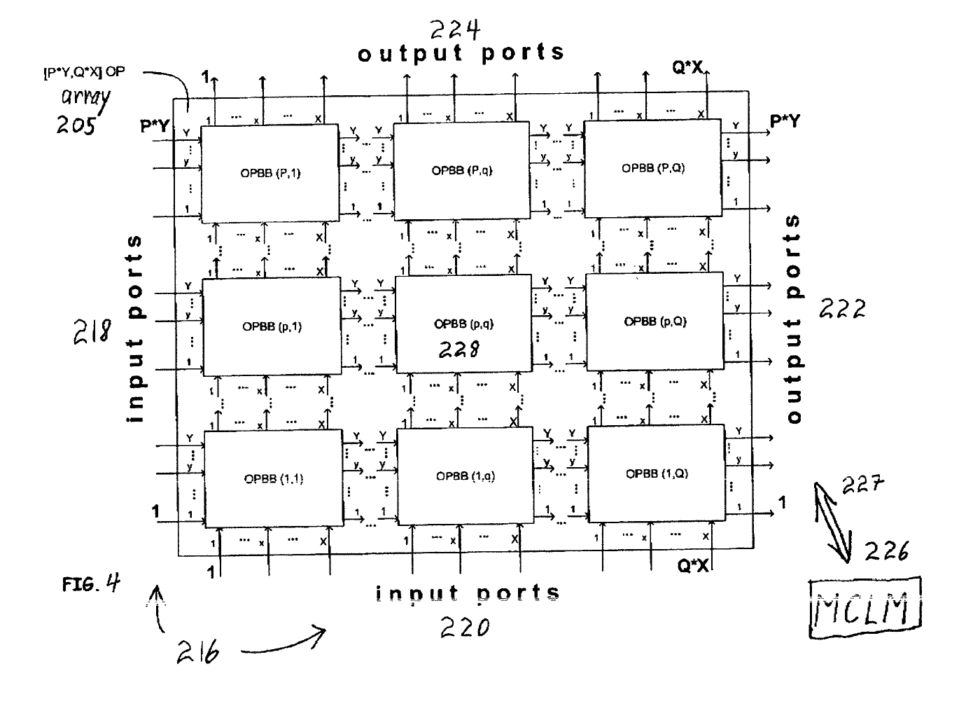

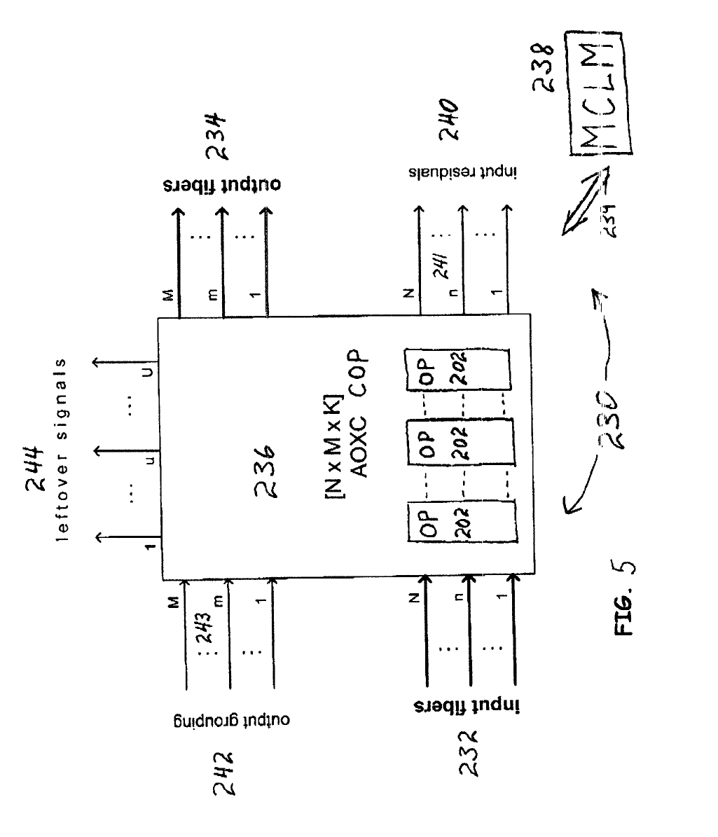

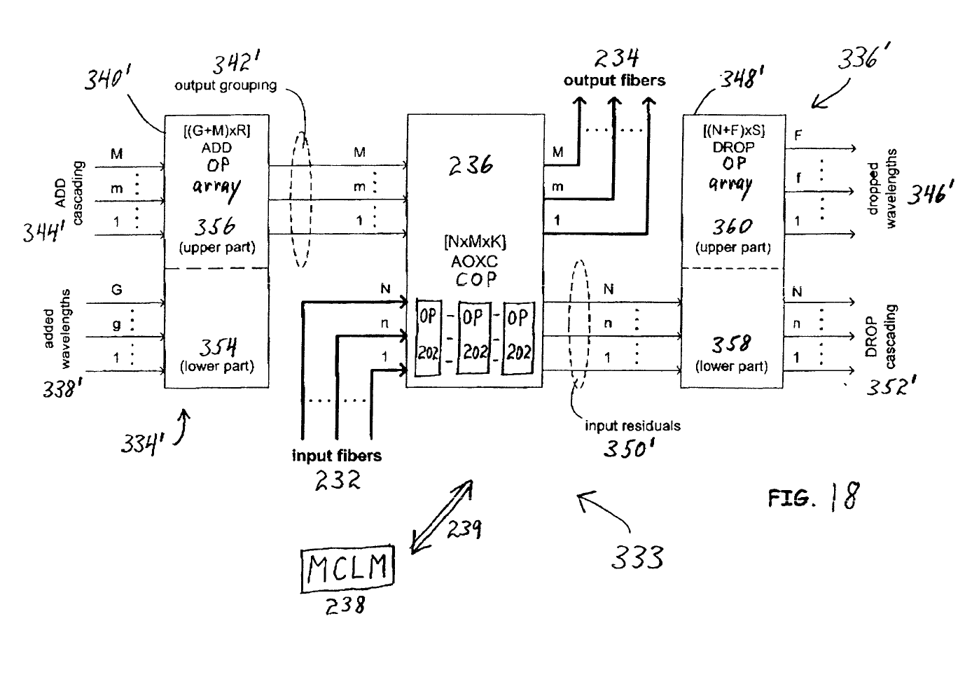

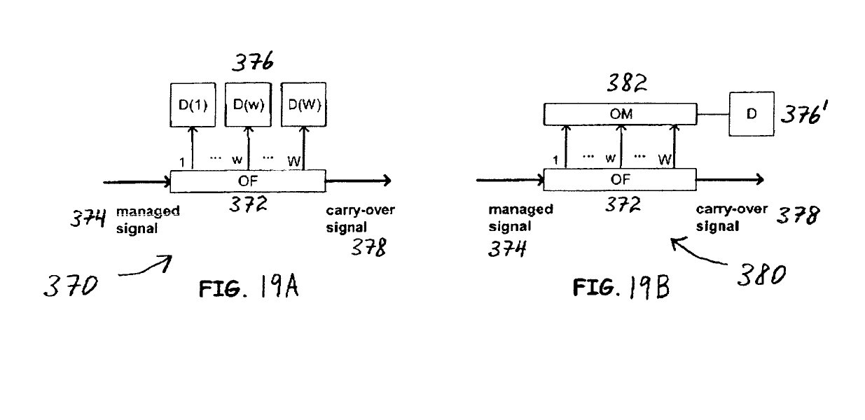

For example, for implementing basic system 200 featuring optical package (OP) array 202 of optical switch (OS) elements 204, and, management and control logic mechanism 214 (FIG. 3); scaled-up system 216 featuring scaled-up optical package (OP) array 205, and, scaled-up management and control logic mechanism (MCLM) 226 (FIG. 4); general embodiment of extendable all optical cross connect (AOXC) chained optical package (COP) architecture 230 featuring [N×M×K] dimensioned AOXC COP array 236 of OP arrays 202, and, management and control logic mechanism 238 (FIG. 5); the different specific embodiments of extendable all optical cross connect (AOXC) chained optical package (COP) architectures (FIGS. 6-18); and, the various additional embodiments (FIGS. 19-35), of the present invention, preferably, but in a non-limiting fashion, each optical switch (OS) element, indicated in these embodiments as optical switch (OS) element 204, or, as part of an optical multiplexer (OM) 252, or, as part of an optical filter (OF) element 264, is a voltage controlled Electroholography based optical switch, such as the optical switch (OS) element described in previously cited PCT International Patent Application Publication No. WO 00/02098, of PCT Patent Application No. PCT/IL99/00368, and, in co-filed U.S. patent application Ser. No. 09/348,057, each taking priority from IL Patent Application No. 125,241, by a same inventor of the present invention, the teachings of which are incorporated by reference as if fully set forth herein.

It is also to be understood that phraseology and terminology employed herein are for the purpose of description and should not be regarded as limiting. For example, the following description refers to switching and routing of optical communication signals corresponding to switching and routing of optical communication channels, where each optical communication channel is associated with a carrier wave having a particular wavelength, in order to illustrate implementation of the present invention. In fact, based on the principles of propagation of electromagnetic waves, since each particular wavelength is, by definition, associated with a particular frequency, the following description equivalently refers to switching and routing of optical communication channels, where each optical communication channel is associated with a carrier wave having a particular frequency.

Herein, for the purpose of understanding description, illustration, and, implementation, of the present invention, in a non-limiting fashion, the term ‘optically connected’ is understood by the context that two devices, components, elements, or, points, A and B, are ‘optically connected’ if light emerging from device, component, element, or, point, A, reaches device, component, element, or, point, B, and vice versa. An ‘optical connection’ is achieved via an optical path in ‘free space’, or, via an interconnecting medium such as an optical fiber, utilizing optical collimators and/or optical connectors, if necessary.

Herein, for the purpose of understanding description, illustration, and, implementation, of the present invention, in a non-limiting fashion, the term ‘operatively connected’ refers to a mechanism selected from the group consisting of an electrical, electronic, magnetic, electromagnetic, mechanical, optical, and, combinations thereof, of connection between at least two devices, components, elements, and/or, points, for establishing and maintaining an operating, managing, or controlling, relationship between the devices, components, elements, and/or, points.

Steps, components, operation, and implementation of the present invention are better understood with reference to the following description and accompanying drawings. Throughout the following description and accompanying drawings, like reference numbers refer to like components or elements.

Basic System: Optical Package (OP) Array of Optical Switch (OS) Elements, Input and Output Ports, and, a Management and Control Logic Mechanism

Referring now to the drawings, FIG. 3 is a schematic diagram illustrating an exemplary preferred embodiment of the basic system, hereinafter, referred to as basic system 200, of the present invention for switching and routing, while logically managing and controlling, multichannel optical signals in an optical communication system, featuring the primary components of: (a) an optical package (OP) array 202 of (i) optically connected optical switch (OS) elements 204, (ii) optically connected left side input ports 206 and bottom side input ports 208, and, (iii) optically connected right side output ports 210 and top side output ports 212, and, (b) a management and control logic mechanism (MCLM) 214 operatively connected, via an interface 215, to optical package (OP) array 202. Basic system 200, in a non-limiting fashion, is used for forming the general embodiment of the extendable all optical cross connect (AOXC) chained optical package (COP) architecture, and, different specific embodiments of extendable all optical cross connect (AOXC) chained optical package (COP) architectures, of the present invention, described and illustrated hereinafter, below.

More specifically, in basic system 200, optical package (OP) array 202, as illustrated in FIG. 3, is an array of H rows by W columns, denoted as an [H×W] dimensioned optical package (OP) array, of (i) optically connected optical switch (OS) elements, wherein the optical switch (OS) element at a row h and a column w, for h=1 to H, and, w=1 to W, respectively, is denoted as OS(h,w) 204, (ii) optically connected left side input ports 206 and bottom side input ports 208, and, (iii) optically connected right side output ports 210 and top side output ports 212.

Each optical switch (OS) element 204 is a device that is dynamically activated by an external control (not shown), and, features characteristics of:

(1) selectivity to a particular wavelength, λ, for example, pre-programmed according to a holographic process;

(2) when optical switch (OS) element 204 is not activated, optical switch (OS) element 204 is transparent, that is, inducing very small loss, to light in a wavelength range of the multichannel optical signal; and

(3) when optical switch (OS) element 204 is activated, then part of the light at a particular wavelength, λ, is diverted at a predetermined angle, whereby the percentage of the light that is diverted compared to the percentage of the light that is not diverted is a function of the level of activation of optical switch (OS) element 204, and, whereby activated optical switch (OS) element 204 is transparent to all other wavelengths.

Management and control logic mechanism (MCLM) 214 operatively connected to optical package array 202 is for logically managing and controlling the switching and routing of light entering optical package (OP) array 202 via left side input ports 206 and bottom side input ports 208, and, exiting optical package (OP) array 202 via right side output ports 210 and top side output ports 212. Additionally, management and control logic mechanism (MCLM) 214 prevents a conflict of routing components with a same wavelength, λ, of the optical signals from different input ports 206, 208 to a same output port 210 or 212.

Optical package (OP) array 202 features characteristics of:

(1) light may travel, that is, by entering and/or exiting, along rows or along columns of optical package (OP) array 202, whereby (I) light may enter a row h at the left side of optical package (OP) array 202 via a corresponding left side input port 206, (II) light may enter a column w at the bottom side of optical package (OP) array 202 via a corresponding bottom side input port 208, (III) light may exit from a row h at the right side of optical package (OP) array 202 via a corresponding right side output port 210, and, (IV) light may exit from a column w at the top side of optical package (OP) array 202 via a corresponding top side output port 212; and

(2) light diverted by a particular optical switch (OS) element 204 is grouped with the other light entering that same optical switch (OS) element 204 and traveling in the same direction as the diverted light.

Preferably, optical package (OP) array 202 features additional characteristics of:

(3) all optical switch (OS) elements 204 in column w are selective to a specific wavelength, λ_{w};

(4) when light traveling in a row h hits an active optical switch (OS) element 204 in column w, at least a portion of the λ_{w} component of the light is diverted upwards, joining any other light traveling in that column; and

(5) when light traveling in column w hits an active optical switch (OS) element 204 in a row h, at least a portion of the λ_{w} component of the light is diverted to the right, joining any other light traveling in that row.

It is to be clearly understood that the principles of the present invention apply, mutatis mutandis, to alternative arrangements of optical switch (OS) elements 204, for example, where all optical switch (OS) elements 204 in a row h are selective to a specific wavelength λₕ, and/or to alternative arrangements of input ports 206 and 208, and, output ports 210 and 212. In particular, for example, where input ports 206 and 208 are configured at the top side and at the right side, respectively, and, output ports 210 and 212 are configured at left side and at the bottom side, respectively, of optical package array 202.

As previously stated above, for implementing basic system 200, and, for implementing the various other embodiments described and illustrated below, of the present invention, preferably, but in a non-limiting fashion, each optical switch (OS) element 204 is a voltage controlled Electroholography based optical switch, such as the optical switch (OS) element described in previously cited PCT International Patent Application Publication No. WO 00/02098, of PCT Patent Application No. PCT/IL99/00368, and, in co-filed U.S. patent application Ser. No. 09/348,057, the teachings of which are incorporated by reference as if fully set forth herein.

In the description, and in the accompanying figures, of the present invention, for the purpose of brevity without decrease in meaning, the terms ‘optical package (OP) array’ and ‘optical package (OP) arrays’, are equivalently referred to by the terms ‘OP array’ and ‘OP arrays’, respectively, and, the terms ‘optical switch (OS) element’ and ‘optical switch (OS) elements’, are equivalently referred to by the terms ‘OS element’ and ‘OS elements’, respectively. In the description, and in the accompanying figures, of the present invention, for the purpose of brevity without decrease in meaning, the term ‘management and control logic mechanism (MCLM)’ is equivalently referred to by the term ‘MCLM’.

Using OP Building Blocks

FIG. 4 is a schematic diagram illustrating an exemplary preferred embodiment of a scaled-up system 216 of the present invention, featuring a scaled-up optical package (OP) array 205, with input ports 218, 220 and output ports 222, 224, and, a correspondingly scaled-up management and control logic mechanism (MCLM) 226, operatively connected to optical package (OP) array 202 via an interface 227. Accordingly, in forming this embodiment, there is using a plurality of OP arrays 202, previously described and illustrated in FIG. 3, where each OP array 202 is referred to as an OP building block (OPBB) 228, for scaling up to a larger scaled-up system 216.

As shown FIG. 4, scaled-up optical package (OP) array 205, with P*Y rows and Q*X columns of OS elements 204 (previously described and illustrated in FIG. 3; not shown in FIG. 4), is constructed of P rows of OPBBs 228 and Q columns of OPBBs 228. Each OP building block, OPBB(p,q) 228, for p=1 to P, and q=1 to Q, is composed of Y rows and X columns of OS elements 204. OPBBs 228 are chained in the following way: for p=1 to P−1, and, q=1 to Q−1, all 1 to Y rows at the right side of OPBB(p,q) are optically connected to the corresponding rows at the left side of OPBB(p,q+1), and, similarly, all 1 to X columns at the top side of OPBB(p,q) are optically connected to the corresponding columns at the bottom side of OPBB(P+1,q).

As previously stated above, for implementing scaled-up system 216, preferably, but in a non-limiting fashion, each optical switch (OS) element 204 is a voltage controlled Electroholography based optical switch, such as the optical switch (OS) element described in previously cited PCT International Patent Application Publication No. WO 00/02098, of PCT Patent Application No. PCT/IL99/00368, and, in co-filed U.S. patent application Ser. No. 09/348,057.

Scaled-up system 216 of FIG. 4, featuring scaled-up optical package (OP) array 205, can be used, in a non-limiting fashion, for forming the general embodiment of the extendable all optical cross connect (AOXC) chained optical package (COP) architecture, and, the different specific embodiments of extendable all optical cross connect (AOXC) chained optical package (COP) architectures, of the present invention. Additionally, scaled-up optical package (OP) array 205 of scaled-up system 216, can be used, in a non-limiting fashion, as one or more OPBBs 228 for forming a further scaled-up optical package (OP) array (not shown) of a correspondingly further scaled-up system (not shown) of the present invention.

Basic AOXC COP Architecture

In the description of the present invention provided herein, basic system 200 (FIG. 3), featuring the plurality of optical package (OP) arrays 202, is used, in a non-limiting fashion, for forming the general embodiment of an extendable all optical cross connect (AOXC) chained optical package (COP) architecture, and, different specific embodiments of extendable all optical cross connect (AOXC) chained optical package (COP) architectures. It is to be clearly understood that scaled-up system 216 (FIG. 4), featuring the scaled-up optical package (OP) array 205, can also be used, in a non-limiting fashion, for forming the general embodiment of the extendable all optical cross connect (AOXC) chained optical package (COP) architecture, and, the different specific embodiments of extendable all optical cross connect (AOXC) chained optical package (COP) architectures, of the present invention.

FIG. 5 is a schematic diagram illustrating the general embodiment of an extendable all optical cross connect (AOXC) chained optical package (COP) architecture 230, derived from basic system 200 illustrated in FIG. 3. General AOXC COP architecture 230, and, different specific embodiments of extendable all optical cross connect (AOXC) chained optical package (COP) architectures described and illustrated hereinafter, below, are constructed of a chain of OP arrays 202, previously described and illustrated in FIG. 3.

As illustrated in FIG. 5, the general embodiment of AOXC COP architecture 230 is a system featuring N input fibers 232, M output fibers 234, a chain 236 of OP arrays 202, and, an operatively connected, via interface 239, management and control logic mechanism (MCLM) 238. Each fiber carries a multichannel optical signal, for example, a wavelength division multiplex (WDM) optical signal), with K wavelengths. The key function of AOXC COP architecture 230 is to route groups of one or more wavelength components or portions thereof, from any input fiber 232 to any output fiber 234, according to a scheme determined and operated by management and control logic mechanism (MCLM) 238. AOXC COP architecture 230 provides complete flexibility in routing any wavelength from any input fiber 232 to any output fiber 234 independent of one another. Management and control logic mechanism (MCLM) 238 prevents a conflict of routing components with a same wavelength, λ, of the optical signals from different input fibers 232 to a same output fiber 234.

As shown in FIG. 5, AOXC COP architecture 230 features [N×M×K] AOXC COP array 236 having dimensions (N, M, K), where N is the number of input fibers 232, M is the number of output fibers 234, and, K is the number of wavelengths λₖ, for k=1 to K, per fiber which are operated upon by AOXC COP architecture 230. The number of chained OP arrays 202 in AOXC COP architecture 230 is denoted as the ‘chain length’. AOXC COP architecture 230 is extendable in all three dimensions independently, to a [N′×M′×K′] AOXC COP architecture, where N′ is equal to or greater than N, M′ is equal to or greater than M, and, K′ is equal to or greater than K. Note, however, that not all K wavelengths which are operated upon by AOXC COP architecture 230 must be present in each fiber. Furthermore, each fiber may carry additional wavelengths other than the K wavelengths, and the additional wavelengths are not necessarily the same in the various fibers.

In addition to the N input fibers 232 and M output fibers 234, AOXC COP architecture 230 has two sets of optional components: (1) N input-residuals output fibers 240, where each input-residuals output fiber n, for n=1 to N, is optically connected to a corresponding input-residuals output port n 241 of AOXC COP architecture 230, for carrying portions of the optical signals from input fibers 232 that do not undergo switching, and, (2) M output-grouping input fibers 242, where each output-grouping input fiber m, for m=1 to M, is optically connected to a corresponding output-grouping input port m 243 of AOXC COP architecture 230, for carrying optical signals into output fibers 234 from sources other than from input fibers 232. Furthermore, a set of optional output signals, denoted as U leftover signals 244, can be used for logical management and control purposes by logical management and control mechanism (MCLM) 238, for example, as input to detectors of management and control logic mechanism 238, as further described below.

As further described herein below, the extendable AOXC COP architectures have advantages in the implementation of the following switching and routing features such as grouping of wavelengths, multicasting of wavelengths, adding and/or dropping single wavelengths, adding and/or dropping a group of wavelengths per fiber, converting wavelengths, and/or, restoring wavelengths, interleaving wavelengths for increasing wavelength density. Additional features include extendibility of input fibers, output fibers, and, wavelengths; utilization of building blocks; and, logical management and control of optical signal monitoring, fault detection, connection verification, and, power management.

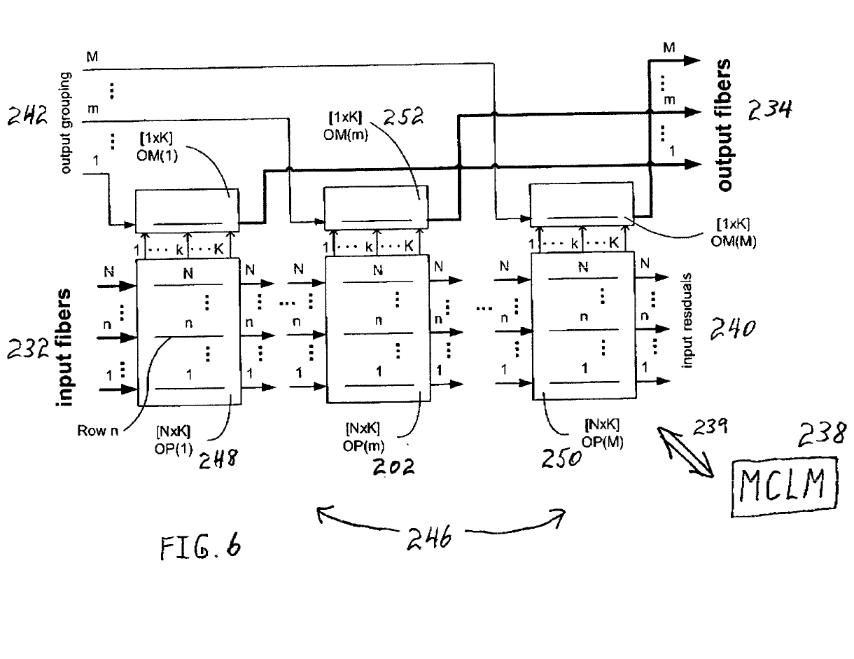

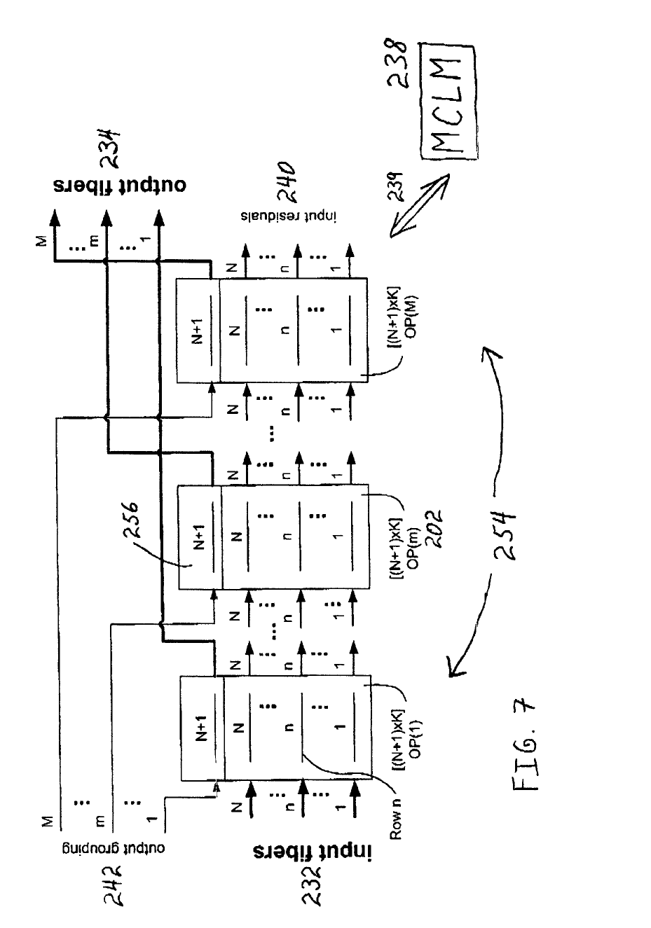

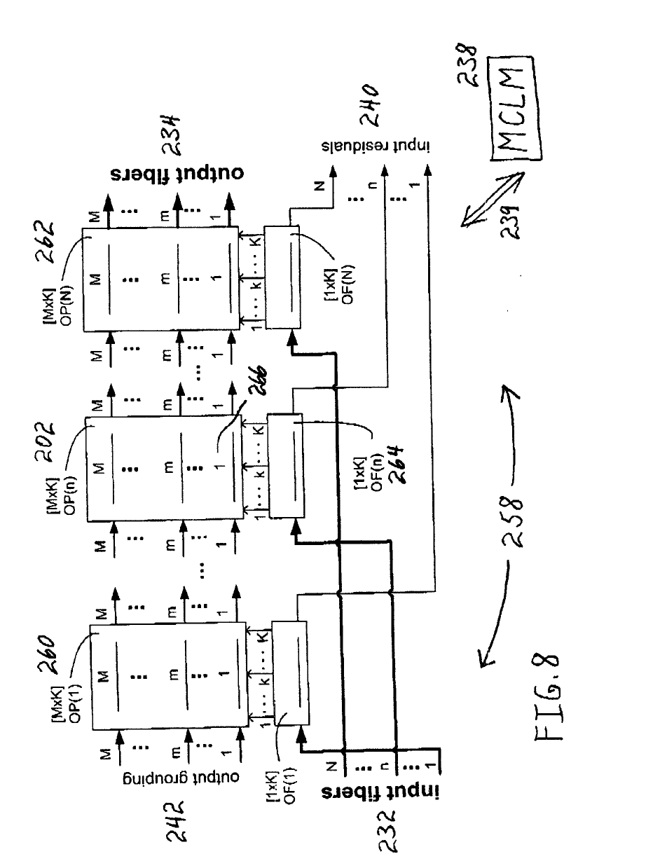

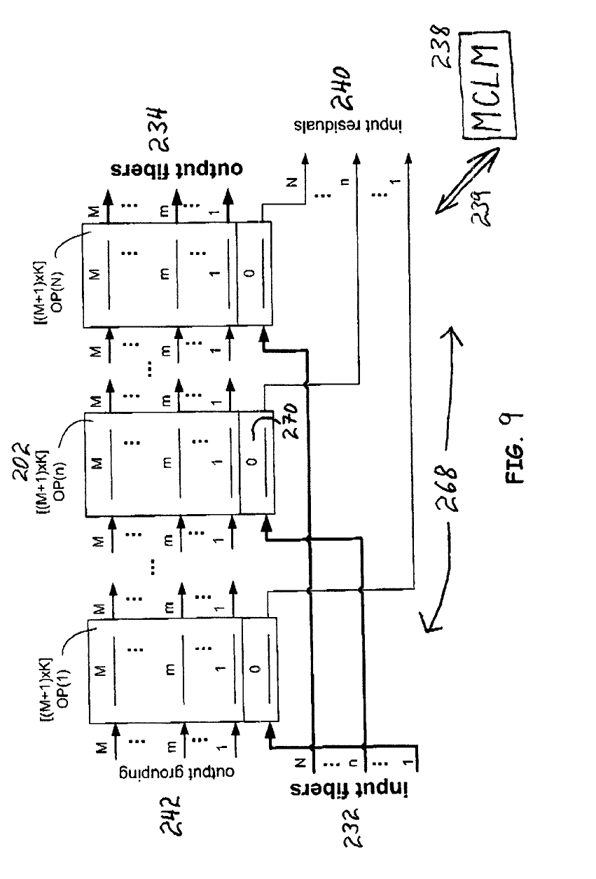

General AOXC COP architecture 230 of FIG. 5 is used for deriving or forming two main specific embodiments of extendable AOXC COP architectures, a ‘Chained Input’ architecture, as illustrated in FIGS. 6 and 7, and, a ‘Chained Output’ architecture, as illustrated in FIGS. 8 and 9. Other variations and specific embodiments of extendable AOXC COP architectures are possible, for example, the ‘Wavelength Chained Output’ architecture, as illustrated in FIG. 10.

‘Basic Chained Input’ (‘BCI’) AOXC COP Architecture

FIG. 6 is a schematic diagram illustrating a specific embodiment of extendable all optical cross connect (AOXC) chained optical package (COP) architecture 230 (FIG. 5), as a ‘Basic Chained Input’ (‘BCI’) AOXC COP architecture 246.

‘Basic Chained Input’ (‘BCI’) AOXC COP architecture 246 is based on chaining of M [N×K] dimensioned OP arrays 202, thus, the ‘chain length’ is M, and each optical package array OP(m) 202, for m=1 to M, is composed of N rows and K columns, and, features characteristics of:

(1) for m=1 to M, all OS elements in column k, for k=1 to K, of array OP(m) 202 are selective to the wavelength λk;

(2) for n=1 to N, input fiber n 232 is optically connected to input port n of the AOXC chain, which is at the left side of row n of array OP(1) 248;

(3) for m=1 to M−1, rows 1 to N at the right side of array OP(m) 202 are optically connected to rows 1 to N at the left side of the array OP(m+1), respectively, forming N chained rows of OP arrays 202; and

(4) for n=1 to N, optional input-residuals fiber n 240 is optically connected to a corresponding input-residuals output port n of the AOXC chain, located at the right side of row n of array OP(M) 250.

In addition to the chain of M OP arrays 202, ‘BCI’ AOXC COP architecture 246 includes a set of M ‘optical multiplexer’ elements, OM(m) 252, for m=1 to M. Each optical multiplexer, OM(m) 252, is a [1×K] dimensioned OP array, that is, a single row of K optical switch elements, OS(k), for k=1 to K, where for m=1 to M:

(1) each optical switch element, OS(k), for k=1 to K, of optical multiplexer OM(m) 252 is selective to a respective wavelength λₖ;

(2) each optical switch element, OS(k), for k=1 to K, of optical multiplexer OM(m) 252 is optically connected at its bottom side, to the top side of the optical switch element, OS(N,k), in row N (the upper row) and column k of optical package array OP(m) 202;

(3) optional output-grouping input fiber m 242 is optically connected to a corresponding output-grouping input port m of the AOXC chain, located at the left side of optical multiplexer OM(m) 252; and

(4) output fiber m 234 is optically connected to the output port m of the AOXC chain, located at the right side of optical multiplexer OM(m) X252.

‘BCI’ AOXC COP architecture 246 operates in the following way. Light entering from input fiber n 232 into the input port n of the AOXC chain, travels along row n through all chained OP arrays, thus, the name ‘Chained Input’ of this specific AOXC COP architecture. Activating the optical switch element, OS(n,k), in row n and column k of array OP(m) 202 causes at least a portion of the λₖ component of the optical signal from input fiber n 232, to be diverted upwards along column k. This diversion corresponds to a demultiplexing function that is integrated, without external components, into the OP array itself. The other wavelength components of the optical signal from fiber n together with the non-diverted portion of the specific λₖ component, continue traveling to the right, and are then either diverted by subsequent OS elements in the chained row n of the OP arrays, and/or exit the AOXC chain at the n'th port of optional input-residuals group 240.

By activating an optical switch element, OS(k), of optical multiplexer OM(m) 252, at least a portion of the diverted λₖ components of the optical signals from the various input fibers that entered this optical switching element, OS(k), at its bottom side, are further diverted to the right, and join all other wavelength components that travel in that row of OS elements. This corresponds to the multiplexing function of optical multiplexer OM(m) 252. Light exiting from the right side of optical multiplexer OM(m) 252, exits the AOXC chain at output port m, into output fiber m 234.

The residuals (leftover signals 244 as illustrated in FIG. 5; not shown in FIG. 6) that were not diverted by the OS elements of optical multiplexers OM(m) 252, exit at the top side of those OS elements, and, optionally, may be used for logical management and control by logical management and control mechanism (MCLM) 238, as further described below. The total number of available leftover signals per OP array is K, thus, the total number U of available leftover signals for the entire AOAC chain of M OP arrays is U=M*K.

Note that concurrently activating more than one OS element in rows 1 to N in the same column k of a certain array OP(m) 202 will route components with the same wavelength λₖ of optical signals from different input fibers n 232 to a same output fiber m 234, which is a conflict, whereby, management and control logic mechanism (MCLM) 238 of ‘BCI’ AOXC COP architecture 246 prevents such a situation.

‘Basic Integrated Chained Input’ (‘BICI’) AOXC COP Architecture

FIG. 7 is a schematic diagram illustrating a specific embodiment of extendable all optical cross connect (AOXC) chained optical package (COP) architecture 230 (FIG. 5), as a ‘Basic Integrated Chained Input’ (‘BICI’) AOXC COP architecture 254.

‘Basic Integrated Chained Input’ (‘BICI’) AOXC COP architecture 254 of FIG. 7 is similar to ‘BCI’ AOXC COP architecture 246 of FIG. 6, but with the OS elements of optical multiplexer OM(m) 252, for m=1 to M, being integrated into the respective OP(m) array 202, (FIG. 6) as the top row, denoted as row N+1 256 of a [(N+1)×K] dimensioned OP array 202, as illustrated in FIG. 7.

Another possible ‘Chained Input’ AOXC COP architecture (not shown) is a ‘mixture’ of ‘BCI’ AOXC COP architecture 246 (FIG. 6) and ‘BICI’ AOXC COP architecture 254 (FIG. 7), in such a way that for part of the optical multiplexers OM(m) 252, their OS elements are separated from the respective array OP(m) 202 as in ‘BCI’ AOXC COP architecture 246, and, for part of the optical multiplexers OM(m) 252, their OS elements are integrated as row N+1 256 of the respective array OP(m) 202 as in ‘BICI’ AOXC COP architecture 254.

‘Basic Chained Output’ (‘BCO’) AOXC COP Architecture

FIG. 8 is a schematic diagram illustrating a specific embodiment of extendable all optical cross connect (AOXC) chained optical package (COP) architecture 230 (FIG. 5), as a ‘Basic Chained Output’ (‘BCO’) AOXC COP architecture 258.

‘Basic Chained Output’ (‘BCO’) AOXC COP architecture 258 of FIG. 8, is based on chaining of N [M×K] dimensioned OP arrays 202, thus, the ‘chain length’ is N, and each array OP(n) 202, for n=1 to N, is composed of M rows and K columns, where:

(1) for n=1 to N, all OS elements in column k, for k=1 to K, of array OP(n) 202 are selective to the wavelength λₖ;

(2) for n=1 to N−1, rows 1 to M at the right side of array OP(n) 202 are optically connected to rows 1 to M at the left side of the array OP(n+1), respectively, forming M chained rows of the OP arrays; and

(3) for m=1 to M, optional output-grouping input fiber m 242 is optically connected to a corresponding output-grouping input port m, located at the left side of row m of array OP(1) 260, and, output fiber m 234 is optically connected to output port m of the AOXC chain, located at the right side of row m of array OP(N) 262.

In addition to the chain of N OP arrays 202, ‘BCO’ AOXC COP architecture 258 includes a set of N ‘optical filter’ elements, OF(n) 264, for n=1 to N. Each such OF(n) element 264 is a [1×K] dimensioned OP array, that is, a single row of K OS(k) elements, with k=1 to K, where for n=1 to N:

(1) each OS(k) element, for k=1 to K, of optical filter OF(n) 264 is selective to the respective wavelength λₖ;

(2) each OS(k) element, for k=1 to K, of optical filter OF(n) 264 is optically connected at its top side, to the bottom side of the element OS(1,k) in row 1 266 (the lower row) and column k of array OP(n) 202;

(3) input fiber n 232 is optically connected to input port n of the AOXC chain, located at the left side of optical filter OF(n) 264; and

(4) optional input residuals output fiber n 240 is optically connected to a corresponding input-residuals output port n of the AOXC chain, located at the right side of optical filter OF(n) 264.

‘BCO’ AOXC COP architecture 258 operates in following way. The optical signal from input fiber n 232 enters into optical filter OF(n) 264 at the left side. Activating the element OS(k) of optical filter OF(n) 264 diverts at least a portion of the λₖ component of the optical signal from input fiber n upwards into column k of array OP(n) 202. This diversion corresponds to a demultiplexing function of optical filter OF(n) 264.

Activating an element OS(m,k) in row m and column k of array OP(n) 202, causes at least a portion of the λₖ component of the light traveling upward on column k, to be further diverted to the right, joining the other wavelength components, or portions thereof, of the optical signals from the same input fiber n 232 and/or from other input fibers 232, and/or optical signals arriving from corresponding output-grouping input port m 242, traveling through the chained row m of the OP arrays towards output fiber m 234. This further diversion to the right is a multiplexing function that is integrated, without external components, into the OP array itself. Notice that the name, ‘Chained Output’, of this AOXC COP architecture, reflects the traveling of light through the chained row m of the OP arrays 202 towards the corresponding output fiber m 234.

The residuals (leftover signals 244 as illustrated in FIG. 5; not shown in FIG. 8) of the signals traveling along the columns of arrays OP(n) 202 that were not diverted into output fibers 234, exit at the top side of columns of arrays OP(n) 202, and, optionally, may be used for logical management and control, as further described below. The total number of available leftover signals per OP array is K, thus the total number U of available leftover signals for the entire AOXC chain of N OP arrays is U=N*K.

Note that concurrently activating elements OS(m,k) in the same row m and in the same column k in different arrays OP(n) 202 will route components with the same wavelength λₖ of optical signals from different input fibers n 232 to a same output fiber m 234, which is a conflict, whereby, management and control logic mechanism (MCLM) 234 of ‘BCO’ AOXC COP architecture 258 prevents such a situation.

‘Basic Integrated Chained Output’ (‘BICO’) AOXC COP Architecture

FIG. 9 is a schematic diagram illustrating a specific embodiment of extendable all optical cross connect (AOXC) chained optical package (COP) architecture 230 (FIG. 5), as a ‘Basic Integrated Chained Output’ (‘BICO’) AOXC COP architecture 268.

‘Basic Integrated Chained Output’ (‘BICO’) AOXC COP architecture 268 is similar to ‘BCO’ AOXC COP architecture 258 of FIG. 8, but with the OS elements of optical filter OF(n) 264, for n=1 to N, being integrated into the respective OP(n) array 202 (FIG. 8), as the bottom row, denoted as row 0 270, of a [(M+1)×K] dimensioned OP array 202, as illustrated in FIG. 9.

Another possible ‘Chained Output’ AOXC COP architecture (not shown) is a ‘mixture’ of ‘BCO’ AOXC COP architecture 258 (FIG. 8) and ‘BICO’ AOXC COP architecture 268 (FIG. 9), in such a way that for part of optical filters OF(n) 264, their OS elements are separated from the respective array OP(n) 202 as in ‘BCO’ AOXC COP architecture 258, and, for part of optical filters OF(n) 264, their OS elements are integrated as row 0 270 of the respective array OP(n) 202 as in ‘BICO’ AOXC COP architecture 268.

‘Basic Wavelength Chained Output’ (‘BWCO’) AOXC COP Architecture

FIG. 10 is a schematic diagram illustrating a specific embodiment of extendable all optical cross connect (AOXC) chained optical package (COP) architecture 230 (FIG. 5), as a ‘Basic Wavelength Chained Output’ (‘BWCO’) AOXC COP architecture 272.

‘Basic Wavelength Chained Output’ (‘BWCO’) AOXC COP architecture 272 of FIG. 10, is based on chaining of K [M×N] dimensioned OP arrays 202, thus, the ‘chain length’ is K, and each array OP(k) 202, for k=1 to K, is composed of M rows and N columns, where:

(1) for k=1 to K, OP(k) array 202 is designated to the k'th wavelength λₖ, that is, all of its OS elements are selective to this same wavelength λₖ;

(2) for k=1 to K−1, rows 1 to M at the right side of array OP(k) 202 are optically connected to rows 1 to M at the left side of the array OP(k+1), respectively, forming M chained rows of OP arrays 202; and

(3) for m=1 to M, optional output-grouping input fiber m 242 is optically connected to a corresponding output-grouping input port of the AOXC chain, located at the left side of row m of array OP(1) 274, and, output fiber m 234 is optically connected to output port m of the AOXC chain, located at the right side of row m of array OP(K) 276.

In addition to the chain of N OP arrays 202, ‘BWCO’ AOXC COP architecture 272 includes a set of N ‘optical filter’ elements OF(n) 264, for n=1 to N. Each such OF(n) element 264 is a [1×K] dimensioned OP array, that is, a single row of K OS(k) elements, for k=1 to K, where for n=1 to N:

(1) each OS(k) element, for k=1 to K, of optical filter OF(n) 264 is selective to the respective wavelength λₖ;

(2) each OS(k) element, for k=1 to K, of optical filter OF(n) 264 is optically connected at its top side, to the bottom side of the element OS(1,n) in row 1 278 (the lower row) and column n of array OP(k) 202;

(3) input fiber n 232 is optically connected to input port n of the AOXC chain, located at the left side of optical filter OF(n) 264; and

(4) optional input-residuals output fiber n 240 is optically connected to a corresponding input-residuals output port n of the AOXC chain, located at the right side of optical filter OF(n) 264.

‘BWCO’ AOXC COP architecture 272 operates in the following way. The optical signal from input fiber n 232 enters into optical filter OF(n) 264 at the left side. Activating the element OS(k) of optical filter OF(n) 264 diverts at least a portion of the λₖ component of the optical signal from input fiber n 232 upwards into column n of array OP(k) 202. This diversion corresponds to a demultiplexing function of optical filter OF(n) 264.

Activating an element OS(m,n) in row m and column n of array OP(k) 202, causes at least a portion of the diverted λₖ component of the optical signal from input fiber n 232 to be further diverted to the right, joining the other diverted wavelength components, or portion thereof, of the optical signals from the same input fiber n 232 and/or other input fibers 232, and/or optical signals arriving from corresponding output-grouping input port m, traveling through the chained row m of the OP arrays towards output fiber m 234. This further diversion to the right is a multiplexing function that is integrated, without external components, into OP array 202 itself. Notice that the name, ‘Wavelength Chained Output’, of AOXC COP architecture 272, reflects the traveling of light through the chained row m of the OP arrays 202 towards the corresponding output fiber m 234. However, since each specific wavelength component that travels through the chained row m of OP arrays 202 towards output fiber m 234, emerges from an OP array 202 which corresponds to the specific wavelength, AOXC COP architecture 272 is referred to as ‘Wavelength Chained’.

The residuals (leftover signals 244 as illustrated in FIG. 5; not shown in FIG. 10) of the signals traveling along the columns of arrays OP(k) 202 that were not diverted into output fibers 234, exit at the top side of columns of the arrays OP(k) 202, and, optionally, may be used for logical management and control by logical management and control mechanism (MCLM) 238, as further described below. The total number of available leftover signals per OP array is N, thus, the total number U of available leftover signals for the entire AOAC chain of K OP arrays 202 is U=K*N.

Note that concurrently activating more than one OS element in the same row m of a certain array OP(k) 202 will route components with the same wavelength λₖ of optical signals from different input fibers n 232 to a same output fiber m 234, which is a conflict, whereby, management and control logic mechanism (MCLM) 238 of ‘BWCO’ AOXC COP architecture 272 prevents such a situation.

Advantages of the Basic AOXC COP Architectures

Several advantages of the above described and illustrated basic extendable AOXC COP architectures are:

(1) they are compact, that is, requiring a minimum number of OS elements;

(2) they implement the AOXC wavelength switching and routing functions with fall flexibility and control;

(3) their optical attenuation is low and is equal to the attenuation associated with two diversions; plus one optical connection between an optical multiplexer OM(m) 252 and an OP array 202 in ‘BCI’ AOXC COP architecture 246 (FIG. 6), or, between an optical filter 264 and an OP array 202 in ‘BCO’ AOXC COP architecture 258 (FIG. 8) and in ‘BWCO’ AOXC COP architecture 272 (FIG. 10); and plus zero to X−1 optical connections between OP arrays 202, where X=M for ‘BCI’ AOXC COP architecture 246 (FIG. 6) and ‘BICI’ AOXC COP architecture 268 (FIG. 9), X=N for ‘BCO’ AOXC COP architecture 258 (FIG. 8) and ‘BICO’ AOXC COP architecture 268 (FIG. 9), and, X=K for ‘BWCO’ AOXC COP architecture 272 (FIG. 10). Traveling inside the OP arrays without being diverted adds a relatively small amount of attenuation; and

(4) they integrate at least some of the several optional features described below.

Extensions of the Basic AOXC COP Architectures

A variety of different extensions of the above described and illustrated basic ‘Chained Output’ and ‘Wavelength Chained Output’ extendable all optical cross connect (AOXC) chained optical package (COP) architectures are presented herein. These extended AOXC COP architectures are:

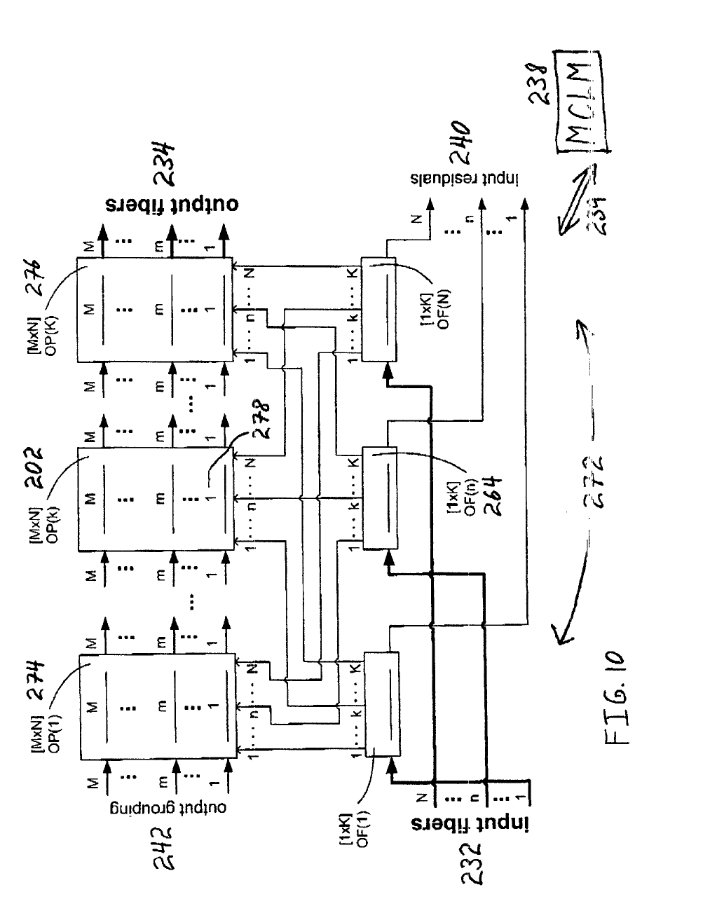

‘Coupled Chained Output’ (‘CCO’) AOXC COP architecture 280, illustrated in FIG. 11;

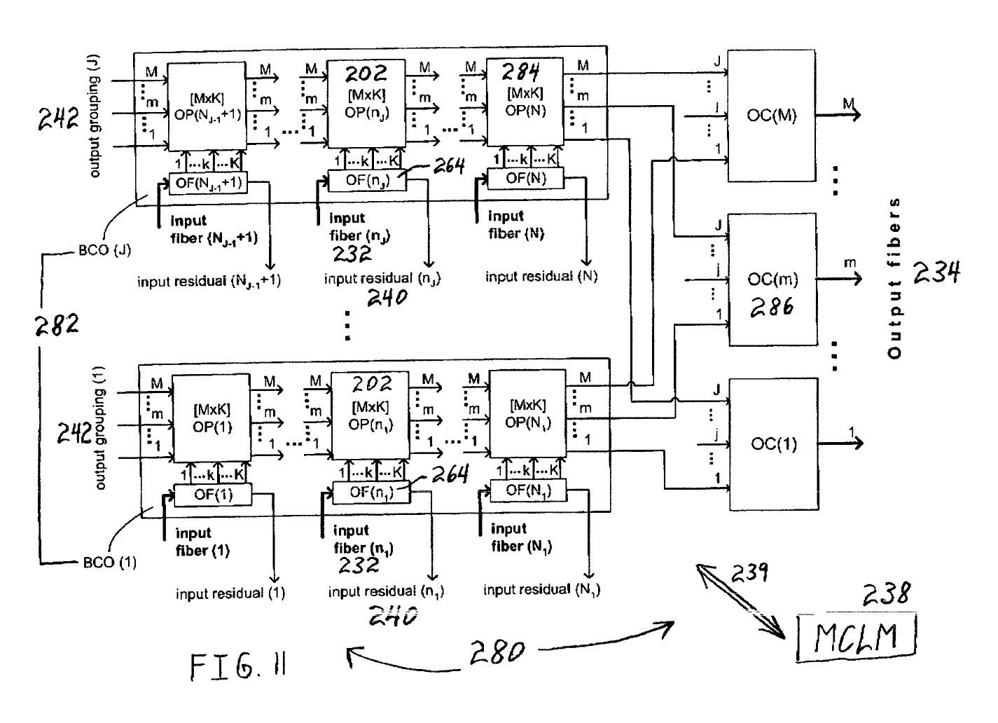

‘Coupled Integrated Chained Output’ (‘CICO’) AOXC COP architecture 290, illustrated in FIG. 12;

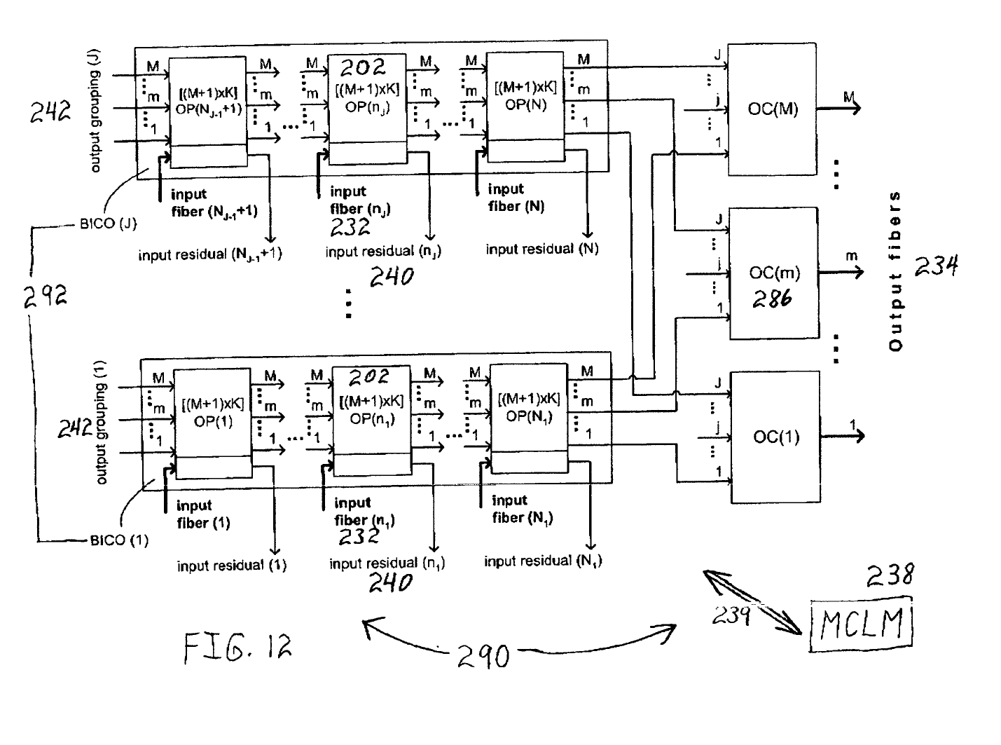

‘Mixed Chained Output’ (‘MCO’) AOXC COP architecture 294, illustrated in FIG. 13;

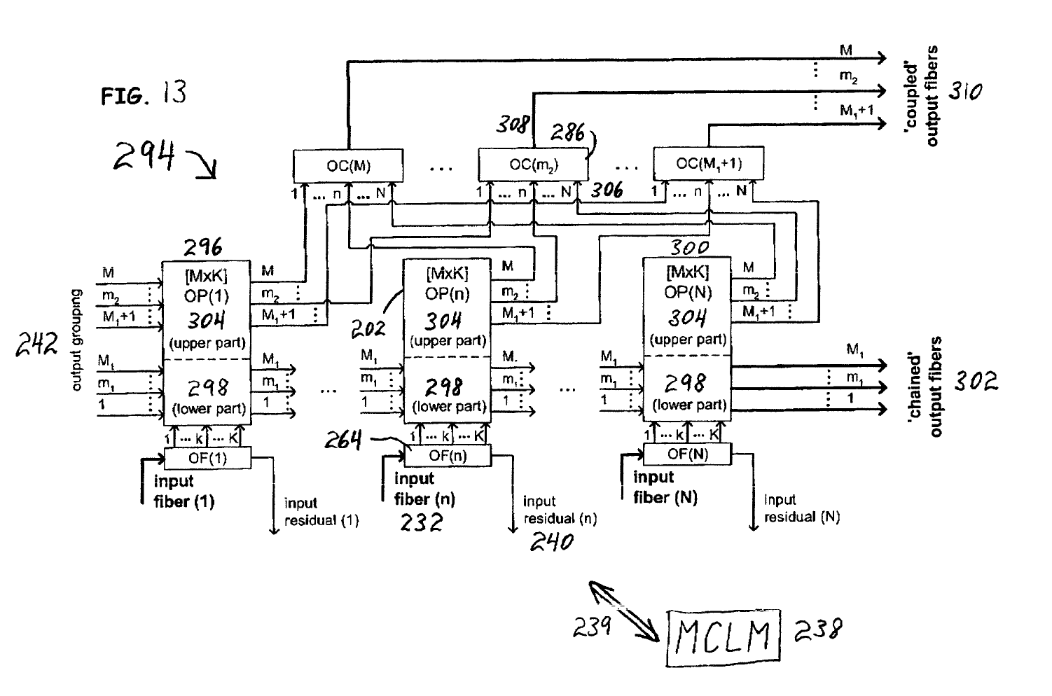

‘Mixed Integrated Chained Output’ (‘MICO ’) AOXC COP architecture 312, illustrated in FIG. 14; and

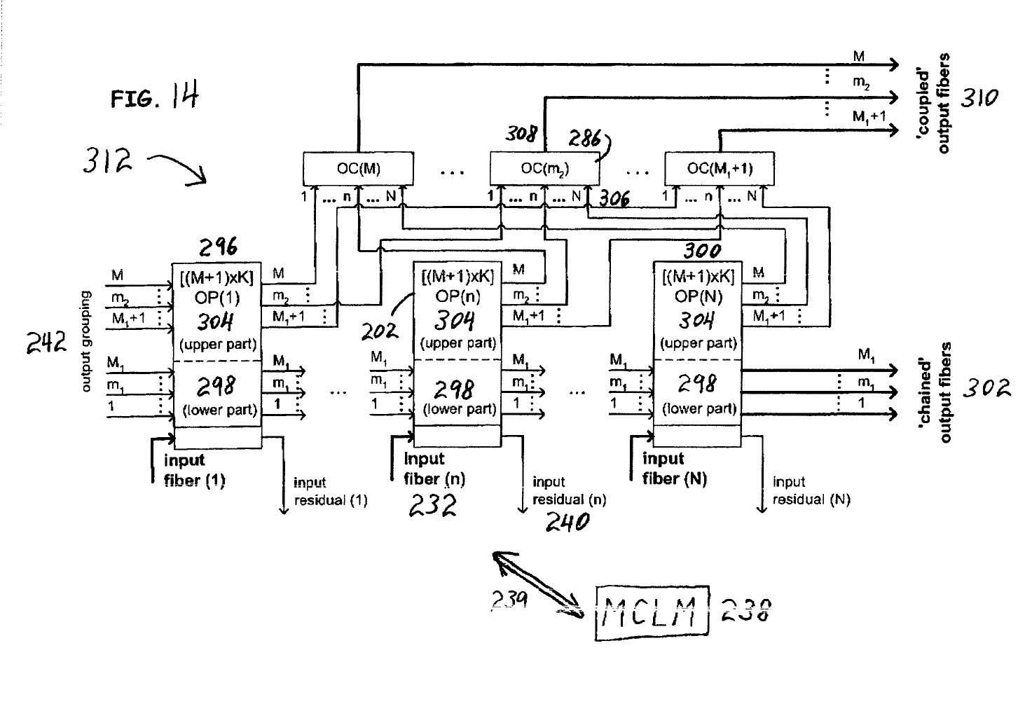

‘Mixed Wavelength Chained Output’ (‘MWCO’) AOXC COP architecture 314, illustrated in FIG. 15.

‘Coupled Chained Output’ (‘CCO’) AOXC COP Architecture

FIG. 11 is a schematic diagram illustrating a specific embodiment of extendable all optical cross connect (AOXC) chained optical package (COP) architecture 230 (FIG. 5), as a ‘Coupled Chained Output’ (‘CCO’) AOXC COP architecture 280.

‘Coupled Chained Output’ (‘CCO’) AOXC COP architecture 280 of FIG. 11 is based on a set of J ‘BCO’ chains BCO(j) 282, for j=1 to J, which includes altogether N [M×K] dimensioned OP arrays 202, and N [1×K] dimensioned optical filters OF 264, where for j=1 to J:

(1) BCO(j) chain 282 is constructed with Lⱼ [M×K] dimensioned OP arrays 202 and Lⱼ [1×K] dimensioned OF optical filters 264, according to the layout in FIG. 8. The ‘chain length’ Lⱼ of chain BCO(j) 282 may vary from chain to chain;

(2) the Lⱼ OP arrays and the Lⱼ OF optical filters 264 of BCO(j) chain 282 are denoted as OP(nⱼ) 202 and OF(nⱼ) 264, respectively, with the index nⱼ varying from Nⱼ₋₁+1 to Nⱼ, where Nⱼ=Nⱼ₋₁+Lⱼ, with the boundary conditions: N₀=0 and N_{J}=N;

(3) for nⱼ=Nⱼ₋₁+1 to Nⱼ, input fiber nⱼ 232 is optically connected to the input port nⱼ of BCO(j) chain 282, which is at the left side of optical filter OF(nⱼ) 264, and, optional input-residuals output fiber nⱼ 240 is optically connected to a corresponding input-residuals output port n of the AOXC chain, located at the right side of optical filter OF(nⱼ) 264; and

(4) for m=1 to M, optional output-grouping input fiber m of the j'th output grouping (j) group of optional M output-grouping input fibers 242, is optically connected to corresponding output-grouping input port m of BCO(j) chain 282, located at the left side of row m of the array OP(Nⱼ₋₁+1); the output port m of BCO(j) chain 282, located at the right side of row m of array OP(Nⱼ) 284, is optically connected to the j'th input port of a [J×1] optical coupler OC(m) 286, that is, an optical coupler with J input ports and 1 output port; and, output fiber m 234 is optically connected to the output port of optical coupler OC(m) 286.

‘CCO’ AOXC COP architecture 280 operates in the following way. In each of the BCO(j) chains 282, for j=1 to J, at least a portion of the optical signals from the input fibers that are connected to a particular BCO(j) chain 282, together with the optical signals from the j'th output-grouping (j) group of optional M output-grouping input fibers 242, are routed into the output ports of the particular BCO(j) chain 282. Finally, for each of the M output fibers m 234, for m=1 to M, all optical signals that exit the J BCO(j) chains 282 at output port m, are coupled together by optical coupler OC(m) 286 into output fiber m 234, thus, the name ‘Coupled Chained Output’ of this specific AOXC COP architecture.

From the layout of ‘CCO’ AOXC COP architecture 280 illustrated in FIG. 11, it is clear that for a given number N of input fibers 232, there are various possibilities in choosing the number J of BCO(j) chains 282, and the respective chain lengths, Lⱼ, as long as the condition

$$N = {\sum }_{j = 1}^{J} {L}_{j}$$

is met. For example, the two ‘extreme cases’ are for J=1 and J=N. The extreme case of J=1 is a ‘pure chaining’ of the OP arrays, that is, no coupling, in which ‘CCO’ AOXC COP architecture 280 of FIG. 11 coincides with ‘BCO’ AOXC COP architecture 258 of FIG. 8 (A3A). Whereas the extreme case of J=N is a ‘pure coupling’ of the OP arrays, that is, no chaining.

Furthermore, in order to ‘optimize’ the values of the number J of BCO(j) chains 282 (FIG. 11) and of the chain lengths, Lⱼ, for ‘CCO’ AOXC COP architecture 280 with a given number N of input fibers 232, one can make considerations such as:

(1) reducing the overall insertion losses of the system, taking into account that by increasing J and decreasing the chain lengths in accordance, the insertion losses of the optical couplers increase (more input ports), and the insertion losses of ‘BCO’ chains 282 decrease (shorter chains with less passes of light through the OS elements within the chains). The opposite is equally valid, whereby, by decreasing J and increasing the chain lengths in accordance, the insertion losses of the optical couplers decrease (less input ports), and the insertion losses of ‘BCO’ chains 282 increase (longer chains with more passes of light through the OS elements within the chains); and

(2) setting up ‘CCO’ AOXC COP architecture 280 with ‘BCO’ chains 282 of ‘standard’ lengths, which then dictates the chain lengths, Lⱼ, and the number J of ‘BCO’ chains 282, fulfilling the above mentioned condition

$$N = {\sum }_{j = 1}^{J} {L}_{j} .$$

N=Lj.

In ‘Coupled Chained Output’ (‘CCO’) AOXC COP architecture 280 of FIG. 11, management and control logic mechanism (MCLM) 238 operates, in part, by preventing the switching and routing of the same wavelength from more than one input fiber 232 to a same output fiber 234.

‘Coupled Integrated Chained Output’ (‘CICO’) AOXC COP Architecture

FIG. 12 is a schematic diagram illustrating a specific embodiment of extendable all optical cross connect (AOXC) chained optical package (COP) architecture 230 (FIG. 5), as a ‘Coupled Integrated Chained Output’ (‘CICO’) AOXC COP architecture 290.

‘Coupled Integrated Chained Output’ (‘CICO’) AOXC COP architecture 290 of FIG. 12 is similar to ‘CCO’ AOXC COP architecture 280 of FIG. 11, but with a set of J ‘BICO’ chains BICO(j) 292 (FIG. 12) instead of ‘BCO’ chains 282 (FIG. 11). However, ‘CICO’ AOXC COP architecture 290 (FIG. 12) operates in a similar way to ‘CCO’ AOXC COP architecture 280 (FIG. 11), since integration of the optical filters OF 264 into the respective OP arrays 202 has no impact on the switching and routing capabilities of the ‘Chained Output’ AOXC COP architecture. In ‘Coupled Integrated Chained Output’ (‘CICO’) AOXC COP architecture 290 of FIG. 12, management and control logic mechanism (MCLM) 238 operates, in part, by preventing the switching and routing of the same wavelength from more than one input fiber 232 to a same output fiber 234.

Another possible ‘Coupled Chained Output’ AOXC COP architecture (not shown) is a ‘mixture’ of ‘CCO’ AOXC COP architecture 280 (FIG. 11) and ‘CICO’ AOXC COP architecture 290 (FIG. 12), in such a way that part of chains of the set of J chains are ‘BCO’ chains 282 as in ‘CCO’ AOXC COP architecture 280 (FIG. 11), and, part of the set of J chains are ‘BICO’ chains 292 as in ‘CICO’ AOXC COP architecture 290 (FIG. 12).

‘Mixed Chained Output’ (‘MCO’) AOXC COP Architecture

FIG. 13 is a schematic diagram illustrating a specific embodiment of extendable all optical cross connect (AOXC) chained optical package (COP) architecture 230 (FIG. 5), as a ‘Mixed Chained Output’ (‘MCO’) AOXC COP architecture 294.

‘Mixed Chained Output’ (‘MCO’) AOXC COP architecture 294 of FIG. 13 is based on chaining of N [M×K] dimensioned OP arrays 202, together with a set of N [1×K] dimensioned optical filters, OF (n) 264, where each optical filter OF 264 is optically connected to the corresponding OP array 202, in a similar way as in ‘BCO’ AOXC COP architecture 258 illustrated in FIG. 8. Furthermore, input fibers, for example, input fiber (n) 232, and optional input-residuals output fibers, for example, optional input-residuals output fiber (n) 240, are optically connected to corresponding optical filters OF, for example, OF(n) 264, and also the optional output-grouping input fibers 242 are optically connected to the left side of the rows of array OP(1) 296, in a similar way as in the ‘BCO’ AOXC COP architecture. However, ‘MCO’ AOXC COP architecture 294 differs from the ‘BCO’ AOXC COP architecture in the chaining of the rows of the OP arrays, in the following way:

(1) only part of the M rows of the OP arrays are chained in ‘MCO’ AOXC COP architecture 294. Those chained rows are denoted as the ‘lower part’ 298 constructed of chained rows 1 to M₁;

(2) for m₁=1 to M₁, the ‘lower part’ chained row m₁ 298 is optically connected at the right side of array OP(N) 300 to output fiber m₁ 302, where output fiber m₁ 302 belongs to the group of output fibers m₁, for m₁=1 to M₁, denoted as ‘chained’ output fibers 302;

(3) the rest of the rows in the OP arrays are denoted as the ‘upper part’ 304, constructed of rows M₁+1 to M; and

(4) for m₂=M₁+1 to M, the ‘upper part’ row m₂ 304 of OP(n) array 202, for n=1 to N, is optically connected at the right side to the respective input port n of a [N×1] optical coupler OC(m₂) 286, that is, an optical coupler with N input ports 306 and 1 output port 308, and, output port 308 of optical coupler OC(m₂) 286 is optically connected to output fiber m₂ 310, where output fiber m₂ 310 belongs to the group of output fibers m₂, for m₂=M₁+1 to M, denoted as ‘coupled’ output fibers 310.

‘MCO’ AOXC COP architecture 294 operates in the following way. At least portions of the optical signals from the input fibers, for example, input fiber (n) 232, together with the optical signals from optional output-grouping input fibers 242, are routed, either through the chained rows in lower part 298 of OP arrays 202, or, through the coupled output optical signals from the rows in upper part 304 of OP arrays 202, into the output fibers, that is, into ‘chained’ output fibers 302, or, into ‘coupled’ output fibers 310, respectively. Thus, the name ‘Mixed Chained Output’ of this specific AOXC COP architecture, indicating the mix of ‘chained’ and ‘coupled’ output signals.

The layout of ‘MCO’ AOXC COP architecture 294 illustrated in FIG. 13 is applicable to the whole range of values of M₁ between 0 to M. The extreme case of M₁=0 is a ‘pure coupling’ of the output signals from the rows of the OP arrays, that is, no chaining, in which ‘MCO’ AOXC COP architecture 294 coincides with ‘CCO’ AOXC COP architecture 280 of FIG. 11 with J=N. In contrast, however, the extreme case M₁=M is a ‘pure chaining’ of the output signals from the rows of the OP arrays, that is, no coupling, in which ‘MCO’ AOXC COP architecture 294 coincides with ‘CCO’ AOXC COP architecture 280 of FIG. 11, with J=1, that is, coinciding with ‘BCO’ AOXC COP architecture 258 of FIG. 8.

In ‘Mixed Chained Output’ (‘CCO’) AOXC COP architecture 294 of FIG. 13, management and control logic mechanism (MCLM) 238 operates, in part, by preventing the switching and routing of the same wavelength from more than one input fiber 232 to a same output fiber 302, 310.

‘Mixed Integrated Chained Output’ (‘MICO’) AOXC COP Architecture

FIG. 14 is a schematic diagram illustrating a specific embodiment of extendable all optical cross connect (AOXC) chained optical package (COP) architecture 230 (FIG. 5), as a ‘Mixed Integrated Chained Output’ (‘MICO’) AOXC COP architecture 312.

‘Mixed Integrated Chained Output’ (‘MICO’) architecture 312 of FIG. 14 is similar to ‘MCO’ AOXC COP architecture 294 of FIG. 13, but with the optical filters OF(n) 264, integrated into the respective OP(n) arrays 202 (FIG. 13). However, ‘MICO’ AOXC COP architecture 312 (FIG. 14) operates in a similar way to ‘MCO’ AOXC COP architecture 294 (FIG. 13), since the integration of the optical filters into the respective OP arrays has no impact on the switching and routing capabilities of the ‘Chained Output’ AOXC COP.

In ‘Mixed Integrated Chained Output’ (‘MICO’) AOXC COP architecture 312 of FIG. 14, management and control logic mechanism (MCLM) 238 operates, in part, by preventing the switching and routing of the same wavelength from more than one input fiber 232 to a same output fiber 302, 310.

‘Mixed Wavelength Chained Output’ (‘MWCO’) AOXC COP Architecture

FIG. 15 is a schematic diagram illustrating a specific embodiment of extendable all optical cross connect (AOXC) chained optical package (COP) architecture 230 (FIG. 5), as a ‘Mixed Wavelength Chained Output’ (‘MWCO’) AOXC COP architecture 314.

‘Mixed Wavelength Chained Output’ (‘MWCO ’) architecture 314 of FIG. 15 is based on chaining of K [M×N] dimensioned OP arrays, OP(k) 202, for k=1 to K, together with a set of N [1×K] dimensioned optical filters OF, where each optical filter, OF(n) 264, for n=1 to N, is optically connected to the plurality of corresponding OP arrays 202, in a similar way as in ‘BWCO’ AOXC COP architecture 272 of FIG. 10. Furthermore, input fibers, for example, input fiber (n) 232, and optional input-residuals output fibers, for example, optional input-residuals output fiber (n) 240, are optically connected to corresponding optical filters OF, for example, OF(n) 264, and also the optional output-grouping input fibers 242 are optically connected to the right side of the rows of array OP(1) 296, in a similar way as in the ‘BWCO’ AOXC COP architecture. However, ‘MWCO’ AOXC COP architecture 314 differs from the ‘BWCO’ AOXC COP architecture in the chaining of the rows of the OP arrays 202, in the following way:

(1) only part of the M rows of the OP arrays 202 are chained in ‘MWCO’ AOXC COP architecture 314. Those chained rows are denoted as the ‘lower part’ 298 constructed of chained rows 1 to M₁;

(2) for m₁=1 to M₁, the ‘lower part’ chained row m₁ 298 is optically connected at the right side of array OP(K) 300 to output fiber m₁, where output fiber mₗ belongs to the group of output fibers m₁, for m₁=1 to M₁, denoted as ‘chained’ output fibers 302;

(3) the rest of the rows in the OP arrays are denoted as the ‘upper part’ 304, constructed of rows M₁+1 to M; and

(4) for m₂=M₁+1 to M, the ‘upper part’ row m₂ 304 of OP(k) array 202, for k=1 to K, is optically connected at the right side to the respective input port k of a [K×1] optical coupler OC(m₂) 286, that is, an optical coupler with K input ports 306 and 1 output port 308, and, output port 308 of optical coupler OC(m₂) 286 is optically connected to output fiber m₂ 310, where output fiber m₂ 310 belongs to the group of output fibers m₂, for m₂=M₁+1 to M, denoted as ‘coupled’ output fibers 310.

‘MWCO’ AOXC COP architecture 314 operates in the following way. At least portions of the optical signals from the input fibers 232, together with the optical signals from optional output-grouping input fibers 242, are routed, either through the chained rows in lower part 298 of OP arrays 202, or, through the coupled output optical signals from the rows in upper part 304 of OP arrays 202, into the output fibers, that is, into ‘chained’ output fibers 302, or, into ‘coupled’ output fibers 310, respectively. Thus, the name ‘Mixed Wavelength Chained Output’ of this specific AOXC COP architecture, indicating the mix of ‘chained’ and ‘coupled’ output signals.

The layout of ‘MWCO’ AOXC COP architecture 314 illustrated in FIG. 15 is applicable to the whole range of values of M₁ between 0 to M. The extreme case of M₁=0 is a ‘pure coupling’ of the output signals from the rows of the OP arrays, that is, no chaining, in which ‘MWCO’ AOXC COP architecture 314 coincides with a ‘Coupled Wavelength Chained ‘CWC’ AOXC COP architecture (not shown). In contrast, however, the extreme case M₁=M is a ‘pure chaining’ of the output signals from the rows of the OP arrays, that is, no coupling, in which ‘MWCO’ AOXC COP architecture 314 coincides with ‘BWCO’ AOXC COP architecture 272 of FIG. 10.

In ‘Mixed Wavelength Chained Output’ (‘MWCO’) AOXC COP architecture 314 of FIG. 15, management and control logic mechanism (MCLM) 238 operates, in part, by preventing the switching and routing of the same wavelength from more than one input fiber 232 to a same output fiber 302, 310.

Interleaved AOXC COP Architecture

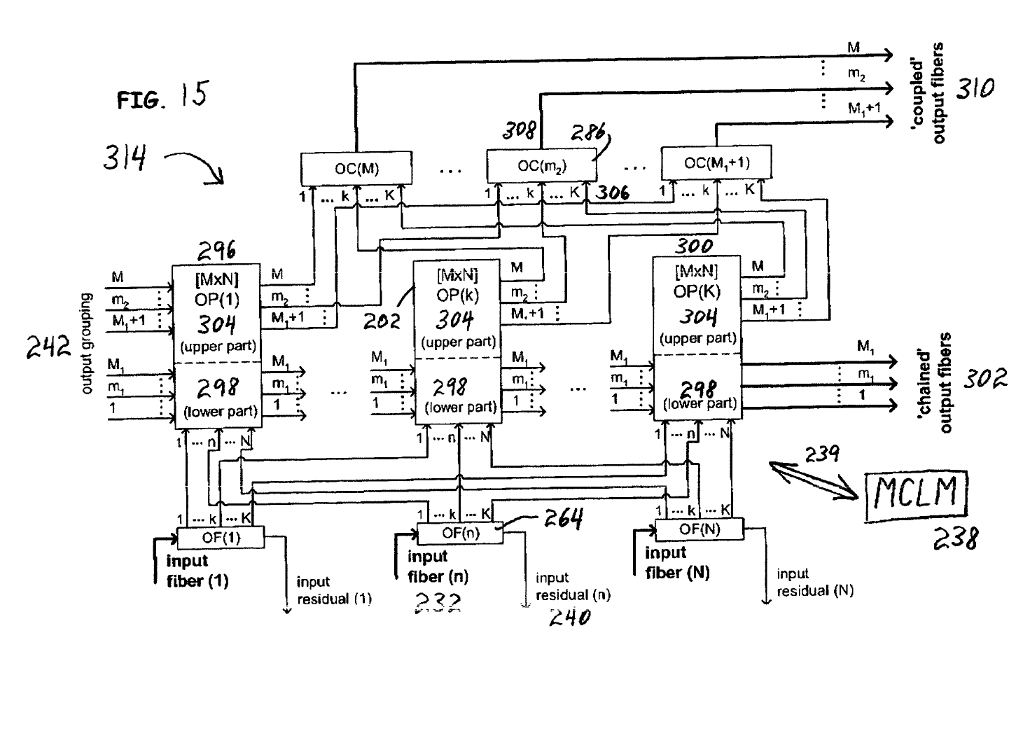

FIG. 16 is a schematic diagram illustrating a specific embodiment of extendable all optical cross connect (AOXC) chained optical package (COP) architecture 230 (FIG. 5), as an ‘Interleaved Modular Configuration’ AOXC COP architecture 316.

Interleaved AOXC COP architecture 316 of FIG. 16 is based on the concept of using interleaved wavelengths. This architecture enables switching and routing of multichannel optical signals with increased wavelength density, while keeping cross-talk between neighboring channels within an acceptable limit.

Interleaved AOXC COP architecture 316, with N input fibers 232, M output fibers 234, and K wavelengths which are operated upon by AOXC COP architecture 316, is composed of a set of N [1×V] optical interleavers OI(n) 318, for n=1 to N, a set of V [N×M×Kᵥ] AOXC COP(v) chains 236′ (similarly structured and functioning as AOXC COP chain 236 of OP arrays 202, featured in the general embodiment of AOXC COP architecture 230, previously described and illustrated in FIG. 5), for v=1 to V, a set of N [V×1] optical couplers OCI(n) 320, for n=1 to N, and, a set of M [V×1] optical couplers OCO(m) 322, for m=1 to M, in the following way.

Each optical interleaver OI(n) 318, for n=1 to N, has one input port and V output ports. Optical interleaver OI(n) 318 filters the wavelengths so that each of the K wavelengths λₖ, for k=1 to K, is routed from the input port to the respective output port v out of the V output ports, where v=(k−1) modulo V+1.

Kᵥ denotes the number of wavelengths that are routed into the output port v of any of optical interleavers OI(n) 318. If K/V is an integer, that is, K modulo V=0, then Kᵥ=K/V for all V output ports. Whereas, if K/V is non-integer, that is, K modulo V is greater than 0, then Kᵥ=integer [K/V]+1 for the first (K modulo V) output ports, and Kᵥ=integer [K/V] for the rest of the output ports.

Each AOXC COP(v) chain 236′, for v=1 to V, can be of any of the AOXC COP architectures described above. Each AOXC COP(v) chain 236′ has N input ports 324, M output ports 326, optional N input-residuals output ports 328, and, optional M output-grouping input ports 330. Each AOXC COP(v) chain 236′ supports the routing of Kᵥ wavelengths of optical signals from its input ports to the corresponding output ports, which are the same Kᵥ wavelengths that are routed into output port v of any of optical interleavers OI(n) 318.

Each of the N optical couplers OCI(n) 320, for n=1 to N, and each of the M optical couplers OCO(m) 322, for m=1 to M, is a [V×1] optical coupler, that is, an optical coupler that couples the optical signals from V input ports into one output signal.

The various components of interleaved AOXC COP architecture 316 are optically connected in the following way:

(1) for n=1 to N: (I) input fiber n 232 is optically connected to the input port of interleaver OI(n) 318; (II) output port v, for v=1 to V, of interleaver OI(n) 318 is optically connected to input port n of the respective AOXC COP(v) chain 236′; (III) optional input-residuals output port n of AOXC(v) chain 236′, for v=1 to V, is optically connected to the respective input port v of optical coupler OCI(n) 320; and, (IV) the output port of optical coupler OCI(n) 320 is optically connected to optional input-residuals output fiber n 240; and

(2) for m=1 to M: (I) output port m of AOXC(v) chain 236′, for v=1 to V, is optically connected to the respective input port v of optical coupler OCO(m) 322; (II) output port m of optical coupler OCO(m) 320 is optically connected to output fiber m 234; and, (II) optional output-grouping input fiber m of the v'th ‘output grouping (v)’ group of optional M output-grouping input fibers 242, for v=1 to V, is optically connected to corresponding output-grouping input port m 330 of the respective AOXC COP(v) chain 236′.

Interleaved AOXC COP architecture 316 operates in the following way. In each AOXC COP(v) chain 236′, for v=1 to V, the wavelengths of at least portions of the optical signals from the input fibers that are routed to AOXC COP(v) chain 236′, together with the optical signals from the v'th ‘output grouping (v)’ group of optional M output-grouping input fibers 242, are routed into the output ports, 326, 328, of AOXC COP(v) chain 236′. Finally, for each of the M output fibers m 234, that is, for m=1 to M, all optical signals that exit the V AOXC COP(v) chains 236′ at output port m 326, are coupled together by optical coupler OCO(m) 322 into output fiber m 234, thus, the name of the optical coupler ‘OCO’, indicating optical coupler for coupling optical signals into output fibers 234. Likewise, for each of the optional N input-residuals output fibers n 240, that is, for n=1 to N, all optical signals that exit the V AOXC(v) chains 236′ at the corresponding input-residuals output port n 328, are coupled together by optical coupler OCI(n) 320 into optional input-residuals output fiber n 240, thus, the name of the optical coupler ‘OCI’, indicating optical coupler for coupling optical signals into the optional input-residuals output fibers 240.

It should be noticed that interleaved AOXC COP architecture 316 can be extended in a ‘recursive’ manner, by allowing the AOXC COP(v) chains 236′ to be interleaved AOXC COP as well. It should also be noticed, that the general case of partitioning the wavelengths of the optical signals from the N input fibers 232 into V subgroups, is to use N V-way wavelength splitters (interleaving is one instance of a wavelength splitter). Each of the V AOXC COP(v) chains 236′ should be capable of handling the wavelengths which are routed from the output ports of the wavelength splitters to the input ports of the AOXC COP chain module.

Interleaved AOXC COP architecture 316 has a number of advantages. It allows extending the total number of wavelengths K in a modular way, by adding more AOXC COP(v) chain modules. For a given wavelength density which is supported by the OP arrays 202 of the AOXC COP(v) chains 236′, the wavelength partitioning feature of the optical interleavers supports an increased wavelength density of the WDM wavelengths on the input and output fibers, by a factor of V. The architecture may utilize smaller standard OP building blocks, since the AOXC COP(v) chain 236′ supports less than the total number of wavelengths, thus, the OP arrays 202 of the AOXC(v) chain 236′ have less columns than the OP arrays 202 of a non-interleaved AOXC COP architecture with the same total number of wavelengths.

Extended Dimensions of AOXC COP Architectures

The all optical cross connect (AOXC) chained optical package (COP) architecture is extendable in the number of input fibers, the number of output fibers, and/or, the number of supported wavelengths, as follows:

For Increasing the Number of Input Fibers:

(1) in the various ‘Chained Input’ architectures (‘BCI’ and ‘BICI’, in FIGS. 6 and 7, respectively), the number of rows in the OP arrays 202 are extended;

(2) in the various ‘Chained Output’ architectures (‘BCO’, ‘BICO’, ‘CCO’, ‘CICO’, ‘MCO’, and, ‘MICO’, in FIGS. 8, 9, 11, 12, 13, and, 14, respectively), the number of OP arrays 202, and, the number of optical filters 264 (either as separated or as integrated into OP arrays 202), are extended; and

(3) in the various ‘Wavelength Chained Output’ architectures (‘BWCO’ and ‘MWCO’, in FIGS. 10 and 15, respectively), the number of optical filters 264, and, the number of columns in each of the OP arrays 202, are extended.

For Increasing the Number of Output Fibers:

(1) in the various ‘Chained Input’ architectures (‘BCI’ and ‘BICI’, in FIGS. 6 and 7, respectively), the number of OP arrays 202, and, the number of optical multiplexers 252, either as separated or as integrated into OP arrays 202, are extended;

(2) in the various ‘Chained Output’ architectures (‘BCO’, ‘BICO’, ‘CCO’, ‘CICO’, ‘MCO’, and, ‘MICO’, in FIGS. 8, 9, 11, 12, 13, and, 14, respectively, the number of rows in OP arrays 202 are extended; and

(3) in the various ‘Wavelength Chained Output’ architectures (‘BWCO’ and ‘MWCO’, in FIGS. 10 and 15, respectively), the number of rows in OP arrays 202 are extended.

For Increasing the Number of Wavelengths:

(1) in the various ‘Chained Input’ architectures (‘BCI’ and ‘BICI’, in FIGS. 6 and 7, respectively), the number of columns in OP arrays 202, and, the number of columns in optical multiplexers 252 (either as separated or as integrated into OP arrays 202), are extended;

(2) in the various ‘Chained Output’ architectures (‘BCO’, ‘BICO’, ‘CCO’, ‘CICO’, ‘MCO’, and, ‘MICO’, in FIGS. 8, 9, 11, 12, 13, and, 14, respectively), the number of columns in OP arrays 202, and, the number of columns in optical filters 264, either as separated or as integrated into OP arrays 202, are extended; and

(3) in the various ‘Wavelength Chained Output’ architectures (‘BWCO’ and ‘MWCO’, in FIGS. 10 and 15, respectively), the number of OP arrays 202, and, the number of columns in optical filters 264, are extended.

In all cases, the number of OS elements 204 (FIG. 3) increases linearly with the increase in capacity. This makes the reservation of resources for future expansion very reasonable in most cases.

Due to the particular COP architecture, extending the AOXC COP array architecture in any of the dimensions has a small effect of the insertion loss, whereby:

The number of OS elements that divert a particular wavelength component of an optical signal from a particular input fiber 232 to a particular output fiber 234 remains two in the various ‘Chained Input’, ‘Chained Output’ and ‘Wavelength Chained Output’ architectures, independent of the size of the AOXC COP array architecture.

The number of optical connections that the light from an input fiber 232 to an output fiber 234 encounters between an OP array 202 and either a separated optical multiplexer 252 or a separated optical filter 264 remains one, independent of the size of the AOXC COP array.

The number of transparent OS elements that are traversed will grow with the extension of the size of the AOXC COP array, however, the contribution of this to the insertion loss is very small.

The number of optical connections between OP arrays 202 that the light traverses does not change with the increase of the following dimensions: (1) the number of wavelengths, in the various ‘Chained Input’ and ‘Chained Output’ AOXC COP architectures; (2) the number of input fibers, in the various ‘Chained Input’ and ‘Wavelength Chained Output’ AOXC COP architectures; and (3) the number output fibers, in the various ‘Chained Output’ and ‘Wavelength Chained Output’ AOXC COP architectures.

No change in the number of optical couplers 286, and hence no change in the insertion loss due to those elements, even if the dimensions of the AOXC COP array increase, as long as the number of ‘coupled’ output fibers does not change. This applies to the various ‘coupled’ and ‘mixed’ architectures (‘CCO’, ‘CICO’, ‘MCO’, ‘MICO’, and, ‘MWCO’, in FIGS. 11, 12, 13, 14, and, 15, respectively).

Extended Switching and Routing Features

Grouping

The grouping feature, of routing different λₖ components of optical signals from different input fibers n 232 into a same output fiber m 234, is a basic property of any ‘optical cross connect’ (OXC) device.

The grouping function in the various ‘Chained Input’ architectures (‘BCI’ and ‘BICI’, in FIGS. 6 and 7, respectively) is implemented simply when more than one element OS(n,k) in different rows n and columns k are activated in the same array OP(m) 202. Note that this implements an integrated splitter function. The diverted portions of the different λₖ components from the different input fibers n 232 are then multiplexed into a same output fiber m 234 by activating the respective elements OS(k) in the optical multiplexer OM(m) 252 in ‘BCI’ AOXC COP architecture 246 (FIG. 6), or, by activating the respective elements OS(N+1,k) in the array OP(m) 202 when optical multiplexer OM(m) 252 is integrated as row N+1 256 of array OP(m) 202 in ‘BICI’ AOXC COP architecture 254 (FIG. 7).

The grouping function in the various ‘Chained Output’ architectures (‘BCO’, ‘BICO’, ‘CCO’, ‘CICO’, ‘MCO’ and ‘MICO’, in FIGS. 8, 9, 11, 12, 13, and, 14, respectively) is implemented simply when each different λₖ component, or portion thereof, of the optical signal from each different input fiber n 232 that is routed into the respective column k of the respective array OP(n) 202 (by activating the element OS(k) of optical filter OF(n) 264 in the ‘BCO’, ‘CCO’, and, ‘MCO’, AOXC COP architectures (258 (FIG. 8), 280 (FIG. 11), and, 294 (FIG. 13), respectively), or, by activating the element OS(0,k) of the array OP(n) 202 when optical filter OF(n) 264 is integrated as row 0 270 of array OP(n) 202 in the ‘BICO’, ‘CICO’, and, ‘MICO’ AOXC architectures (268 (FIG. 9), 290 (FIG. 12), and, 312 (FIG. 14), respectively)), is diverted by the element OS(m,k) in the same row m and in the respective column k of the respective array OP(n) 202, that is, to a same output fiber m 234.

The grouping function in the various ‘Wavelength Chained Output’ architectures (‘BWCO’ and ‘MWCO’, in FIGS. 10 and 15, respectively) is implemented simply when each different λₖ component, or portion thereof, of the optical signal from each different input fiber n 232 that is routed into the respective column n of the respective array OP(k) 202 (by activating the element OS(k) of optical filter OF(n) 264), is diverted by the element OS(m,n) in the same row m and in the respective column n of the respective array OP(k) 202, that is, to a same output fiber m 234.

Multicasting

The multicast function in the various ‘Chained Input’ architectures (‘BCI’ and ‘BICI’, in FIGS. 6 and 7, respectively) is implemented simply when the same λₖ component of the optical signal from the same input fiber n 232 is partially diverted in more than one OP array 202, that is, to multiple output fibers 234. Namely, an element OS(n,k) is activated in more than one array OP(m) 202. The diverted portions of the λₖ component from the same input fiber n 232 are then multiplexed into the specific output fibers m 234 by activating the element OS(k) in the respective optical multiplexers OM(m) 252 in ‘BCI’ AOXC COP architecture 246 (FIG. 6), or, by activating an element OS(N+1,k) in the respective arrays OP(m) 202 when optical multiplexers OM(m) 252 are integrated as row N+1 256 of arrays OP(m) 202 in ‘BICI’ AOXC COP architecture 254 (FIG. 7).

The multicast function in the various ‘Chained Output’ architectures (‘BCO’, ‘BICO’, ‘CCO’, ‘CICO’, ‘MCO’, and, ‘MICO’, in FIGS. 8, 9, 11, 12, 13, and, 14, respectively) is implemented simply when at least a portion of the λₖ component of the optical signal from input fiber n 232 that is routed into column k of array OP(n) 202 (by activating an element OS(k) of optical filter OF(n) 264 in the ‘BCO’, ‘CCO’, and, ‘MCO’, AOXC COP architectures (258 (FIG. 8), 280 (FIG. 11), and, 294 (FIG. 13), respectively), or, by activating an element OS(0,k) of array OP(n) 202 when optical filter OF(n) 264 is integrated as row 0 270 of array OP(n) 202 in the ‘BICO’, ‘CICO’, and, ‘MICO’ AOXC architectures (268 (FIG. 9), 290 (FIG. 12), and, 312 (FIG. 14), respectively)), is partially diverted by more than one OS element in rows 1 to M in the same column k of array OP(n) 202, that is, to multiple output fibers m 234.

The multicast function in the various ‘Wavelength Chained Output’ architectures (‘BWCO’ 272 (FIG. 10), and, ‘MWCO’ 314 (FIG. 15), respectively) is implemented simply when at least a portion of the λₖ component of the optical signal from input fiber n 232 that is routed into column n of array OP(k) 202 (by activating an element OS(k) of optical filter OF(n) 264), is partially diverted by more than one OS element in column n of OP(k) array 202, that is, to multiple output fibers m 234.

One particular application of the inherent multicast capability of the AOXC COP architecture is a ‘1+1’ protection mechanism which is enabled by splitting and transmitting the same optical signal out to two different output fibers. This split signal could be further routed through different paths to the same destination. A receiver at the destination receives two instances of the same optical signal and monitors the active instance. In case of failure of the active instance, the receiver can switch over to the second instance instantaneously, causing minimal loss of information.

Adding and/or Dropping Single Wavelengths

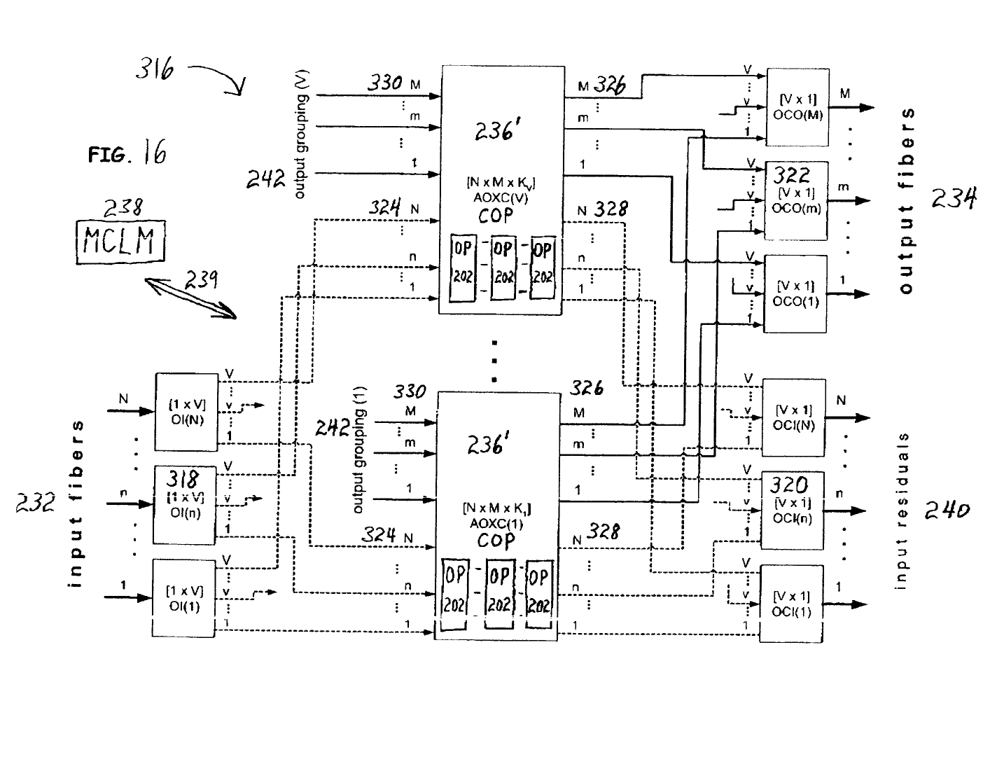

FIG. 17 is a schematic diagram illustrating a specific embodiment 332 of general all optical cross connect (AOXC) chained optical package (COP) architecture 230 (FIG. 5), featuring an ‘add’ mechanism 334 and a ‘drop’ mechanism 336, for adding and/or dropping single wavelengths.

The addition of wavelengths carried by up to R fibers, referred to as ‘added wavelengths’ input fibers 338, where each fiber r carries a single wavelength λᵣ, is illustrated in FIG. 17. ‘Add’ mechanism 334 is based on connecting a [M×R] dimensioned OP array, herein, referred to as an ADD OP array 340, to the [N×M×K] dimensioned AOXC COP chain 236, where:

(1) for r=1 to R, ‘added wavelengths’ input fiber r 338 is optically connected to the bottom of column r of ADD OP array 340, where all OS elements in column r are selective to the same wavelength λᵣ; and

(2) for m=1 to M, the right side of row m of ADD OP array 340 is optically connected to output-grouping 342 input port m of AOXC COP chain 236.

‘Add’ mechanism 334 operates as follows. Activating an element OS(m,r) in ADD OP array 340 selects at least a portion of a wavelength λᵣ component from ‘added wavelengths’ input fiber r 338 to be added to the group of wavelengths routed to output fiber m 234. Multicasting of an added wavelength carried by an ‘added wavelengths’ input fiber r 338 may be implemented by activating more than one OS in the respective column r of ADD OP array 340, and, grouping a set of added wavelengths carried by a set of ‘added wavelengths’ input fibers 338 to a particular output fiber m 234 is implemented by activating more than one OS element in the respective row m of ADD OP array 340. More than one set of single wavelengths carried by more than one set of ‘added wavelengths’ input fibers 338, may be added to a particular AOXC COP chain 236, by chaining the M rows of multiple ADD OP arrays 340 according to an ‘ADD cascading’ configuration (not shown in FIG. 17), in which, for m=1 to M, the right side of row m of ADD OP array 340 is optically connected to an ‘ADD cascading’ input port m 344 of a next ADD OP array 340 in the cascade. Note, however, that routing of the same wavelength from more than one input source, either input fibers m 232, and/or, ‘added wavelengths’ input fibers r 338, and/or, ‘ADD cascading’ input ports 344, to a same output fiber 234 causes a conflict, whereby, management and control logic mechanism (MCLM) 238 prevents this situation.

Dropping of up to S wavelengths into, up to S fibers s, for s=1 to S, with single wavelength λₛ per fiber, herein, referred to as ‘dropped wavelengths’ output fibers 346, is also illustrated in FIG. 17. Operation of ‘drop’ mechanism 336 is based on connecting a [N×S] dimensioned OP array, herein, referred to as a DROP OP array 348, to [N×M×K] dimensioned AOXC COP chain 236, where:

(1) for n=1 to N, input-residuals output port n 350 of AOXC COP chain 236 is optically connected to the left of row n of DROP OP array 336; and

(2) for s=1 to S, ‘dropped wavelengths’ output fiber s 346, carrying a single dropped λₛ, is optically connected to the top of column s of DROP OP array 348, where all OS elements in column s are selective to a same wavelength λₛ.

‘Drop’ mechanism 336 operates as follows. Activating an OS(n,s) in DROP OP array 348 selects at least a portion of a wavelength λₛ component from an input-residuals output port n 350 of AOXC COP chain 236 to be dropped into ‘dropped wavelengths’ output fiber s 346. Activating more than one OS element in a row simply drops more than one wavelength from a particular input-residuals output port 350. Activating more than one OS element per column s will cause a conflict of dropping components with a same wavelength, λₛ, of the optical signals from different input-residuals output ports 350 of AOXC COP chain 236, into a same ‘dropped wavelengths’ output fiber s 346, whereby management and control logic mechanism (MCLM) 238 prevents this situation.

Note that in the description above, the input to DROP OP array 348 is from input-residuals output ports 350 of AOXC COP chain 236. Alternatively, the input to DROP OP array 348 could be split from input fibers 232 at the input to AOXC COP chain 236.

More than one set of wavelengths may be dropped from a particular AOXC COP chain 236, into more than one set of ‘dropped wavelengths’ output fibers 346, by chaining the N rows of multiple DROP OP arrays 348 according to a ‘DROP cascading’ configuration (not shown in FIG. 17), in which, for n=1 to N, a ‘DROP cascading’ output port n 352 of DROP OP array 348 is optically connected to the left side of row n of a next ADD OP array 348 in the cascade.

‘Add’ mechanism 334 and ‘drop’ mechanism 336 may be added to, without affecting operation of, AOXC COP chain 236. Moreover, when these mechanisms are added to an AOXC COP chain that features previously described and illustrated Interleaved AOXC COP architecture 316 (FIG. 16), ‘add’ mechanism 334 and/or ‘drop’ mechanism 336 may each be added separately to each of the V [N×M×Kᵥ] AOXC(v) chains 236′ (FIG. 16). Moreover, management and control logic mechanism (MCLM) 238 logically manages and controls AOXC COP chain 236, ‘add’ mechanism 334, and, ‘drop’ mechanism 336.

These types of ‘add’ and ‘drop’ mechanisms are useful for connecting a router port, an ATM switch, or, any other user device or mechanism, to the extendable all optical communication network. The advantage in the way each mechanism integrates with the COP AOXC architecture is that it interfaces through a small number of fibers, whereby each mechanism can be added in an incremental or partial way.

Adding and/or Dropping Groups of a Plurality of Wavelengths

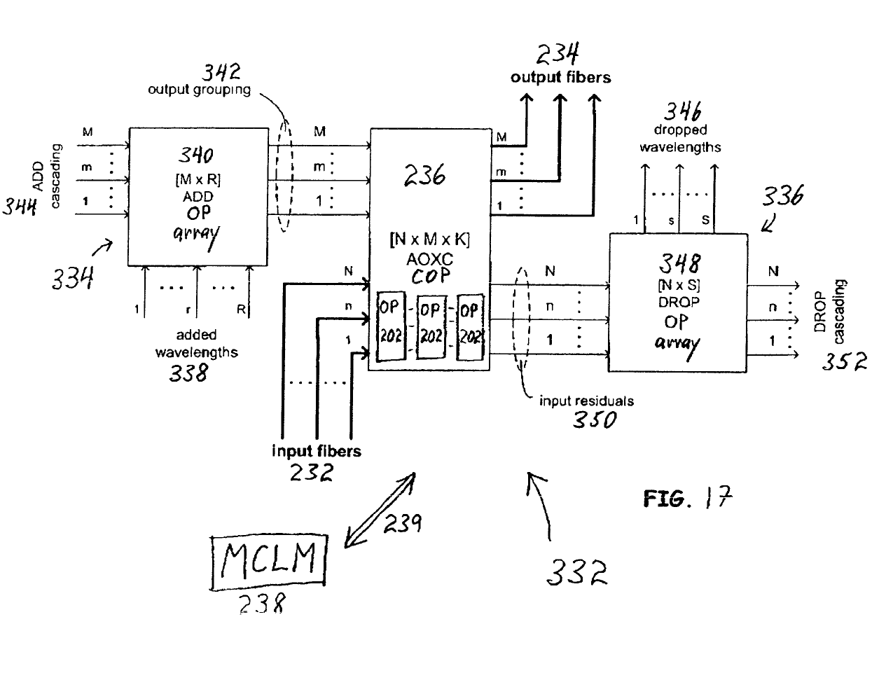

FIG. 18 is a schematic diagram illustrating a specific embodiment 333 of general all optical cross connect (AOXC) chained optical package (COP) architecture 230 of FIG. 5, featuring a ‘grouped add’ mechanism 334′ and a ‘grouped drop’ mechanism 336′, for adding and/or dropping groups of a plurality of wavelengths.

The addition of up to G fibers with up to R wavelengths per fiber, referred to as ‘added wavelengths’ input fibers 338′, is illustrated in FIG. 18. ‘Grouped add’ mechanism 334′ is based on connecting a [(G+M)×R] OP array, herein, referred to as a grouped ADD OP array 340′, to the [N×M×K] dimensioned AOXC COP chain 236. Up to G ‘added wavelengths’ input fibers g 338′, for g=1 to G, each carrying up to R wavelengths λᵣ, for r=1 to R, are connected to the left side of the G lower rows of grouped ADD OP array 340′, that is, the lower part 354 of grouped ADD OP array 340′. Output-grouping input ports 342′ of AOXC COP chain 236 are connected to the right side of the higher M rows of grouped ADD OP array 340′, that is, the upper part 356 of grouped ADD OP array 340′, in a way similar to previously described and illustrated Adding and/or Dropping single wavelengths. All OS elements in a column r of grouped ADD OP array 340′ are selective to a same wavelength λᵣ.

‘Grouped add’ mechanism 334′ operates as follows. Activating an element OS(g,r) in lower part 354 of grouped ADD OP array 340′, selects at least a portion of a wavelength λᵣ component from a particular ‘added wavelengths’ input fiber g 338′ to be added to the group of output fibers 234. Activating an element OS(G+m,r) in upper part 356 of grouped ADD OP array 340′, selects at least a portion of a wavelength λᵣ component to be routed to an output fiber m 234. Activating more than one OS element in a column r in lower part 354 of grouped ADD OP array 340′ leads to a conflict of adding components with a same wavelength, λᵣ, of the optical signals from different ‘added wavelengths’ input fibers 338′ to a same output fiber m 234, whereby management and control logic mechanism (MCLM) 238 prevents this situation.

Multicast of added wavelengths is implemented by activating more than one OS element in a column in upper part 356 of grouped ADD OP array 340′. Activating more than one OS element in any row of grouped ADD OP array 340′ simply leads to grouping of added wavelengths, either grouping from an ‘added wavelengths’ input fiber g 338′, when the row is g in lower part 354, or, grouping to an output fiber m 234, when the row is G+m in upper part 356.

Only up to R wavelengths can be added with a single grouped ADD OP array 340′. In order to add more wavelengths, it is possible to chain the M rows of upper part 356 of multiple grouped ADD OP arrays 340′, according to an ‘ADD cascading’ configuration, (not shown in FIG. 18), in which, for m=1 to M, the right side of row G+m of upper part 356 of a grouped ADD OP array 340′ is optically connected to a grouped ‘ADD cascading’ input port m 344′ of a next ADD OP array 340′ in the cascade.

The dropping of up to S wavelengths on up to F fibers, referred to as ‘dropped wavelengths’ output fibers 346′, is also illustrated in FIG. 18. ‘Grouped drop’ mechanism 336′ is based on connecting a [(N+F)×S] OP array, herein, referred to as a grouped DROP OP array 348′, to the [N×M×K] dimensioned AOXC COP chain 236. The N input-residuals output ports 350′ of AOXC COP chain 236 are connected to the left of the lower N rows of grouped DROP OP array 348′, that is, the lower part 358 of grouped DROP OP array 348′. The F ‘dropped wavelengths’ output fibers f 346′, for f=1 to F, each for carrying S dropped wavelengths λₛ, for s=1 to S, are optically connected to the right side of the higher F rows of grouped DROP OP array 348′, that is, the upper part 360 of grouped DROP OP array 348′. All OS elements in a column s of grouped DROP OP array 348′ are selective to a same wavelength λₛ.

‘Grouped drop’ mechanism 336′ operates as follows. Activating an element OS(n,s) in lower part 358 of grouped DROP OP array 348′, selects at least a portion of a wavelength λₛ component to be dropped from an input-residuals output port n 350′ of AOXC COP chain 236. Activating an element OS(N+f,s) in upper part 360 of grouped DROP OP array 348′, selects at least a portion of a wavelength λₛ component to be routed to ‘dropped wavelengths’ output fiber f 346′. Activating more than one OS element in any row of grouped DROP OP array 348′, simply drops more than one wavelength from a particular input-residuals output port 350′, into a particular ‘dropped wavelengths’ output fiber 346′. Activating more than one OS element per column s in lower part 358 of grouped DROP OP array 348′ will cause a conflict of dropping components with a same wavelength, λₛ, of the optical signals from different input-residuals output ports 350′ of AOXC COP chain 236, into a same ‘dropped wavelengths’ output fiber f 346′, whereby management and control logic mechanism (MCLM) 238 prevents this situation.

Multicasting of dropped wavelengths may be implemented by activating more than one OS per column in upper part 360 of grouped DROP OP array 348′. Activating more than one OS element in any row of grouped DROP OP array 348′ simply leads to grouping of dropped wavelengths, either grouping from an input-residuals output port n 350′ of AOXC COP chain 236, when the row is n in lower part 358, or, grouping to a ‘dropped wavelengths’ output fiber f 346′, when the row is N+f in upper part 360.

Note that in the description above, the input to grouped DROP OP array 348′ is from input-residuals output ports 350′ of AOXC COP chain 236. Alternatively, the input to grouped DROP OP array 348′ could be split from input fibers 232 at the input to AOXC COP chain 236.

Only up to S wavelengths can be dropped with a single grouped DROP OP array 348′. In order to drop more wavelengths, it is possible to chain the N rows of lower part 358 of multiple grouped DROP OP arrays 348′, according to a ‘DROP cascading’ configuration (not shown in FIG. 18), in which, for n=1 to N, a ‘DROP cascading’ output port n 352′ of a grouped DROP OP array 348′ is optically connected to the left side of row n of a lower part 358 of a next grouped ADD OP array 348′, in the cascade.

‘Grouped add’ mechanism 334′ and ‘grouped drop’ mechanism 336′ may be added to, without affecting operation of, AOXC COP chain 236. Moreover, when these mechanisms are added to an AOXC COP chain that features previously described and illustrated Interleaved AOXC COP architecture 316 (FIG. 16), ‘grouped add’ mechanism 334′ may be added separately to each of the V [N×M×Kᵥ] AOXC(v) chains 236′, via the v'th ‘output grouping (v)’ group of output-grouping input ports 330 (FIG. 16). Furthermore, management and control logic mechanism (MCLM) 238 logically manages and controls AOXC COP chain 236, ‘grouped add’ mechanism 334, and, ‘grouped drop’ mechanism 336.

These types of ‘grouped add’ and ‘grouped drop’ mechanisms are useful, for example, and in a non-limiting fashion, to connect, via a set of transponders, to user equipment that already includes WDM multiplexers and demultiplexers. The advantage in the way each mechanism integrates with the COP AOXC COP architecture is that it interfaces through a small number of fibers, whereby each mechanism can be added in an incremental or partial way.

Wavelength Conversion and Restoration

Wavelength conversion may be needed in order to prevent blocking during the wavelength switching and routing process in the optical communication system. Restoration may be required when a routed path experiences too much loss. There are many ways to implement wavelength conversion and restoration functions. Basic system 200 featuring optical package (OP) array 202 of optical switch (OS) elements 204, and, management and control logic mechanism 214 (FIG. 3); scaled-up system 216 featuring scaled-up optical package (OP) array 205, and, scaled-up management and control logic mechanism (MCLM) 226 (FIG. 4); general embodiment of extendable all optical cross connect (AOXC) chained optical package (COP) architecture 230 featuring [N×M×K] dimensioned AOXC COP array 236 of OP arrays 202, and, management and control logic mechanism 238 (FIG. 5); and, the different specific embodiments of extendable all optical cross connect (AOXC) chained optical package (COP) architectures (FIGS. 6-18), of the present invention, described and illustrated herein, are each optimized for minimizing the number of detector/laser units, maintaining a ‘pool’ of convert/restore units according to the maximal number of concurrent conversion/restoration required at any particular time, rather than a convert/restore unit per each combination of input fiber, wavelength and output fiber.

Implementing the wavelength convert/restore functionality within the embodiments of the present invention, is based on utilizing the ‘add/drop’ mechanisms previously described and illustrated, above. A wavelength λₓ, to be converted/restored, is dropped from the optical signal, routed to a convert/restore unit, and the converted/restored wavelength λ_{y} is added to the optical signal. When λₓ is not equal to λ_{y}, the convert/restore unit operates as a converter, whereas, when λₓ equals λ_{y}, the convert/restore unit operates as a restorer. Maximum flexibility is achieved when the convert/restore units employ tunable lasers since a tunable laser may be used for conversion/restoration of different wavelengths at different times.

Logical Management and Control

Optical Signal Management and Control

Logical management and control of optical signals in the various AOXC COP architecture systems of the present invention, is performed by routing the managed optical signals, or portions thereof, to one or more detectors which are capable of measuring the monitored features of the optical signals. The measured values are then used by the management and control logic mechanism (MCLM) for logically managing and controlling the AOXC COP architecture system.

There are several ways to logically switch and route the managed optical signals to the detectors in an AOXC COP architecture system of the present invention. One way is to use a direct optical connection of an output signal, for example, a leftover signal, to a detector. Another way is to ‘tap’ and route a portion of the managed optical signal, to one or more detectors. The ‘tapped’ signal can be any of the optical signals in conjunction with the particular AOXC COP architecture system, that is, any of the input and output signals of the AOXC COP chain, or, any optical signal inside the AOXC COP chain. Examples of tapping and routing of managed and controlled signals are illustrated in FIGS. 19A, 19B, and, 20.

FIG. 19A is a schematic diagram illustrating an exemplary embodiment 370 of the management and control logic mechanism (MCLM) 238 of an extendable all optical cross connect (AOXC) chained optical package (COP) architecture system (not shown here), featuring single optical signal tapping and routing to multiple detectors. In FIG. 19A, an optical filter OF 372 is used to filter out (tap) portions of up to W wavelength components λ_{w}, for w=1 to W, of a single managed signal 374. The filtered out portions of the wavelength components, λ₁ to λ_{W}, can be optically connected to detectors 376, D(1) to D(W), respectively. The portion of managed signal 374 which is not filtered out continues in the direction of managed signal 374, as a carry-over signal 378 for further managing and controlling, and/or, switching and routing, either by the AOXC COP architecture system, when managed signal 374 is an input signal or an internal optical signal of the AOXC COP architecture system, or, by other components of the optical communication system, when managed signal 374 is an output signal of the AOXC COP architecture system.

FIG. 19B is a schematic diagram illustrating an exemplary embodiment 380 of the management and control logic mechanism (MCLM) 238 of an extendable all optical cross connect (AOXC) chained optical package (COP) architecture system (not shown here), featuring single optical signal tapping and routing to a single detector. Embodiment 380 of FIG. 19B is similar to embodiment 370 illustrated in FIG. 19A, in filtering out portions of wavelength components of managed signal 374, but, with the filtered out portions multiplexed by an optical multiplexer OM 382, and, routed to a single detector D 376′. The advantage here is that single detector D 376′ can be used to monitor any single wavelength in the AOXC COP architecture system, one at a time, or, groups of wavelengths simultaneously.

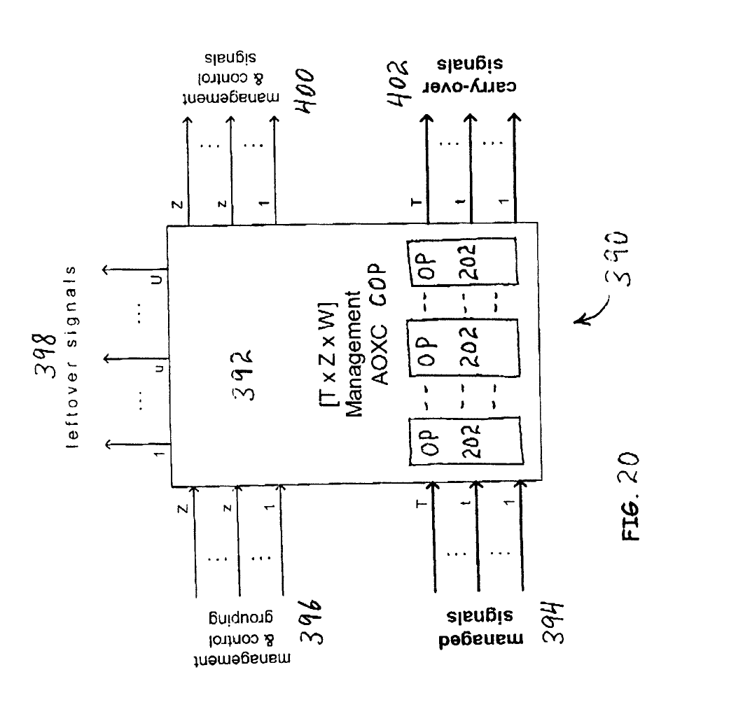

FIG. 20 is a schematic diagram illustrating an exemplary embodiment 390 incorporating an extendable all optical cross connect (AOXC) chained optical package (COP) architecture as part of the management and control logic mechanism (MCLM) 238. In FIG. 20, a [T×Z×W] dimensioned AOXC COP architecture, referred to as ‘management AOXC COP’ 392, is utilized for logically managing and controlling up to W wavelengths of a group of T managed signals 394, via a group of Z management and control signals 400, and, a group of U leftover signals 398.

Management AOXC COP 392 can be constructed according to any of the previously described and illustrated specific embodiments of AOXC COP architectures, for switching and routing the optical signals of the optical communication system. Management AOXC COP 392 can be interjected into a ‘switching and routing AOXC COP’ architecture for logical management and control of any of the optical signals involved in the switching and routing process, that is, any of the input and output signals as well as any internal optical signal of the ‘switching and routing AOXC COP’ architecture.

Management AOXC COP 392 filters out (taps) portions of up to W wavelength components of the T managed signals 394, and, routes the filtered out portions into two sets of output signals for logical management and control purposes, that is, the group of Z management and control signals 400, and, the group of U leftover signals 398. The output signals for logical management and control purposes, for example, can be optically connected to detectors (such as illustrated in FIGS. 19A and 19B), or, be optically connected to a group of ‘management and control grouping’ input ports 396 of another ‘management AOXC COP’ architecture (not shown here), thus, forming a cascade of ‘management AOXC COP’ architectures.

The portion of each of the T managed signals 394 which is not filtered out by management AOXC COP 392 continues in the direction of each corresponding managed signal 394, as a carry-over signal 402 for further managing and controlling, and/or, switching and routing, either by a ‘switching and routing AOXC COP’ architecture, when each corresponding managed signal 394 is an input signal or an internal optical signal of the ‘switching and routing AOXC COP’ architecture, or, by other components of the optical communication system, when each corresponding managed signal 394 is an output signal of the ‘switching and routing AOXC COP’ architecture.

Properly selecting the managed signals and their tapping points could be very effective in the AOXC COP architecture system during the logical management and control of normal operation and/or fault detection. If necessary, the management and control logic mechanism (MCLM) can combine information from multiple measurements to logically manage and control the AOXC COP architecture system and/or analyze a fault, for example, a single detector might be insufficient to pinpoint a fault in a particular optical communication system.

Thus, the method and system of the present invention support implementation of the so called ‘non-interfering network management’. Unlike prior art methods of optical network management, in which multichannel optical signals are converted to electronic signals, by implementing the present invention, network management functions manipulate such electronic signals, and, finally, these electronic signals are converted back to optical signals, whereby the network management method of the present invention is based on electronic manipulation of signals created from the diverted portions of the optical channels, while the non-diverted portions of the optical channels continue to propagate, unaffected, in the optical communication network.

Fault Detection in AOXC COP Architectures

Connecting the simplest type of light detector to leftover and/or optional input-residuals signals could be used for detecting major system problems. For example, (1) loss of light power at input-residuals output ports might indicate that an input fiber is broken, and/or, malfunction of the AOXC COP architecture system, and, (2) loss of light at the top of a column k of an OP array, that is, no leftover signal, might indicate that a laser driving the wavelength λₖ at the source of a certain input optical signal has a problem, and/or, indicate a disconnection in the optical path from the source laser to the tapping point.

Power Management and Control

Power management and control in the various embodiments of the AOXC COP architecture systems of the present invention may be performed on any input and output signal of the AOXC COP system, as well as any optical signal inside the AOXC COP system. The power level of the optical signal can be managed and controlled to match a desired power spectrum, such as a uniform, equalized signal, by decreasing, for example, by attenuating, or, by increasing, for example, by amplifying using an EDFA amplifier, the power level of the various wavelength components of the optical signal. It is the function of the management and control logic mechanism (MCLM) to counteract (compensate) the gain non-uniformity of an optical amplifier which is used for increasing the power of the optical signal.

The power of input signals can be measured by tapping and measuring the input signals, or, by tapping and measuring the power levels at the optional input-residuals output fibers of the AOXC COP system. In the latter case, the measured value, in conjunction with the knowledge about the level of activation applied to the OS elements in the optical paths from the input fibers to the optional input-residuals output fibers, can be used to calculate the input signals power level, and, be used as data for operation of the management and control logic mechanism (MCLM).

Power management of the output signals of an AOXC COP architecture system can be performed by tapping and measuring the output signals, using the measured power levels as data to the management and control logic mechanism (MCLM). Another possible way of determining the power of the output signals, is by measuring the power of the ‘leftover signals’, and then together with the knowledge of the level of activation of the OS elements in the optical paths leading to the leftover signals, to let the management and control logic mechanism (MCLM) compute the power switched into the output fibers of the AOXC COP system.

Following are description and illustrations of three dimensional (3-D) physical representations of structure and function of the present invention described and illustrated above in terms of two dimensional representations, relating to basic system 200 featuring optical package (OP) array 202 of optical switch (OS) elements 204, and, management and control logic mechanism 214 (FIG. 3); scaled-up system 216 featuring scaled-up optical package (OP) array 205, and, scaled-up management and control logic mechanism (MCLM) 226 (FIG. 4); general embodiment of extendable all optical cross connect (AOXC) chained optical package (COP) architecture 230 featuring [N×M×K] dimensioned AOXC COP array 236 of OP arrays 202, and, management and control logic mechanism 238 (FIG. 5); and, the different specific embodiments of extendable all optical cross connect (AOXC) chained optical package (COP) architectures (FIGS. 6-18), of the present invention. It is to be clearly understood that the following description and accompanying drawings do not refer to a different invention which is derived from, or, separate from, the above described and illustrated invention of a method and system for switching and routing, while logically managing and controlling, multichannel optical signals in an optical communication system.

For purposes of clarity of presentation and understanding, a three dimensional Cartesian coordinate system is used herein for describing and illustrating the 3-D representations of the system of the present invention, however, it is to be clearly understood that other three dimensional curvilinear coordinate systems, for example, spherical, cylindrical, hyperbolic, parabolic, can be used for describing, illustrating, and, implementing the present invention.

The system of the present invention can be described and illustrated in terms of three dimensional (3-D) physical representations featuring a spatial array of optical switch (OS) elements, that is, optical switch (OS) elements 204 previously described and illustrated in FIG. 3, above, such as voltage controlled Electroholography based optical switches, for example, the optical switch (OS) element described in previously cited PCT International Patent Application Publication No. WO 00/02098, of PCT Patent Application No. PCT/IL99/00368, and, in co-filed U.S. patent application Ser. No. 09/348,057, placed in pre-determined positions relative to each other, thereby forming three dimensional representations of the above described and illustrated optical package (OP) array, for example, optical package (OP) array 202 (FIG. 3 and other figures), with the following characteristics.

As described above, the system of the present invention is designed for switching and routing each of the incoming wavelengths on each of the incoming input ports to each of the output ports. The system is designed for individually activating and controlling each OS element within a particular three dimensional OP array. Each OS element is selective to a particular wavelength, whereby, (1) when an OS element is not activated (switched off), then it is transparent, causing minimal loss, to the light signal flowing through it, (2) when the OS element is activated (switched on), then part of the light signal of the particular wavelength is diverted at a predetermined angle, where the percentage of the light signal that is diverted compared to the percentage of the light signal that continues is a function of the level of activation, and, the activated OS element is transparent to all the other light signal wavelengths, and, (3) the diverted light signal is grouped with the light signal(s) traveling in the same direction, and can be further diverted by another activated OS element, thus resulting in multiple switching of a certain light signal wavelength from a certain input port.

A brief summary of the main features of the three dimensional representation of the system of the present invention is provided here, followed by the detailed description and accompanying drawings. The system features a three dimensional array of (N+2) by (M+2) by K cells. Each cell in the 3-D array of optical switch (OS) elements is constructed of a mechanical frame hosting an OS element. The frame provides for all electronic control and power of the OS element via appropriate wiring throughout the structure. Each cell has six faces with openings to accommodate light signals that flow through it, that is, sufficiently large openings for a light beam to propagate through. Along an input ports axis (denoted ‘I’) are N layers for switching light signals from N input ports, and two additional layers, one layer (to the right of the input switching layers) is used for grouping and collection operations to the output ports and a second (the rightmost) layer for monitoring and testing purposes. Along the output ports axis (denoted ‘O’) are M layers for switching portions of the light signals from the input ports to M output ports, and two additional layers, one (the bottom) layer is used for initial selection of specific wavelengths of the input ports, and, the second (the top) layer for monitoring and testing purposes. Along the wavelength axis (denoted ‘W’) are K layers for switching the K specific wavelengths.

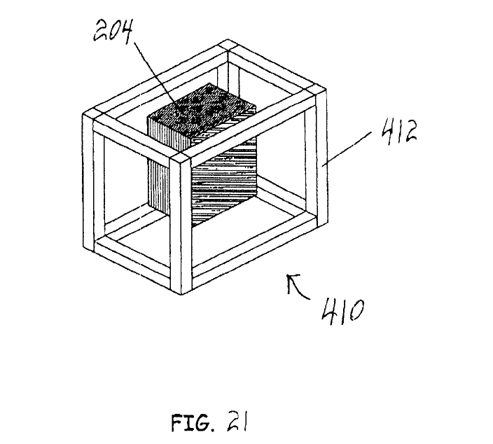

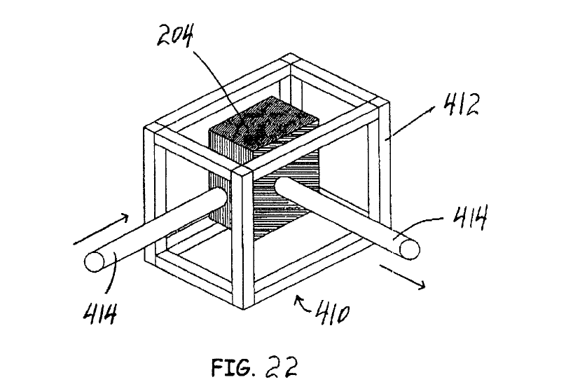

FIG. 21 is a schematic diagram illustrating an exemplary preferred embodiment of a basic optical switching cell 410 housing each optical switch (OS) element 204. Basic optical switching cell 410 features a containing structural frame 412 populated with optical switch (OS) element 204. Frame 412 provides for electronic wiring for controlling and powering OS element 204. Each such optical switching cell 410 of the 3-D array of optical switch (OS) elements 204 has six faces with openings sufficiently large for the light beam 414 carrying the signals to flow and propagate through, as illustrated in FIG. 22, a schematic diagram illustrating light beam switching by optical switch (OS) element 204 within the exemplary preferred embodiment of basic optical switching cell 410 of FIG. 21.

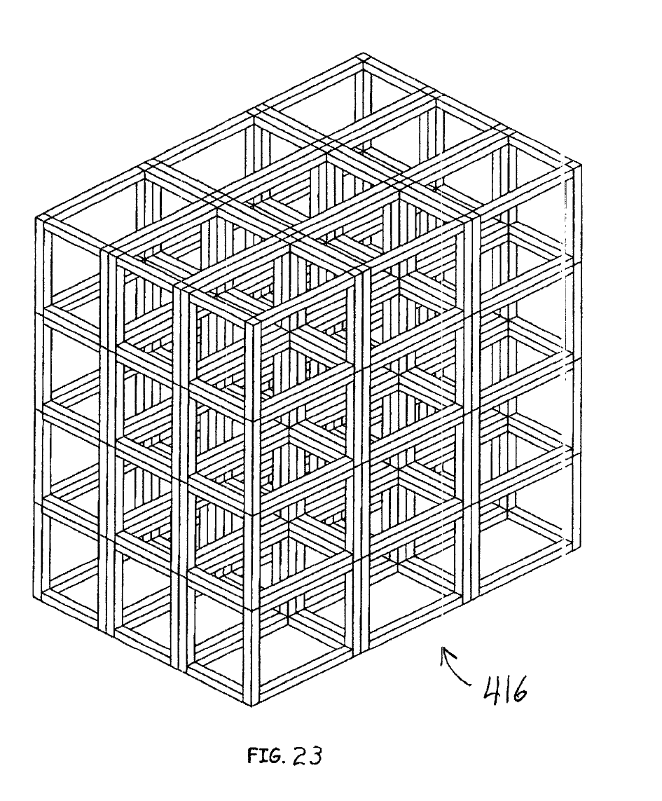

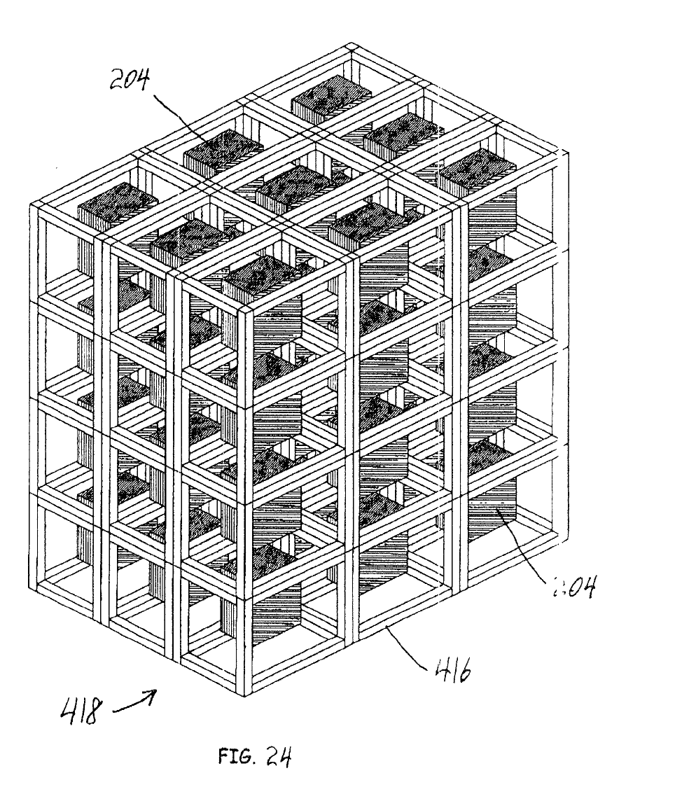

FIG. 23 is a schematic diagram illustrating an exemplary preferred embodiment of a mechanical structure or frame 416 for housing a 3-D array of optical switch (OS) elements. FIG. 24 is a schematic diagram illustrating an exemplary preferred embodiment 418 of mechanical frame 416 of FIG. 23 fully populated with optical switch (OS) elements 204.

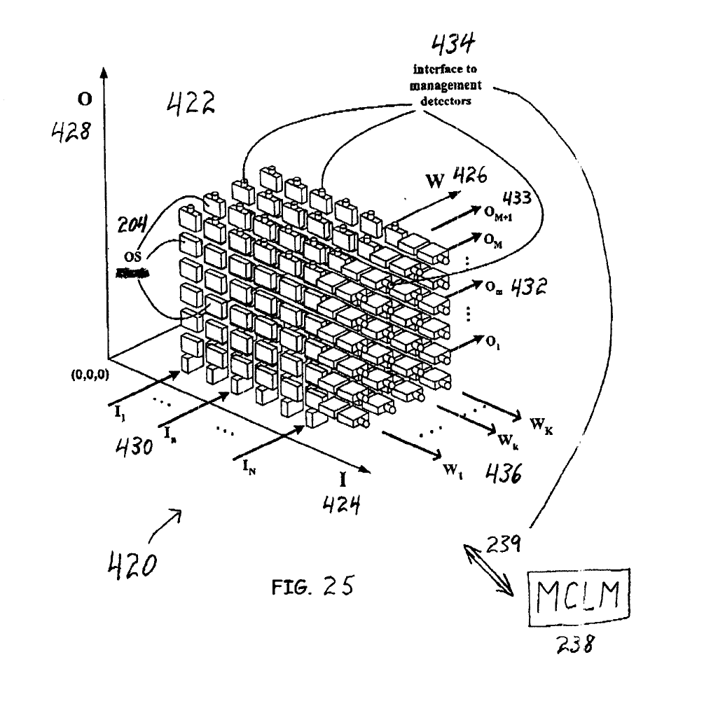

FIG. 25 is a schematic diagram illustrating an exemplary embodiment 420 of a 3-D array 422 of optical switch (OS) elements 204, without mechanical frame 416, together with the axes of the 3-D array and connections to input ports 430 and output ports 432 of an exemplary embodiment of an AOXC COP architecture system of the present invention, including two management and control logic layers, and, an interface 434 for optically connecting detectors of management and control logic mechanism (MCLM) 238, via interface 239, to the optical switch (OS) elements of these layers. For simplicity in clearly understanding method of operation of the system, an exemplary embodiment is shown in FIGS. 25-35 (B5-B15), in which the OS elements 204 are rectangular boxes with the bases of an OS element being parallel to its switching plane, that is, the plane defined by the impinging and diverted beams. In these figures, the following notation and terminology are used:

1. 3-D array 422 of optical switch (OS) elements 204 has three axes: I (Input) 424, O (Output) 426 and W (Wavelength) 428.

2. Each layer (plane) in 3-D array 422 of optical switch (OS) elements 204 is denoted by the two axes it is parallel to, and a layer number.

3. The output layers are denoted IWₘ—the layer is parallel to the I×W plane and is in distance m from the origin of 3-D array 422 of optical switch (OS) elements 204.

In this direction 3-D array 422 has M+2 layers denoted IW₀, IW₁, . . . , IWₘ, . . . , IW_{M}, IW_{M+1}.

IW₁ to IW_{M} are the M output planes.

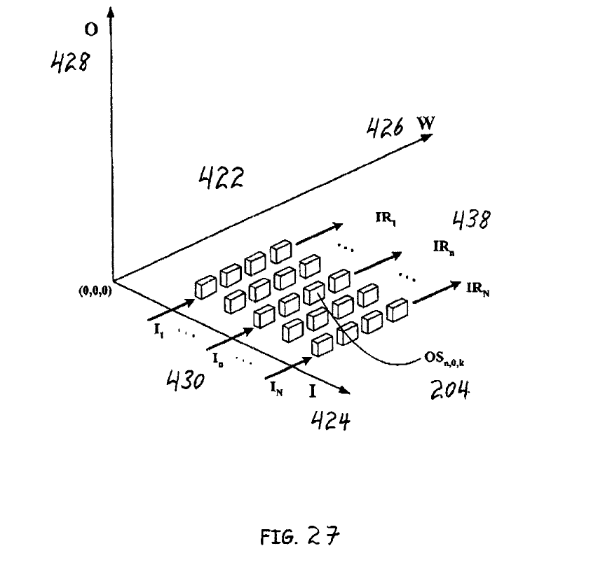

IW₀ is the input-connections and optional input-residuals layer (FIG. 27).

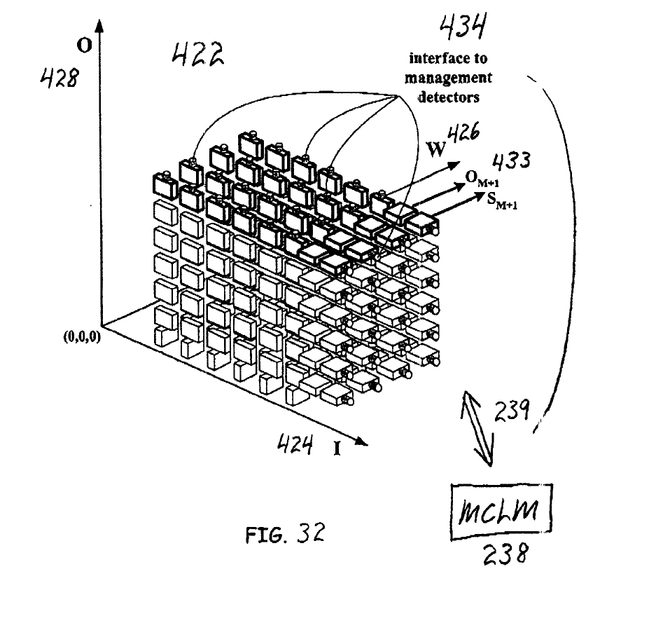

IW_{M+1} is the ‘second-switching management-and-control’ layer (FIG. 32).

4. The wavelength layers are denoted IOₖ—the layer is parallel to the I×O plane and is in distance k from the origin of 3-D array 422 of optical switch (OS) elements 204.

In this direction 3-D array 422 has K layers denoted IO₁, . . . , IOₖ, . . . , IO_{K}, which correspond to the K wavelengths 436, that is, λ₁ to λ_{K}, carried via the input ports.

5. The input layers are denoted OWₙ—the layer is parallel to the O×W plane and is in distance n from the origin of 3-D array 422 of optical switch (OS) elements 204.

In this direction, 3-D array 422 has N+2 layers denoted OW₁, . . . , OWₙ, . . . , OW_{N}, OW_{N+1}, OW_{N+2}.

OW₁ to OW_{N} are the N input planes.

OW_{N+1} is the output ports plane.

OW_{N+2} is the ‘third-switching management-and-control’ layer (see FIG. B14).

6. Each OS element 204 is referred to and referenced by triple indices (OS_{n,m,k}), where:

n—is the input layer index, varying from 1 to N+2;

m—is the output layer index, varying from 0 to M+1; and

k—for the wavelength layer index, varying from 1 to K.

7. Each switching path (SP) connecting the k-th wavelength of the n-th input port to the m-th output port, is referred to and referenced by triple indices (SP_{n,m,k}), where:

n—is the input port index, varying from 1 to N;

m—is the output port index, varying from 1 to M; and

k—is the wavelength index, varying from 1 to K.

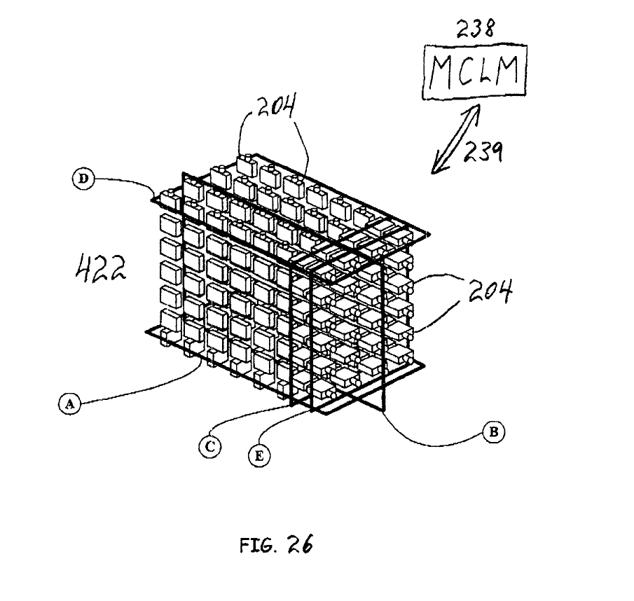

FIG. 26 is a schematic diagram illustrating highlighting of the various planes of 3-D array 422 of optical switch (OS) elements 204 of FIG. 25.

Plane A, referenced in FIG. 26 by the circled letter ‘A’, is the ‘input-connections and input-residuals’ layer IW₀. This bottom plane of 3-D array 422 of optical switch (OS) elements 204 is used for input ports connection, for selection of specific wavelengths from the input streams and for connection of the optional input-residuals signals. As illustrated in FIGS. 25 and 27, the input ports Iₙ, for n=1 to N, 430, are connected to the OS elements OS_{n,0,1} along the leftmost column of Plane A. The optional input-residuals IRₙ of the input ports Iₙ (for n=1 to N), are connected to the OS elements OS_{n,0,K} along the rightmost column of Plane A;

Plane B, referenced in FIG. 26 by the circled letter ‘B’, is a wavelength-specific switching layer IOₖ (for k=1 to K). OS elements 204 in Plane B are selective to the particular wavelength λₖ, and, perform all switching and routing operations of this wavelength from all the input streams to all the output streams. The symbol Wₖ, for k=1 to K, in FIG. 25 indicates the direction of movement of the switched signals within the corresponding IOₖ layer;

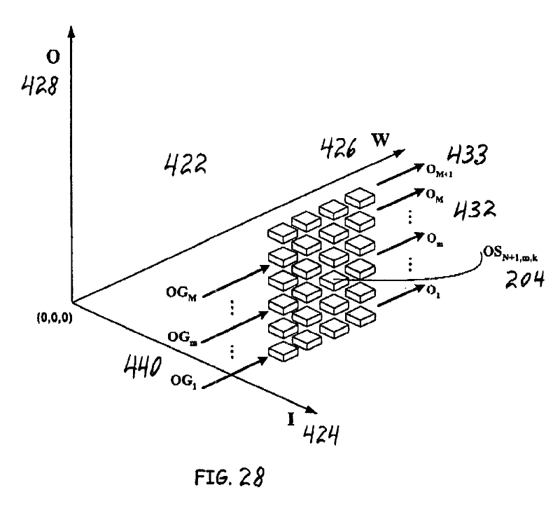

Plane C, referenced in FIG. 26 by the circled letter ‘C’, is the optional output-groupings and output-connections layer OW_{N+1}. As illustrated in FIGS. 25 and 28, the output ports Oₘ, for m=1 to M, 432, are connected to the OS elements OS_{N+1,m,K} along the rightmost column of Plane C; an additional output port O_{M+1} 433 for management and control purposes is connected to the top element OS_{N+1,M+1,K}. Plane C also contains the connections to the output-grouping ports, which are optional input ports that may be used in the embodiment of the add/drop feature described below. These ports OGₘ, for m=1 to M, are connected to the OS elements OS_{N+1,m,1} along the leftmost column of Plane C.

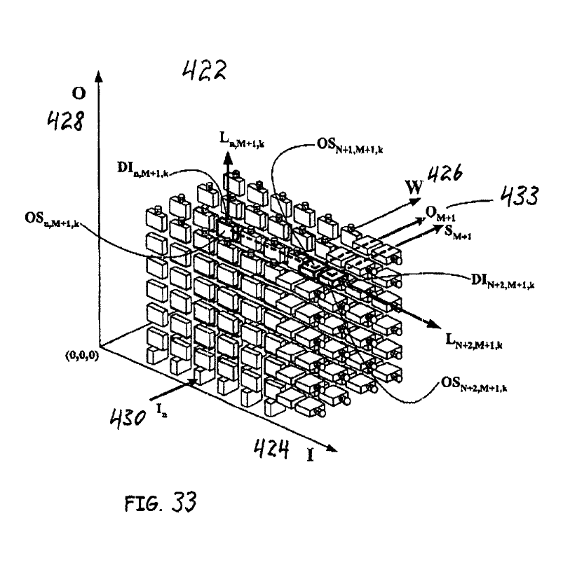

Plane D, referenced in FIG. 26 by the circled letter ‘D’, is the ‘second-switching management-and-control’ layer IW_{M+1}. As also highlighted in FIGS. 32 and 33, this top plane of 3-D array 422 of optical switch (OS) elements 204, together with detectors for management and control logic mechanism 238 which are optically connected, via interface 239, to OS elements 204 of this layer, is used for logical management and control functions of the second-switching operations; and

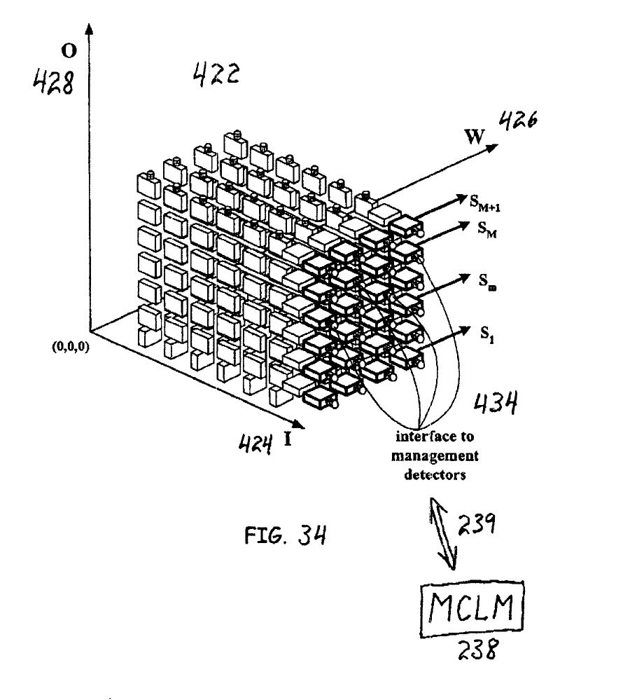

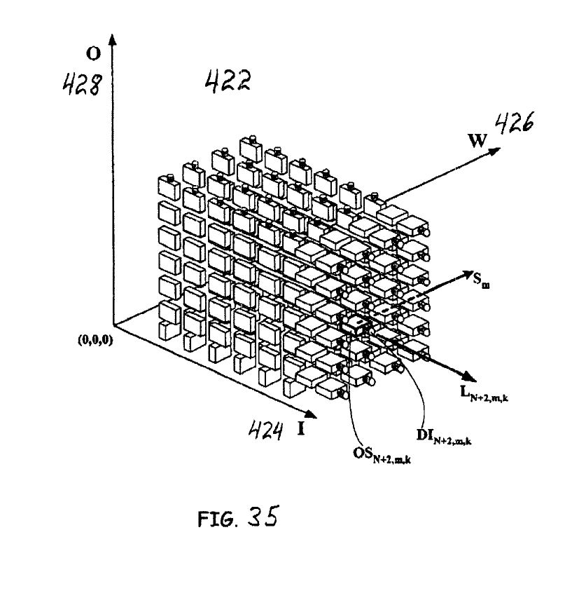

Plane E, referenced in FIG. 26 by the circled letter ‘E’, is the ‘third-switching-management-and-control’ layer OW_{N+2}. As also highlighted in FIGS. 34 and 35, this rightmost plane of 3-D array 422 of optical switch (OS) elements 204, together with detectors for management and control logic mechanism 238 which are optically connected, via interface 239, to OS elements 204 of this layer, is used for logical management and control functions of the third-switching operations.

FIG. 27 is a schematic diagram illustrating the input connections and optional input residuals layer IW₀, of 3-D array 422 of FIG. 25, with OS elements 204 and the connections to the input ports and to the optional input-residuals. Shown are the N input ports Iₙ, for n=1 to N, 430 , connected to the leftmost column of this layer. Each of the K columns denoted as Wₖ, for k=1 to K, contains the OS elements which are selective to the particular wavelength k, with the OS element OS_{n,0,k} being responsible for selecting (demultiplexing) the wavelength k from the input port Iₙ. The residual (the un-switched) portions of the input signals are leaving the rightmost column of this layer as the input-residuals IRₙ, for n=1 to N, 438.

FIG. 28 is a schematic diagram illustrating the optional output groupings and an output connections layer, of 3-D array 422 of FIG. 25, OW_{N+1}, with its OS elements 204 and connections to output ports 432 and to the output-grouping ports. Shown are the M output ports Oₘ, for m=1 to M, 432 connected to the rightmost column of this layer. Additional output port O_{M+1} 433 for management purposes, is connected to the top element of this column. Shown are also the output-grouping ports OGₘ, for m=1 to M, 440, connected to the OS elements OS_{N+1,m,1} along the leftmost column of this layer. The output-grouping ports are optional input ports that may be used in the embodiments of the add/drop feature described below.

Triple Switching

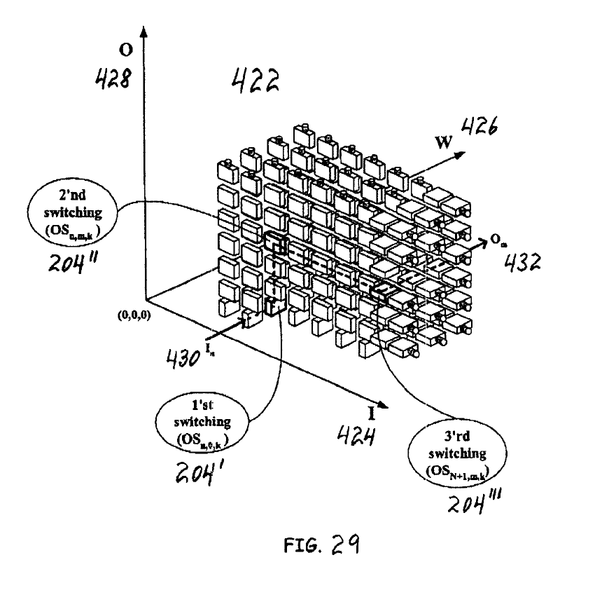

FIG. 29 is a schematic diagram illustrating the mechanism of triple switching, of 3-D array 422 of FIG. 25. The switching operation is shown with an appropriate switching path SP_{n,m,k}, (indicated by dashed lines), of a wavelength λₖ of an input port Iₙ, 430 into an output port Oₘ 432. In order to activate the switching path SP_{n,m,k}, three OS elements are ‘switched on’:

(1) the element OS_{n,0,k} 204′ at the n-th row of the bottom plane IW₀, in order to select at least a portion of wavelength k from the input port Iₙ, and to direct this portion upwards into the n-th column of the plane IOₖ;

(2) the element OS_{n,m,k}, 204″, in order to further direct at least a portion of wavelength k to the right into the m-th row of the plane IOₖ; and

(3) the element OS_{N+1,m,k}, 204′″, in order to further direct at least a portion of wavelength k into output port Oₘ 432.

The three OS elements 204 switched on to perform a triple switching have the same k index. Namely, all three switching operations occur in the same IOₖ plane, which is the plane responsible for all switching operations of the k-th wavelength from all input ports to all output ports. The un-switched portion of the k-th wavelength at each switched-on OS element, and the other wavelengths continue unaffected in the direction of the impinging light. The optical signals unaffected by a certain OS element can be switched and routed by other switched-on OS elements. The light unaffected by any of first-switching OS elements 204′ leaves 3-D array 422 of optical switch (OS) elements as input-residuals (FIG. 27). The light affected by a certain first-switching (at OS_{n,0,k} 204′) and unaffected by second-switching OS elements 204″ enters the element OS_{n,M+1,k} of the ‘second-switching management-and-control’ plane IW_{M+1}, as a second-switching management signal. As shown in FIGS. 32 and 33, the second-switching management signals can be further switched by the OS elements in this management-and-control plane, and then leave 3-D array 422 as leftover signals carried over to the detectors which are optically connected to the OS elements in this plane, and/or leave 3-D array 422 through the output port O_{M+1} 433, and/or through the supervisory output port S_{M+1}. The unaffected light at a third-switching OS element 204″ enters the element OS_{N+2,m,k} of the ‘third-switching management-and-control’ plane OW_{N+2}, as a third-switching management signal. As shown in FIGS. 34 and 35, the third-switching management signals can be further switched by the OS elements in this management-and-control plane, and then leave 3-D array 422 as leftover signals carried over to the detectors which are optically connected to the OS elements in this plane, and/or leave 3-D array 422 through the supervisory output ports S₁ to S_{M+1}.

The portion of light switched by a element OS_{n,m,k} will be denoted as p_{n,m,k,} a number between 0 and 1, where the extreme value, P_{n,m,k} equals 0, means that the element OS_{n,m,k} is not activated at all, whereas the extreme value, p_{n,m,k} equals 1, means full switching. Intermediate values between 0 and 1 indicate partial switching of the impinging light intensity. The element OS_{n,m,k} is said to be in an ‘on’ (active) state if and only if p_{n,m,k} is greater than 0. Thus, the portion of the light switched by the triple-switch along a switching path SP_{n,m,k} is given by the equation:

P_{n,m,k}=p_{n,0,k}*p_{n,m,k}*p_{0,m,k}.

The term P_{n,m,k} is a number between 0 and 1 indicating the portion of the intensity of wavelength k of input port Iₙ reaching output port Oₘ. Hence, this term P_{n,m,k} is ‘on’, that is, has a value greater than 0, implying that the switching and routing is operable, if and only if, all of its three p components are ‘on’.

The basic function of the 3-D array of optical switch (OS) elements is to route groups of one or more wavelengths from any input fiber to any output fiber, according to logical management and control mechanism (MCLM) 238. The 3-D array of optical switch (OS) elements provides complete flexibility in routing any wavelength from any input fiber to any output fiber independent of one another. Note, however, that MCLM 238 prevents the conflict of routing a same wavelength from more then one input fiber to the same output fiber.

Grouping

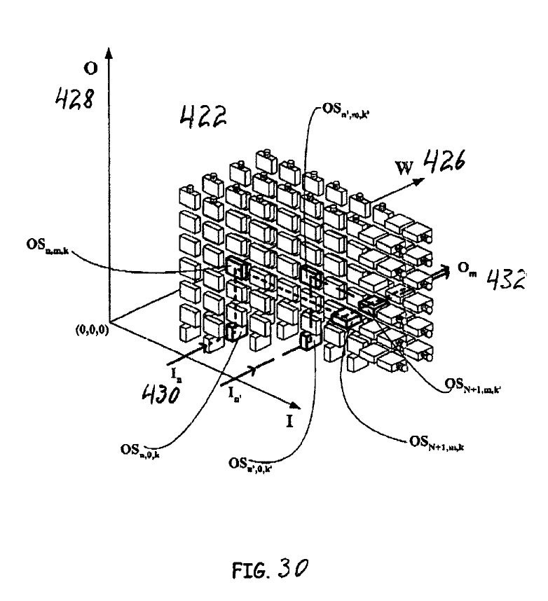

FIG. 30 is a schematic diagram illustrating the grouping operation in 3-D array 422 of optical switch (OS) elements 204 of FIG. 25, that is, switching two or more different wavelengths from one or more input ports 430 into a same output port 432. In the example shown, two triple-switchings SP_{n,m,k} and SP_{n′,m,k′}, indicated by short dashed and long dashed lines, respectively, switch at least a portion of wavelength k from input port Iₙ, and at least a portion of wavelength k′ from input port I_{n′} into same output port Oₘ 432.

Multicasting

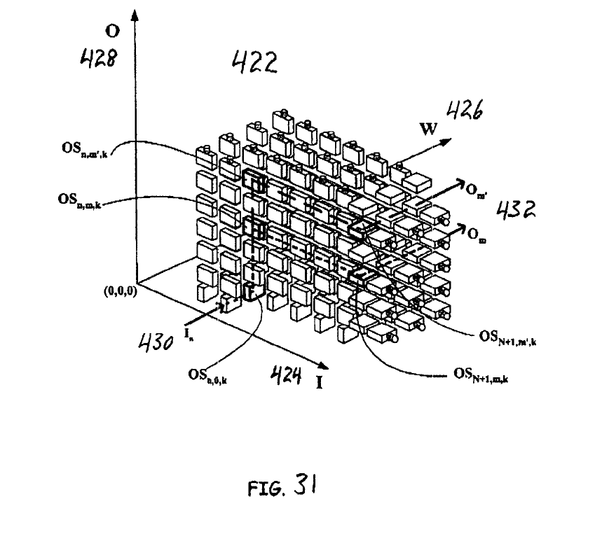

FIG. 31 is a schematic diagram illustrating the multicasting operation in 3-D array 422 of optical switch (OS) elements 204 of FIG. 25, that is, switching at least portions of the same wavelength from a common input port 430 into two or more different output ports 432. The importance of the multicast function is in the areas of routing, switching, and, transmission protection through, for example, redundant transmission, and, in transmitting to groups of receivers. In the example shown, two triple-switchings SP_{n,m,k} and SP_{n,m′,k}, indicated by short dashed and long dashed lines, respectively, switch at least portions of the same wavelength k from a same input port Iₙ 430 into different output ports Oₘ and O_{m′}, respectively.

Logical Management and Control

The proposed architecture, as highlighted in FIG. 27 concerning the input-residuals, and in FIGS. 22-25 concerning the second-switching and third-switching management signals, provides a way to tap the routed information, monitor and manage its quality, without intervening in the switching and routing operation. It is achieved by analyzing the residual (‘leftover’) signals that reach the management-and-control layers, that is, the ‘second-switching management-and-control layer IW_{M+1}, and the ‘third-switching management-and-control layer OW_{N+2}, following the second and third switchings, respectively, together with the input-residuals signals that leave the input-connections and optional input-residuals layer IW₀, following the first switchings. The leftover and optional input-residuals signals are well defined portions of the original signals, so they can be used, for example, to monitor the characteristics of the original signal for management analysis.

The management-and-control layers act as any other switching and routing layers of 3-D array 422 of optical switch (OS) elements 204. Thus, the leftover optical signals from the various wavelengths can be routed to a common output conduit, for example, for being analyzed intermittently by a common monitoring and management equipment, and/or, converted to electrical signals by the detectors which are optically connected to the OS elements of the management-and-control layers, for example, for power, error, and data analysis, and used to ensure the quality of the signal transmission and operation of the 3-D array of optical switch (OS) elements.

FIG. 32 is a schematic diagram illustrating highlighting of the second-switching management-and-control layer or plane, IW_{M+1}, of 3-D array 422 of optical switch (OS) elements of FIG. 25, together with an interface 434 for optically connecting second-switching management detectors, operatively connected to management and control logic mechanism 238 via interface 239, to the optical switch (OS) elements of this layer.

FIG. 33 is a schematic diagram illustrating the switching and routing operations within the second-switching management-and-control layer of 3-D array 422 of optical switch (OS) elements of FIG. 25. Here is shown how a second-switching management signal, that is, the light of a wavelength k of an input port Iₙ being unaffected by the second-switching OS elements, reaching the element OS_{n,M+1,k} of the ‘second-switching management-and-control’ plane IW_{M+1}, can be routed within this management-and-control plane, and leave 3-D array 422 of optical switch (OS) elements as leftover signals L_{n,M+1,k} and/or L_{N+2,M+1,k} which are carried over through the interfaces DI_{n,M+1,k} and/or DI_{N+2,M+1,k} to the management detectors D_{n,M+1,k} and/or D_{N+2,M+1,k}, respectively (not shown here), and/or leave 3-D array 422 of optical switch (OS) elements as optical signals through output port O_{M+1} 433 and/or through the supervisory output port S_{M+1}.

FIG. 34 is a schematic diagram illustrating highlighting of the third-switching management-and-control layer or plane OW_{N+2}, of 3-D array 422 of optical switch (OS) elements of FIG. 25, together with an interface 434 for optically connecting third-switching management detectors, operatively connected to management and control logic mechanism 238 via interface 239, to the optical switch (OS) elements of this layer.

FIG. 35 is a schematic diagram illustrating the switching and routing operations within the third-switching management-and-control layer, of 3-D array 422 of optical switch (OS) elements of FIG. 25. Here is shown how a third-switching management signal, that is, the light being unaffected by the third-switching OS elements, reaching the element OS_{N+2,m,k} of the ‘third-switching management and control’ plane OW_{N+2}, can be routed within this management-and-control plane, and leave 3-D array 422 of optical switch (OS) elements as a leftover signal L_{N+2,m,k} which is carried over through the interface DI_{N+2,m,k} to the management detector D_{N+2,m,k} (not shown here), and/or leave 3-D array 422 of optical switch (OS) elements as an optical signal through the supervisory output port Sₘ.

One or more ‘management AOXC's, as previously described and illustrated above, can be utilized to tap and route portions of managed optical signals for logical management and control of the operation of the 3-D array of optical switch (OS) elements. The group of managed signals can consist of any of the optical signals in conjunction with the 3-D array of optical switch (OS) elements, that is, any of the input and output signals of the 3-D array of optical switch (OS) elements, or, any optical signal inside the 3-D array of optical switch (OS) elements. Furthermore, tapping and routing of managed signals can be performed by another 3-D array of optical switch (OS) elements (denoted as ‘management 3-D array of optical switch (OS) elements’), instead of a ‘management AOXC’, or, together with it, for example, using a cascade configuration.

Additional management-and-control layers can be added to the 3-D array of optical switch (OS) elements, in addition to the ‘second-switching management-and-control’ and the ‘third-switching management-and-control’ layers mentioned above, for increasing the variety of output signals for management and control purposes.

Adding and/or Dropping Single Wavelengths or Groups of a Plurality of Wavelengths

Dropping single wavelengths and/or groups of a plurality of wavelengths can be achieved by connecting the input-residuals (I₁ to I_{N}), or a subset thereof, to a ‘DROP OP’ array of the type (that is, DROP OP array 348, 348′, respectively) previously described above and illustrated in FIGS. 17 and 18, respectively, and, activating the appropriate OS elements of the ‘DROP OP’ array for dropping the desired wavelengths from the input-residuals signals.

Adding single wavelengths and/or groups of a plurality of wavelengths can be achieved by connecting the output of an ‘ADD OP’ array of the type (that is, ADD OP array 340, 340′, respectively) previously described above and illustrated in FIGS. 17 and 18, respectively, into the output-grouping input ports (OG₁ to OG_{M}) or a subset thereof, of the 3-D array of optical switch (OS) elements.

Wavelength Conversion and Restoration

Wavelength conversion may be needed in order to prevent blocking during the wavelength routing process. Restoration may be required when a routed path experiences too much loss.

There are many ways to implement wavelength conversion and restoration functions. The architecture presented here, in a similar way to the architecture previously described and illustrated above, is optimized for minimizing the number of detector/laser units, maintaining a ‘pool’ of convert/restore units according to the maximal number of concurrent conversion/restoration required at any particular time, rather than a convert/restore unit per each combination of input fiber, wavelength and output fiber.

Implementing the wavelength convert/restore functionality within the 3-D array of optical switch (OS) elements, is based on utilizing the add/drop mechanism described above. A wavelength λₓ to be converted/restored is dropped from the optical signal, routed to a convert/restore unit and the converted/restored wavelength λ_{y} is added to the optical signal. When λₓ is not equal to λ_{y}, the convert/restore unit operates as a converter, whereas, when λₓ equals λ_{y}, the convert/restore unit operates as a restorer. Maximum flexibility is achieved when the convert/restore units employ tunable lasers since a tunable laser may be used for conversion/restoration of different wavelengths at different times.

Scalability and Extendibility of the 3-D Architecture Representation

With respect to extendibility, the just described and illustrated 3-D architecture representations of the system of the present invention is extendable in the number of input ports, the number of output ports, and/or, in the number of wavelengths supported, as follows, with reference to exemplary embodiment 420 of FIG. 25:

For increasing the number of input ports 430, the number of planes in 3-D array 422 of optical switch (OS) elements 204 along I axis 424 is extended.

For increasing the number of output ports 432, the number of planes in 3-D array 422 of optical switch (OS) elements 204 along O axis 428 is extended.

For increasing the maximal number of wavelengths 436, the number of planes in 3-D array 422 of optical switch (OS) elements 204 along W axis 426 is extended.

In all cases, the number of elements increases linearly with the increase in capability. In most cases of implementation, this makes allocation of resources very reasonable for future expansion of the multichannel optical communication system.

With respect to spatial scalability, in general, 3-D array 422 of optical switch (OS) elements 204 may come in particular ‘standard’ sizes, smaller than the sizes required for actual implementation. The desired sized 3-D array, however, may be implemented by concatenating, via optical fibers and/or connectors, several, smaller sized 3-D arrays of optical switch (OS) elements.

Thus, it is understood from the embodiments of the invention herein described and illustrated, above, that the method and system for switching and routing, while logically managing and controlling, multichannel optical signals in an optical communication system, of the present invention, are neither anticipated or obviously derived from the “Electroholographic Wavelength Selective Photonic Switch For WDM Routing”, as disclosed in PCT Pat. Application. Publication No. WO 01/07946 and in co-filed U.S. patent application Ser. No. 09/621,874.

It is also appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for switching and routing, while logically managing and controlling, multichannel optical signals in an optical communication system, comprising the steps of:
(a) providing an optical package (OP) array as an array of H rows by W columns, denoted as an [H×W] dimensioned OP array, of (i) optically connected optical switch (OS) elements, wherein a said optical switch (OS) element at a row h and a column w, for h=1 to H, and, w=1 to W, respectively, is denoted as OS(h,w), (ii) optically connected left input ports and bottom side input ports, and, (iii) optically connected right output ports and top side output ports, whereby each said optical switch (OS) element is a device dynamically activated by an external control and features characteristics of:
(1) selectivity to a particular wavelength, λ;
(2) when said optical switch (OS) element is not activated, said optical switch (OS) element is transparent, by inducing very small loss, to light in a wavelength range of a multichannel optical signal; and
(3) when said optical switch (OS) element is activated, then part of said light at a particular wavelength, λ, is diverted at a pre-determined angle, whereby percentage of said light diverted compared to percentage of said light not diverted is a function of level of activation of said optical switch (OS) element, and, whereby said activated optical switch (OS) element is transparent to all other wavelengths; and
(b) providing a management and control logic mechanism (MCLM) operatively connected to said optical package array, for logically managing and controlling the switching and routing of said light entering and exiting said optical switch (OS) elements via said optically connected left side input ports and bottom side input ports, and, via said optically connected right side output ports and top side output ports, and, for preventing a conflict of routing components with a same said wavelength, λ, of the optical signals from different said input ports to a same said output port.

2. The method of claim 1, whereby said optical package (OP) array features characteristics of:
(1) said light may travel by entering and/or exiting along said rows and/or along said columns of said optical package (OP) array, whereby (I) said light may enter a said row h at left side of said optical package (OP) array via a corresponding said left side input port, (II) said light may enter a said column w at bottom side of said optical package (OP) array via a corresponding said bottom side input port, (III) said light may exit from a said row h at right side of said optical package (OP) array via a corresponding said right side output port, and, (IV) said light may exit from a said column w at top side of said optical package (OP) array via a corresponding said top side output port; and
(2) said light diverted by a particular said optical switch (OS) element is grouped with other said light entering same said optical switch (OS) element and traveling in a same direction as said diverted light.

3. The method of claim 2, whereby said optical package (OP) array features additional characteristics of:
(3) all said optical switch (OS) elements in a said column w are selective to a specific said wavelength, λ_{w};
(4) when said light traveling in a said row h hits a said active optical switch (OS) element in a said column w, at least a portion of λ_{w} component of said light is diverted upwards, joining any other said light traveling in same said column; and
(5) when said light traveling in a said column w hits a said active optical switch (OS) element in a said row h, at least a portion of said λ_{w} component of said light is diverted to said right side, joining any other said light traveling in a same said row.

4. The method of claim 1, whereby each said optical switch (OS) element is a voltage controlled Electroholography based optical switch.

5. The method of claim 1, whereby a plurality of said optical package (OP) arrays are used as optical package (OP) building blocks, OPBBs, for forming a scaled-up optical package (OP) array featuring P*Y rows and Q*X columns of said OS elements, wherein each said OP building block, OPBB(p,q), for p=1 to P, and q=1 to Q, is composed of Y rows and X columns of said OS elements, and, whereby said OPBBs are chained according to: for said p=1 to P−1, and, said q=1 to Q−1, all 1 to said Y rows at right side of said OPBB(p,q) are optically connected to corresponding rows at left side of OPBB(p,q+1), and, all 1 to said X columns at top side of said OPBB(p,q) are optically connected to corresponding columns at bottom side of OPBB(p+1,q).

6. The method of claim 1, whereby a plurality of said optical package (OP) arrays are used for forming an all optical cross connect (AOXC) chained optical package (COP) architecture featuring a three dimensional [N×M×K] array of said optical package (OP) arrays, where said N is number of input fibers, said M is number of output fibers, and, K is number of wavelengths λₖ, for k=1 to K, per said fiber operated upon by said AOXC COP architecture.

7. The method of claim 6, whereby not all said K wavelengths operated upon by said AOXC COP architecture must be present in each said fiber.

8. The method of claim 6, whereby each said fiber may carry additional wavelengths other than said K wavelengths, said additional wavelengths may be different in said fibers.

9. The method of claim 6, whereby said AOXC COP architecture has two sets of optional components: (1) N input-residuals output fibers, where each said input-residuals output fiber n, for n=1 to N, is optically connected to a corresponding input-residuals output port n of said AOXC COP architecture, for carrying portions of the optical signals from said input fibers that do not undergo switching, and, (2) M output-grouping input fibers, where each said output-grouping input fiber m, for m=1 to M, is optically connected to a corresponding output-grouping input port m of said AOXC COP architecture, for carrying the optical signals into said output fibers from sources other than from said input fibers.

10. The method of claim 6, whereby said AOXC COP architecture further includes a set of output signals, denoted as U leftover signals, optionally used for said logical management and control purposes by said logical management and control mechanism.

11. The method of claim 6, whereby said AOXC COP architecture is independently extendable in said three dimensions, to a [N′×M′×K′] AOXC COP architecture, where said N′ is equal to or greater than said N, said M′ is equal to or greater than said M, and, said K′ is equal to or greater than said K.

12. The method of claim 6, whereby said AOXC COP architecture is used for forming a basic chained input (BCI) AOXC COP architecture based on chaining of M [N×K] dimensioned said OP arrays, having chain length of said M, whereby each said optical package array OP(m), for m=1 to M, is composed of N rows and K columns, and, features characteristics of:
(1) for said m=1 to M, all said OS elements in column k, for k=1 to K, of said array OP(m) are selective to wavelength λₖ;
(2) for n=1 to N, said input fiber n is optically connected to said input port n of said AOXC chain, which is at left side of row n of array OP(1);
(3) for m=1 to M−1, rows 1 to N at right side of said array OP(m) are optically connected to rows 1 to N at left side of said array OP(m+1), respectively, forming N chained rows of said OP arrays; and
(4) for said n=1 to N, optional input-residuals fiber n is optically connected to a corresponding input-residuals output port n of said AOXC chain, located at right side of row n of said array OP(M).

13. The method of claim 6, whereby said AOXC COP architecture is used for forming a three dimensional (3-D) array of said optical switch (OS) elements, whereby said 3-D array features characteristics of:
(1) three axes, an input axis, I, an output axis, O, and, a wavelength axis, W;
(2) each layer (plane) in said 3-D array is denoted by two of said axes each said layer (plane) is parallel to, and a layer number;
(3) output layers are denoted IWₘ, whereby each said output layer is parallel to said I×W plane and is in distance m from origin of said 3-D array, whereby in this direction said 3-D array has M+2 said layers denoted IW₀, IW₁, . . . , IWₘ, . . . , IW_{M}, IW_{M+1}, said IW₁ to IW_{M} are M output planes, said IW₀ is input-connections and optional input-residuals layer, and, said IW_{M+1} is a second-switching management and control layer;
(4) said wavelength layers are denoted IOₖ, whereby each said wavelength layer is parallel to said I×O plane and is in distance k from origin of said 3-D array, whereby in this direction said 3-D array has said K layers denoted IO₁, . . . , IOₖ, . . . , IO_{K}, corresponding to said K wavelengths λ₁ to λ_{K}, carried via said input ports;
(5) input layers are denoted OWₙ, whereby each said input layer is parallel to said O×W plane and is in distance n from origin of said 3-D array, whereby in this direction, said 3-D array has N+2 layers denoted OW₁, . . . , OWₙ, . . . , OW_{N}, OW_{N+1}, OW_{N+2}, said OW₁ to OW_{N} are said N input planes, said OW_{N+1} is output ports plane, said OW_{N+2} is third-switching management and control layer;
(6) each said OS element is denoted by triple indices (OS_{n,m,k}), whereby said n is input layer index, varying from 1 to N+2; said m is output layer index, varying from 0 to M+1; and, said k is wavelength layer index, varying from 1 to said K; and
(7) each switching path (SP) connecting said k-th wavelength of said n-th input port to said m-th output port is denoted by triple indices (SP_{n,m,k}), whereby said n is input port index, varying from 1 to said N; said m is output port index, varying from 1 to said M; and, said k is wavelength index, varying from 1 to said K.

14. The method of claim 6, whereby said AOXC COP architecture is used for forming a [T×Z×W] dimensioned management AOXC COP architecture incorporated as part of said management and control logic mechanism, for said logically managing and controlling up to W wavelengths of a group of T managed signals via a group of Z management and control signals, and, a group of U leftover signals, said management AOXC COP architecture filters out portions of up to W wavelength components of said T managed signals, and, routes said filtered out portions into said group of said Z management and control signals, and, into said group of said U leftover signals, said portion of each of said T managed signals not filtered out by said management AOXC COP architecture continues in direction of each corresponding said managed signal as a carry-over signal for further said managing and controlling, and/or, switching and routing, the optical signals in the optical communication system.

15. A system for switching and routing, while logically managing and controlling, multichannel optical signals in an optical communication system, comprising:
(a) an optical package (OP) array as an array of H rows by W columns, denoted as an [H×W] dimensioned OP array, of (i) optically connected optical switch (OS) elements, wherein a said optical switch (OS) element at a row h and a column w, for h=1 to H, and, w=1 to W, respectively, is denoted as OS(h,w), (ii) optically connected left side input ports and bottom side input ports, and, (iii) optically connected right side output ports and top side output ports, whereby each said optical switch (OS) element is a device dynamically activated by an external control and features characteristics of:
(1) selectivity to a particular wavelength, λ;
(2) when said optical switch (OS) element is not activated, said optical switch (OS) element is transparent, by inducing very small loss, to light in a wavelength range of a multichannel optical signal; and
(3) when said optical switch (OS) element is activated, then part of said light at a particular wavelength, λ, is diverted at a predetermined angle, whereby percentage of said light diverted compared to percentage of said light not diverted is a function of level of activation of said optical switch (OS) element, and, whereby said activated optical switch (OS) element is transparent to all other wavelengths; and
(b) a management and control logic mechanism (MCLM) operatively connected to said optical package array, for logically managing and controlling the switching and routing of said light entering and exiting said optical switch (OS) elements via said optically connected left side input ports and bottom side input ports, and, via said optically connected right side output ports and top side output ports, and, for preventing a conflict of routing components with a same said wavelength, λ, of the optical signals from different said input ports to a same said output port.

16. The system of claim 15, whereby said optical package (OP) array features characteristics of:
(1) said light may travel by entering and/or exiting along said rows and/or along said columns of said optical package (OP) array, whereby (I) said light may enter a said row h at left side of said optical package (OP) array via a corresponding said left side input port, (II) said light may enter a said column w at bottom side of said optical package (OP) array via a corresponding said bottom side input port, (III) said light may exit from a said row h at right side of said optical package (OP) array via a corresponding said right side output ports, and, (IV) said light may exit from a said column w at top side of said optical package (OP) array via a corresponding said top side output port; and
(2) said light diverted by a particular said optical switch (OS) element is grouped with other said light entering same said optical switch (OS) element and traveling in a same direction as said diverted light.

17. The system of claim 16, whereby said optical package (OP) array features additional characteristics of:
(3) all said optical switch (OS) elements in a said column w are selective to a specific said wavelength, λ_{w};
(4) when said light traveling in a said row h hits a said active optical switch (OS) element in a said column w, at least a portion of λ_{w} component of said light is diverted upwards, joining any other said light traveling in same said column; and
(5) when said light traveling in a said column w hits a said active optical switch (OS) element in a said row h, at least a portion of said λ_{w} component of said light is diverted to said right side, joining any other said light traveling in a same said row.

18. The system of claim 15, whereby each said optical switch (OS) element is a voltage controlled Electroholography based optical switch.

19. The system of claim 15, whereby a plurality of said optical package (OP) arrays are used as optical package (OP) building blocks, OPBBs, for forming a scaled-up optical package (OP) array featuring P*Y rows and Q*X columns of said OS elements, wherein each said OP building block, OPBB(p,q), for p=1 to P, and q=1 to Q, is composed of Y rows and X columns of said OS elements, and, whereby said OPBBs are chained according to: for said p=1 to P−1, and, said q=1 to Q−1, all 1 to said Y rows at right side of said OPBB(p,q) are optically connected to corresponding rows at left side of OPBB(p,q+1), and, all 1 to said X columns at top side of said OPBB(p,q) are optically connected to corresponding columns at bottom side of OPBB(p+1,q).

20. The system of claim 15, whereby a plurality of said optical package (OP) arrays are used for forming an all optical cross connect (AOXC) chained optical package (COP) architecture featuring a three dimensional [N×M×K] array of said optical package (OP) arrays, where said N is number of input fibers, said M is number of output fibers, and, K is number of wavelengths λₖ, for k=1 to K, per said fiber operated upon by said AOXC COP architecture.

21. The system of claim 20, whereby not all said K wavelengths operated upon by said AOXC COP architecture must be present in each said fiber.

22. The system of claim 20, whereby each said fiber may carry additional wavelengths other than said K wavelengths, said additional wavelengths may be different in said fibers.

23. The system of claim 20, whereby said AOXC COP architecture has two sets of optional components: (1) N input-residuals output fibers, where each said input-residuals output fiber n, for n=1 to N, is optically connected to a corresponding input-residuals output port n of said AOXC COP architecture, for carrying portions of the optical signals from said input fibers that do not undergo switching, and, (2) M output-grouping input fibers, where each said output-grouping input fiber m, for m=1 to M, is optically connected to a corresponding output-grouping input port m of said AOXC COP architecture, for carrying the optical signals into said output fibers from sources other than from said input fibers.

24. The system of claim 20, whereby said AOXC COP architecture further includes a set of output signals, denoted as U leftover signals, optionally used for said logical management and control purposes by said logical management and control mechanism.

25. The system of claim 20, whereby said AOXC COP architecture is independently extendable in said three dimensions, to a [N′×M′×K′] AOXC COP architecture, where said N′ is equal to or greater than said N, said M′ is equal to or greater than said M, and, said K′ is equal to or greater than said K.

26. The system of claim 20, whereby said AOXC COP architecture is used for forming a Basic Chained Input (BCI) AOXC COP architecture based on chaining of M [N×K] dimensioned said OP arrays, having chain length of said M, whereby each said optical package array OP(m), for m=1 to M, is composed of N rows and K columns, and, features characteristics of:
(1) for said m=1 to M, all said OS elements in column k, for k=1 to K, of said array OP(m) are selective to wavelength λₖ;
(2) for n=1 to N, said input fiber n is optically connected to said input port n of said AOXC chain, which is at left side of row n of array OP(1);
(3) for m=1 to M−1, rows 1 to N at right side of said array OP(m) are optically connected to rows 1 to N at left side of said array OP(m+1), respectively, forming N chained rows of said OP arrays; and
(4) for said n=1 to N, optional input-residuals fiber n is optically connected to a corresponding input-residuals output port n of said AOXC chain, located at right side of row n of said array OP(M).

27. The system of claim 20, whereby said AOXC COP architecture is used for forming a three dimensional (3-D) array of said optical switch (OS) elements, whereby said 3-D array features characteristics of:
(1) three axes, an input axis, I, an output axis, O, and, a wavelength axis, W;
(2) each layer (plane) in said 3-D array is denoted by two of said axes each said layer (plane) is parallel to, and a layer number;
(3) output layers are denoted IWₘ, whereby each said output layer is parallel to said I×W plane and is in distance m from origin of said 3-D array, whereby in this direction said 3-D array has M+2 said layers denoted IW₀, IW₁, . . . , IWₘ, . . . , IW_{M}, IW_{M+1}, said IW₁ to IW_{M} are M output planes, said IW₀ is input-connections and optional input-residuals layer, and, said IW_{M+1} is a second-switching management and control layer;
(4) said wavelength layers are denoted IOₖ, whereby each said wavelength layer is parallel to said I×O plane and is in distance k from origin of said 3-D array, whereby in this direction said 3-D array has said K layers denoted IO₁, . . . , IOₖ, . . . , IO_{K}, corresponding to said K wavelengths λ₁ to λ_{K}, carried via said input ports;
(5) input layers are denoted OWₙ, whereby each said input layer is parallel to said O×W plane and is in distance n from origin of said 3-D array, whereby in this direction, said 3-D array has N+2 layers denoted OW₁, . . . , OWₙ, . . . , OW_{N}, OW_{N+1}, OW_{N+2}, said OW₁ to OW_{N} are said N input planes, said OW_{N+1} is output ports plane, said OW_{N+2} is third-switching management and control layer;
(6) each said OS element is denoted by triple indices (OS_{n,m,k}), whereby said n is input layer index, varying from 1 to N+2; said m is output layer index, varying from 0 to M+1; and, said k is wavelength layer index, varying from 1 to said K; and
(7) each switching path (SP) connecting said k-th wavelength of said n-th input port to said m-th output port is denoted by triple indices (SP_{n,m,k}), whereby said n is input port index, varying from 1 to said N; said m is output port index, varying from 1 to said M; and, said k is wavelength index, varying from 1 to said K.

28. The system of claim 20, whereby said AOXC COP architecture is used for forming a [T×Z×W] dimensioned management AOXC COP architecture incorporated as part of said management and control logic mechanism, for said logically managing and controlling up to W wavelengths of a group of T managed signals via a group of Z management and control signals, and, a group of U leftover signals, said management AOXC COP architecture filters out portions of up to W wavelength components of said T managed signals, and, routes said filtered out portions into said group of said Z management and control signals, and, into said group of said U leftover signals, said portion of each of said T managed signals not filtered out by said management AOXC COP architecture continues in direction of each corresponding said managed signal as a carry-over signal for further said managing and controlling, and/or, switching and routing, the optical signals in the optical communication system
